(19) United States
(12) Patent Application Publication
(10) Pub. No.: US 2019/0031524 A1
(43) Pub. Date: Jan. 31, 2019

(54) IMPROVED METHODS OF EXTRACTION OF PRODUCTS FROM TITANIUM-BEARING MINERALS

(71) Applicant: AVERTANA LIMITED, Auckland (NZ)

(72) Inventors: Mohammed Shereez ALI, Auckland (NZ); David Jonathan HASSELL, Auckland (NZ); Sherif Owen Zaki Emad Marshall IBRAHIM, Auckland (NZ); Campbell Stuart MCNICOLL, Auckland (NZ); Sean Daniel James MOLLOY, Auckland (NZ); Björn Jonas Emanuel JACOBSON, Auckland (NZ); Jason Trevor HERROLD, Auckland (NZ); Jenelyn Ongtangco ISLETA, Auckland (NZ); Prana Budimulia HARYANTO, Auckland (NZ); Liam Barry SMITH, Auckland (NZ); David James Relph WOOLNER, Auckland (NZ)

(21) Appl. No.: 16/069,576

(22) PCT Filed: Jan. 13, 2017
(86) PCT No.: PCT/NZ2017/050002

§ 371 Date: Jul. 12, 2018

(30) Foreign Application Priority Data
Jan. 13, 2016 (NZ) 715936
Jan. 13, 2016 (NZ) 715950

(51) Int. Cl. C01G 23/053; C01G 23/08; C01F 7/74; C01F 5/40; C01F 11/46; C01B 33/12

(52) U.S. Cl. CPC C01G 23/0532; C01G 23/08; C01F 7/74; C01F 5/40; C01P 2002/60; C01B 33/126; C01P 2006/80; C01P 2002/54; C01P 2006/60; C01F 11/46

(57) ABSTRACT

The invention relates to processes for the extraction of products from titanium-bearing minerals. In particular embodiments the invention relates to methods of recycling sulphuric acid used in a titanium dioxide extraction process. The invention also relates to methods for minimising chromophore contamination in calcined titanium dioxide. The process may also comprise steps for removing contaminants from recycled acid or desirable products.

### FIELD OF INVENTION

The invention relates to processes for the extraction of products from titanium-bearing minerals. In particular embodiments the invention relates to methods of recycling sulphuric acid used in a titanium dioxide extraction process. The invention also relates to methods for minimising chromophore contamination in calcined titanium dioxide. The process may also comprise steps for removing contaminants from recycled acid or desirable products.

### BACKGROUND

There are numerous reserves of minerals from which valuable constituents cannot currently be recovered through means that are economically viable. The primary reason for this is that the grade of such constituents within the mineral reserves is too low, resulting in large effluent or by-product generation rates.

Melter slag, produced as a by-product during iron and steel making processes, is one such mineral that contains low grades of commercially valuable components, including titanium, aluminium and magnesium. During production of molten-pig iron, impurities are removed as melter slag. For some deposits, the slag is primarily perovskite (calcium titanate) and may contain between 20-40% titanium dioxide.

Known melter slag extraction processes focus on extraction of titanium, due to it having the highest concentration within melter slag and the highest value. Titanium is a valuable pigment used in a number of commercial applications such as the production of paints, paper, cement and polymers. In melter slag, titanium is present in the form of perovskite, a titanium-calcium oxide crystalline structure from which recovery is difficult. An example of a known method of extraction of titanium from perovskite includes reacting perovskite with carbon at high temperatures in an electrical furnace to produce titanium carbide. The titanium carbide is then chlorinated to produce titanium tetrachloride. Unfortunately, this method is energy intensive and the carbide produced has an extremely high melting point, which creates handling problems in the furnace.

Another method of extracting titanium from perovskite is that published in CA1,052,581. In this method, perovskite is treated by roasting at 1200° C. in hydrogen sulphide gas. This is followed by leaching to remove calcium and iron sulphides which leaves the titanium as titanium oxides. The disadvantages of this process are the high temperatures and use of highly toxic gas.

Even minor improvements to a process for extracting saleable products from minerals can have a significant impact on the efficiency, and more particularly, the commercial viability, of such a process. The methods detailed above are economically inefficient due to the high temperatures used, and only titanium is extracted by these processes. The inventors have previously demonstrated novel methods and apparatus for the commercially viable extraction of a number of products from melter slag. These products can include at least titanium dioxide, aluminium sulphate and magnesium sulphate. However, during their continued research, the inventors have identified a number of issues which reduce the viability of the process from a cost, product yield and product purity perspective. One such issue is the purity of a titanium dioxide produced. The colour and reflectivity of the titanium dioxide is affected by contaminants which are co-extracted with titanium dioxide hydrate. Many contaminants are also chromophores which, due to their colour, affect the purity and colour of the products. Quality and commercial value of the products can be affected by the presence of chromophores. This issue is especially acute for titanium dioxide which, when pure, is a white pigment with a very high refractive index. The pigment is widely employed as a pigment to provide whiteness and opacity to products such as paints, coatings, plastics, papers, inks, foods, medicines (i.e. pills and tablets) and toothpastes.

Accordingly, it is an object of the present invention to provide a method of recovering titanium dioxide hydrate from a particulate material while recycling excess acid used in the process, or to at least provide the public with a useful choice.

### SUMMARY OF THE INVENTION

In a first aspect, the invention provides a method of recovering titanium dioxide hydrate from a particulate material, the method comprising:
a. contacting the particulate material with sulphuric acid from a sulphuric acid stream and heating to form a sulphated mixture;
b. filtering the sulphated mixture to produce a filter cake and a first permeate comprising excess sulphuric acid;
c. contacting the filter cake with water to form a sulphated suspension comprising titanyl sulphate;
d. filtering the sulphated suspension to produce a permeate comprising at least titanyl sulphate, and a retentate comprising insoluble residue;
e. contacting the permeate comprising at least titanyl sulphate with water to produce a hydrolysis liquor;
f. hydrolysing the titanyl sulphate to produce a hydrolysed liquor; and
g. separating titanium dioxide hydrate from the hydrolysed liquor,

wherein excess sulphuric acid from at least one of the first permeate and the hydrolysed liquor undergoes recycling.

In particular embodiments, the particulate material of a. is contacted with 2-15 times its stoichiometric quantity of sulphuric acid. In particular embodiments, the particulate material of a. is contacted with 2-15 times its stoichiometric quantity of sulphuric acid. Preferably, the particulate material of a. is contacted with 4-10 times its stoichiometric quantity of sulphuric acid. In preferred embodiments, the particulate material of a. is contacted with 5-6, or approximately 6 times its stoichiometric quantity of sulphuric acid.

In particular embodiments, step a. occurs in a sulphation reactor.

In particular embodiments, the method comprises a step of minimising water accumulation during the sulphation step a.

Preferably the step of minimising water accumulation comprises heating the sulphated mixture to a sulphation temperature and for a heating period sufficient to remove substantially all of the water produced during sulphation.

Preferably the step of minimising water accumulation comprises removal of headspace from a sulphation reactor adapted to contain the sulphation step a. Preferably the removal of headspace is achieved by at least one of:
a. a gas pump adapted to increase gas ingress to the headspace of the sulphation reactor;
b. a gas pump adapted to increase gas egress from the headspace of the sulphation reactor.

In particular embodiments, the concentration of the sulphuric acid in the sulphuric acid stream is greater than 70 m %, between about 80 m % and 98 m %, greater than about 80 m %, greater than about 85 m %, greater than about 90 m %, greater than about 95 m % or greater than about 98 m %.

In particular embodiments of the first aspect, the sulphated mixture is heated to achieve substantially complete sulphation of the oxides (particularly titanium dioxide/calcium titanate) present. In particular embodiments, the sulphated mixture is heated to at least 100° C. following contact with sulphuric acid. In preferred embodiments, the mixture is heated to between about 100° C. to 250° C. In other embodiments, the mixture is heated to between about 150° C. and 250° C., greater than about 150° C., or a maximum of approximately 250° C. In particular embodiments, the sulphated mixture is heated to a temperature between 130° C. and 200° C., approximately 150° C.-160° C. or approximately 190-210° C.

In particular embodiments, the mixture is heated for a heating period. Preferably the heating period is sufficient to achieve substantially complete sulphation of the oxides (particularly titanium dioxide/calcium titanate) present. In one embodiment, the heating period is between 15 minutes and one hour. In another embodiment, the heating period is between 15 minutes and 24 hours. In particular embodiments, the heating period is at least 30 minutes or approximately 40 minutes. In a particular embodiment, the heating period is from 15 minutes to 90 minutes.

In one particular embodiment, the particulate material of step a. of the first aspect is contacted with approximately 4-10 times its stoichiometric quantity of sulphuric acid;

wherein the method comprises a step of minimising water accumulation during the sulphation step a. comprising:
i. heating the sulphated mixture in a sulphation reactor to a sulphation temperature of between approximately 150° C. and 250° C.;
ii. heating the sulphated mixture for a heating period of between about 30 minutes and 6 hours; and
iii. removal of headspace from the sulphation reactor.

In particular embodiments, the method further comprises recovering at least one other product selected from the group consisting of calcium sulphate, silica, aluminium sulphate or magnesium sulphate.

In particular embodiments, the titanium dioxide hydrate is separated by filtering the hydrolysis liquor to produce a permeate, and a retentate comprising titanium dioxide hydrate. In alternative embodiments, the titanium dioxide hydrate is separated by centrifugation and collection of the precipitate.

In particular embodiments, the insoluble residue comprises at least one product selected from calcium sulphate and silica.

In particular embodiments, the invention provides a method of recovering titanium dioxide hydrate and at least one other product from a particulate material comprising greater than 8 m %, greater than 10 m %, greater than 15 m % greater than 20 m % or greater than 25 m % titanium dioxide, and greater than 10 m %, greater than 15 m % or greater than 20 m % silica. In other embodiments, the invention provides a method of recovering titanium dioxide hydrate and at least one other product from a particulate material comprising greater than 8 m %, greater than 10 m %, greater than 15 m % greater than 20 m % or greater than 25 m % titanium dioxide, and greater than 15 m %, greater than 20 m % or greater than 25 m % calcium oxide.

In some embodiments, the invention provides a method of recovering titanium dioxide hydrate and at least one other product from a particulate material comprising greater than 8 m %, greater than 10 m %, greater than 15 m % greater than 20 m % or greater than 25 m % titanium dioxide, greater than 10 m %, greater than 15 m % or greater than 20 m % silica, and greater than 15 m %, greater than 20 m % or greater than 25 m % calcium oxide.

In some embodiments, the invention provides a method of recovering titanium dioxide hydrate and at least one other product from a particulate material comprising a ratio of titanium dioxide to calcium oxide (TiO₂:CaO) in the particulate matter of between 0.2 and 3.0, more preferably between 0.3 and 2.5.

In particular embodiments, the method further comprises separation of calcium sulphate from the insoluble residue using a floatation process.

In one embodiment, the invention provides a method of recovering titanium dioxide hydrate and aluminium sulphate from a particulate material, said method comprising:
a. contacting the particulate material with sulphuric acid from a sulphuric acid stream and heating to form a sulphated mixture;
b. filtering the sulphated mixture to produce a filter cake and a first permeate comprising excess sulphuric acid;
c. contacting the filter cake with water to form a sulphated suspension comprising titanyl sulphate;
d. filtering the sulphated suspension to produce a permeate comprising at least titanyl sulphate, and a retentate comprising insoluble residue;
e. contacting the permeate comprising at least titanyl sulphate with water to produce a hydrolysis liquor;
f. hydrolysing the titanyl sulphate;
g. separating titanium dioxide hydrate from the hydrolysis liquor to produce a permeate comprising aluminium sulphate, and a retentate comprising titanium dioxide hydrate; and
h. precipitating aluminium sulphate from the permeate;

wherein step h. may be carried out after step d or after step g, and

wherein excess sulphuric acid undergoes recycling from the permeate produced following step b., g. or h.

In particular embodiments, the method of the first aspect comprises a step of precipitating aluminium sulphate after step g wherein the precipitation comprises the steps of:
cooling the permeate produced from the hydrolysis liquor to produce a cooled liquor comprising precipitated aluminium sulphate; and
filtering the cooled liquor to produce a retentate comprising precipitated aluminium sulphate, and a permeate.

In particular embodiments, the method of the first aspect further comprises a step of precipitating aluminium sulphate after step g. wherein the particulate material comprises greater than 8 m %, greater than 10 m %, greater than 15 m % greater than 20 m % or greater than 25 m % titanium dioxide, and greater than 10 m % or greater than 13 m % aluminium oxide.

In particular embodiments, the method of the first aspect further comprises a step of precipitating aluminium sulphate after step g. wherein the particulate material comprises a ratio of titanium dioxide to aluminium oxide (TiO₂:Al₂O₃) in the particulate matter of approximately 0.2 to 2.6, more preferably 0.25 to 2.1.

In particular embodiments, the method of the first aspect further comprises a step of precipitating aluminium sulphate prior to step f. wherein the precipitation comprises:
cooling the permeate comprising at least titanyl sulphate to produce a cooled liquor comprising precipitated aluminium sulphate; and
filtering the cooled liquor comprising aluminium sulphate to produce a retentate comprising precipitated aluminium sulphate, and a permeate.

In particular embodiments the step of precipitating aluminium sulphate comprises cooling the permeate to between 10° C. and 4° C. such that the aluminium sulphate crystallizes. In preferred embodiments, the permeate comprising aluminium sulphate is cooled to approximately 5° C.

In particular embodiments, greater than 90% of the aluminium sulphate present in the sulphated suspension is recovered.

In particular embodiments, the method of the first aspect further comprises a step of precipitating magnesium sulphate from a permeate comprising magnesium sulphate, wherein the permeate comprising magnesium sulphate is either the hydrolysis liquor (after separation of titanium dioxide hydrate), or the permeate produced following aluminium sulphate precipitation.

In one embodiment, the invention provides a method of recovering titanium dioxide hydrate and magnesium sulphate from a particulate material, said method comprising:
a. contacting the particulate material with sulphuric acid from a sulphuric acid stream and heating to form a sulphated mixture;
b. filtering the sulphated mixture to produce a filter cake and a first permeate comprising excess sulphuric acid;
c. contacting the filter cake with water to form a sulphated suspension comprising titanyl sulphate;
d. filtering the sulphated suspension to produce a permeate comprising at least titanyl sulphate, and a retentate comprising insoluble residue;
e. contacting the permeate comprising at least titanyl sulphate with water to produce a hydrolysis liquor;
f. hydrolysing the titanyl sulphate;
g. separating titanium dioxide hydrate from the hydrolysis liquor to produce a permeate comprising magnesium sulphate, and a retentate comprising titanium dioxide hydrate; and
h. precipitating magnesium sulphate from the permeate;

wherein excess sulphuric acid undergoes recycling from the permeate produced following step b., g. or h.

In one embodiment, the magnesium sulphate is precipitated by the steps of:
increasing the acid concentration of a permeate comprising magnesium sulphate to form an acidified liquor; and
filtering the acidified liquor to produce a retentate comprising precipitated magnesium sulphate.

In particular embodiments, the acid concentration of the permeate comprising magnesium sulphate is increased by the addition of sulphuric acid. Preferably the pH of the permeate comprising magnesium sulphate is reduced to less than approximately pH1 by the addition of sulphuric acid. In particular embodiments, the acid concentration of the permeate comprising magnesium sulphate is increased by heating the permeate to remove water. Preferably heating is carried out at boiling point or at a temperature of greater than 130° C. Preferably heating is carried out to achieve a final acid concentration of 90%, or less than approximately pH1.

In particular embodiments, the method of the first aspect further comprises a step of precipitating magnesium sulphate from a permeate comprising magnesium sulphate, wherein the method includes the recovery of titanium dioxide hydrate and magnesium sulphate product from a particulate material comprising greater than 8 m %, greater than 10 m %, greater than 15 m % greater than 20 m % or greater than 25 m % titanium dioxide, and greater than 7 m % or greater than 10 m % magnesium oxide.

In particular embodiments, the method of the first aspect further comprises a step of precipitating magnesium sulphate from a permeate comprising magnesium sulphate, wherein the method includes the recovery of titanium dioxide hydrate and magnesium sulphate product from a particulate material comprising a ratio of titanium dioxide to magnesium oxide (TiO₂:MgO) in the particulate matter of approximately 0.5 to 3.0, more preferably 0.8 to 2.8.

In one embodiment, the step of precipitating magnesium sulphate comprises cooling the acidified liquor or a permeate comprising magnesium sulphate to a temperature where precipitation rate is increased.

In another embodiment, the step of precipitating magnesium sulphate comprises:
cooling the permeate comprising magnesium sulphate to produce a cooled liquor comprising magnesium sulphate; and
filtering the cooled liquor comprising magnesium sulphate to produce a retentate comprising precipitated magnesium sulphate, and a permeate.

In preferred embodiments, the permeate comprising magnesium sulphate or the acidified liquor is cooled to less than 4° C., between 0° C. and 4° C. or approximately 3° C.

In particular embodiments, greater than 90% of the magnesium sulphate present in the sulphated suspension is recovered following filtration.

In particular embodiments, the method of the first aspect further comprises:
precipitation of aluminium sulphate as described above, either before or after hydrolysis; and
the retentate obtained from the sulphated suspension comprises at least one of calcium sulphate and silica.

In particular embodiments, the method of the first aspect further comprises:
precipitation of magnesium sulphate as described above; and
the retentate obtained from the sulphated suspension comprises at least one of calcium sulphate and silica.

In particular embodiments, the method of the first aspect further comprises:
precipitation of aluminium sulphate as described above, either before or after hydrolysis; and
precipitation of magnesium sulphate as described above; and
the retentate obtained from the sulphated suspension comprises at least one of calcium sulphate and silica.

In particular embodiments, the method of the first aspect further comprises:
precipitation of aluminium sulphate as described above, either before or after hydrolysis; and
precipitation of magnesium sulphate as described above.

In one embodiment, the invention provides a method of recovering titanium dioxide hydrate, aluminium sulphate and magnesium sulphate from a particulate material, said method comprising: a. contacting the particulate material with sulphuric acid from a sulphuric acid stream and heating to form a sulphated mixture;
b. filtering the sulphated mixture to produce a filter cake and a first permeate comprising excess sulphuric acid;
c. contacting the filter cake with water to form a sulphated suspension comprising titanyl sulphate;
d. filtering the sulphated suspension to produce a permeate comprising at least titanyl sulphate, and a retentate comprising insoluble residue;
e. contacting the permeate comprising at least titanyl sulphate with water to produce a hydrolysis liquor;
f. hydrolysing the titanyl sulphate;
g. separating titanium dioxide hydrate from the hydrolysis liquor to produce a permeate comprising aluminium sulphate and magnesium sulphate, and a retentate comprising titanium dioxide hydrate;
h. precipitating aluminium sulphate from the permeate; and
i. precipitating magnesium sulphate from the permeate,

wherein step h. may be carried out after step d or after step g; and

wherein excess sulphuric acid from the permeate of step b., g., h. or i. undergoes recycling.

It will be understood by those of skill in the art that the particular recycling and regeneration embodiments described below will be applicable to any of the methods of extraction of titanium dioxide hydrate or one or more other products from a particulate material as described above.

In particular embodiments, recycling comprises collecting excess sulphuric acid from one or more steps of the method for re-use. Preferably the collected sulphuric acid is re-used in the method described in any of the embodiments described above. Preferably, re-use comprises passing the collected sulphuric acid to the sulphuric acid stream. In particular embodiments, the collected sulphuric acid is added to a fresh acid stream to achieve a particular concentration of acid for re-use. In particular embodiments, the acid for re-use has a concentration of approximately 80%, 90%, 95%, 96%, greater than 70%, greater than 80%, greater than 90%, greater than 95%, greater than 96%, between 70-98%, between 70-80%, or between 80-98%.

In particular embodiments, the hydrolysis liquor with titanium dioxide hydrate removed undergoes at least one further step and excess sulphuric acid is recycled from a fluid present after the at least one further step.

In particular embodiments, sulphuric acid is recycled from the permeate following separation or precipitation of aluminium sulphate.

In particular embodiments, sulphuric acid is recycled from the permeate following separation or precipitation of magnesium sulphate.

In particular embodiments, the excess sulphuric acid comprises contaminants or chromophores.

In particular embodiments, the contaminants or chromophores comprise at least one of iron, magnesium, lithium, zinc, copper, chromium, nickel, cobalt, vanadium, arsenic, molybdenum, manganese, selenium or a salt form of any one or more thereof.

In particular embodiments, the contaminants or chromophores comprise at least one of iron, chromium, nickel, vanadium or a salt form of any one or more thereof.

In particular embodiments, the methods described above are carried out where at least one contaminant concentration in titanium dioxide hydrate produced by a method without recycling exceeds the following levels:
a. iron greater than 10 ppm;
b. chromium greater than 2 ppm;
c. nickel greater than 1 ppm;
d. vanadium greater than 5 ppm;
e. manganese greater than 1 ppm; or
f. copper greater than 5 ppm.

In particular embodiments, recycling further comprises regenerating the excess sulphuric acid. In particular embodiments, regenerating the excess sulphuric acid comprises at least one of:
a. increasing the concentration of the sulphuric acid; and
b. decreasing the concentration of one or more contaminants in the sulphuric acid.

In particular embodiments, the regenerated sulphuric acid is added to a fresh acid stream to achieve a particular concentration of acid for re-use. In particular embodiments, the regenerated sulphuric acid has a concentration of approximately 80%, 90%, 95%, 96%, greater than 70%, greater than 80%, greater than 90%, greater than 95%, greater than 96%, between 70-98%, between 70-80%, or between 80-98%.

In particular embodiments, the method further comprises reducing contaminant or chromophore concentration in the titanium dioxide hydrate to achieve a final concentration of the contaminant or chromophore in the titanium dioxide hydrate of one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

In particular embodiments, increasing the concentration of the sulphuric acid comprises removing water from the acid. In particular embodiments, removal of water comprises passing the acid through a selective membrane to separate at least a portion of the water. In particular embodiments, removing the water from the acid is achieved by at least one of stripping and distillation.

In particular embodiments, regenerating the acid comprises:
a. thermally cracking the excess sulphuric acid to produce a sulphur dioxide stream;
b. producing regenerated sulphuric acid from the sulphur dioxide stream
c. adding the regenerated sulphuric acid to a fresh acid stream.

In particular embodiments, the excess sulphuric acid is regenerated using the Contact Process. In particular embodiments, the excess sulphuric acid is regenerated by the following steps:
a. converting at least a portion of the excess sulphuric acid to sulphur dioxide;
b. converting the sulphur dioxide to sulphur trioxide; and
c. converting the sulphur trioxide to concentrated sulphuric acid.

Preferably the concentrated sulphuric acid comprises a concentration of greater than 80%, greater than 90%, between 80-98%, between 80-98% or greater than 90%.

In particular embodiments, the Contact Process comprises the steps of
a. converting at least a portion of the sulphuric acid to sulphur dioxide by addition of oxygen to the sulphuric acid;
b. purifying the sulphur dioxide;
c. converting the sulphur dioxide into sulphur trioxide by addition of oxygen to the sulphur dioxide in the presence of an appropriate catalyst, heat and pressure;
d. converting the sulphur trioxide into concentrated sulphuric acid by combining the sulphur trioxide with sulphuric acid to form oleum, and combining the oleum with water to form concentrated sulphuric acid.

Preferably the catalyst to convert sulphur dioxide to sulphur trioxide comprises vanadium pentoxide.

Preferably the temperature required to convert sulphur dioxide to sulphur trioxide is between about 350° C. and 500° C., or about 400° C. to about 450° C. Preferably the pressure required to convert sulphur dioxide to sulphur trioxide is between about 1-2 atm.

In particular embodiments, the excess sulphuric acid has a concentration of between 40-80%, between 50-80%, less than 80%, less than 70%, less than 60%, or less than 50%.

In particular embodiments, regenerating the excess sulphuric acid comprises increasing the concentration of the sulphuric acid to approximately 80%, 90%, 95%, 96%, greater than 70%, greater than 80%, greater than 90%, greater than 95%, greater than 96%, between 70-98%, between 70-80%, or between 80-98%.

In particular embodiments, the one or more contaminants in the sulphuric acid comprises one or more chromophores.

In particular embodiments, the method comprises decreasing the concentration of one or more contaminants in the sulphuric acid comprising removal of the one or more contaminants by a separation process. Preferably the separation process comprises precipitation of the one or more contaminants followed by filtration to yield a retentate comprising the one or more contaminants. Preferably the separation process comprises a membrane separation technique.

In particular embodiments, the concentration of the one or more contaminants is decreased by increasing the concentration of the sulphuric acid to induce precipitation of the one or more contaminants followed by filtration to yield a retentate comprising the one or more contaminants. Increasing the concentration of the sulphuric acid may be achieved by the steps to avoid water accumulation described above.

In particular embodiments, regenerating the sulphuric acid comprises decreasing the concentration of one or more contaminants in the excess sulphuric acid. In particular embodiments, the one or more contaminants comprises at least one of iron, magnesium, lithium, zinc, copper, chromium, nickel, cobalt, vanadium, arsenic, molybdenum, manganese, selenium or a salt form of any one or more thereof. In particular embodiments, the concentration of any one of the contaminants or chromophores in the regenerated sulphuric acid is less than 100 ppm.

In particular embodiments, the regenerated sulphuric acid with contaminants or chromophores removed is added to a fresh acid stream to achieve a particular concentration of acid for re-use. In particular embodiments, the regenerated sulphuric acid has a concentration of approximately 80%, 90%, 95%, 96%, greater than 70%, greater than 80%, greater than 90%, greater than 95%, greater than 96%, between 70-98%, between 70-80%, or between 80-98%.

In particular embodiments, the concentration of the one or more chromophores is reduced by a membrane separation technique.

In a further embodiment of the first aspect, the method further comprises producing calcined titanium dioxide from a mixture comprising titanium dioxide hydrate and at least one contaminant, the method comprising:
a. treating the mixture to decrease the concentration of the at least one contaminant and produce purified titanium dioxide hydrate;
b. addition of at least one dopant to the purified titanium dioxide hydrate to produce a doped mixture;
c. heating the doped mixture comprising pre-calcination titanium dioxide hydrate for a period to produce calcined titanium dioxide.

Optionally, the embodiment in the preceding paragraph further comprises:
i. heating the doped mixture from b. in water for a period to produce a pre-calcination liquor;
ii. drying the pre-calcination liquor to produce a pre-calcination titanium dioxide hydrate.

In a further embodiment of the first aspect, the method further comprises producing calcined titanium dioxide from a mixture comprising titanium dioxide hydrate and at least one contaminant, the method comprising:
a. treating the mixture to decrease the concentration of the at least one contaminant and produce purified titanium dioxide hydrate;
b. addition of at least one dopant to the purified titanium dioxide hydrate to produce a doped mixture;
c. heating the doped mixture in water for a period to produce a pre-calcination liquor;
d. drying the pre-calcination liquor to produce a pre-calcination titanium dioxide hydrate;
e. heating the pre-calcination titanium dioxide hydrate for a period to produce calcined titanium dioxide.

In a further embodiment of the first aspect, the method further comprises producing calcined titanium dioxide from a mixture comprising titanium dioxide hydrate and at least one contaminant,

In particular embodiments, the calcined titanium dioxide comprises at least one of anatase and rutile titanium dioxide. In particular embodiments, the calcined titanium dioxide comprises greater than 95% or greater than 98% rutile titanium dioxide.

In particular embodiments, treating the mixture comprises at least one of a titanous sulphate leach, a sulphuric acid leach, and a water wash.

In particular embodiments, at least one dopant is added to the titanium dioxide hydrate to produce a doped mixture comprises the addition of at least one of potassium oxide (K₂O), phosphorus pentoxide (P₂O₅), and aluminium oxide (Al₂O₃). In a particular embodiment, the potassium oxide is added at a concentration of between 0.1% and 0.4% w/w in aqueous solution. In an alternative embodiment, potassium oxide is added at a concentration of between 0.02% and 0.4% w/w in aqueous solution. In a particular embodiment, the phosphorus pentoxide is added at a concentration of between 0.1% and 0.3% w/w in aqueous solution. In an alternative embodiment, the phosphorus pentoxide is added at a concentration of between 0.001% and 0.4% w/w in aqueous solution. In a particular embodiment, the aluminium oxide is added at a concentration of between 0.1% and 0.8% w/w in aqueous solution. In an alternative embodiment, the aluminium oxide is added at a concentration of between 0.001% and 0.8% w/w in aqueous solution.

In a particular embodiment, the titanium dioxide is substantially monodisperse. Preferably the titanium dioxide comprises a geometric standard deviation of less than 1.5.

In particular embodiments, any of the embodiments of the first aspect further comprise at least one step to reduce the concentration of at least one chromophore present in titanium dioxide by the addition of dopants and associated method steps.

In particular embodiments, the invention comprises a step of addition of a reductant to the hydrolysis or the pre-hydrolysis liquor followed by filtration. Preferably with a polishing filter preferably comprising a porous glass filter. Preferably the polishing filter mesh size is less than 7 μm, more preferably less than 1 μm.

In particular embodiments, the method further comprises at least one step to reduce the concentration of at least one chromophore present in titanium dioxide. Preferably the at least one step comprises a step to reduce iron contamination and comprises addition of a reductant prior to or during hydrolysis. Preferably the reductant has a greater oxidation potential than the reduction potential of Fe3+. Preferably the reductant comprises at least one of Al, Zn or Fe.

In particular embodiments of any aspect described herein, the particulate material is iron slag or obtained from iron slag. In particular embodiments, the particulate material is melter slag from an iron manufacturing process. In particular embodiments, the material is melter slag from a steel manufacturing process.

In particular embodiments, the particulate material comprises i. titanium dioxide and at least one of the following components:
ii. silica;
iii. calcium oxide;
iv. aluminium oxide; and
v. magnesium oxide,

In particular embodiments, the method of the first aspect further comprises the step of grinding raw material comprising components i. to v. to form the particulate material of step a. In particular embodiments, the particulate material has a particle size of less than 180 μm. In preferred embodiments, the particulate material has a particle size from 10 to 180 μm, or from 40 to 110 μm. In particular embodiments, the particulate material has a particle size of approximately 30 μm, 45 μm, 60 μm, 70 μm, 80 μm, 90 μm, or 100 μm.

In particular embodiments, the particulate material comprises greater than 8 m % titanium dioxide. In other embodiments, the particulate material comprises greater than 10 m %, greater than 15 m %. greater than 20 m % or greater than 25 m % titanium dioxide.

In particular embodiments of the first aspect, the step of filtering the sulphated mixture further comprises contacting the mixture with compressed air. The temperature of the compressed air is preferably below 85° C. In particular embodiments, the temperature of the compressed air is from 10° C. to 85° C. Preferably, the compressed air is from 30° C. to 85° C., or approximately 50° C., 60° C., 70° C. or 80° C.

In particular embodiments of the first aspect, the excess sulphuric acid from the sulphated mixture is recycled to the sulphuric acid stream of step a.

In particular embodiments of the first aspect, the permeate comprising at least titanyl sulphate is dehydrated using a membrane to produce a concentrated permeate comprising at least titanyl sulphate in which the metal sulphates are concentrated.

In particular embodiments of the first aspect, the permeate comprising at least titanyl sulphate is heated to remove water and increase the free acidity. Preferably the permeate comprising at least titanyl sulphate is heated to greater than 100° C., more preferably greater than 130° C. and most preferably to greater than 160° C. or to boiling. In particular embodiments, the heated permeate comprising at least titanyl sulphate is filtered to remove residual sulphuric acid and the resulting filter cake (comprising precipitated titanyl sulphate and preferably other precipitated sulphates) is contacted with water to obtain a concentrated permeate comprising at least titanyl sulphate. This permeate may then be subjected to downstream process steps including hydrolysis and optionally precipitation of aluminium/magnesium.

In particular embodiments, the free acidity of the hydrolysis liquor is from 8-25%. In other embodiments, the free acidity of the hydrolysis liquor is from 9-15%.

In particular embodiments of the first aspect, the hydrolysis liquor is heated to a temperature between 85 and 140° C., 80 and 140° C., 90° C. and 120° C., or between 105° C. to 110° C. Preferably the hydrolysis liquor is heated for a period such that substantially all of the titanyl sulphate has reacted. Preferably, the heating period is from one hour to three hours. More preferably from 90 minutes to two hours or approximately 100 minutes. In particular embodiments, the solution is heated for about two hours at a temperature above 85° C. in order for hydrolysis to be completed.

In particular embodiments of the first aspect, the hydrolysis liquor is contacted with water containing titanium dioxide particles. Preferably the titanium dioxide particles are nanoparticles. Preferably, the amount of titanium dioxide particles added to the hydrolysis liquor is between 2 m % and 30 m % of the mass of the titanium dioxide calculated to be present in the liquor. More preferably, between 2 m % and 15 m % and preferably between 5 m % and 9 m %. Preferably, the particle size of the titanium particles added to the liquor is from 2 nm to 10 nm, more preferably 3 to 6 nm.

In particular embodiments of the first aspect, the method further comprises the step of sonicating the hydrolysis liquor to precipitate titanium dioxide hydrate from the solution. Preferably, the hydrolysis liquor is sonicated in the absence of heating.

In one embodiment of the first aspect, the method further comprises the step of calcining the titanium dioxide hydrate. Preferably calcining is carried out at a temperature of between 800 and 1100° C., between 800 and 1050° C., between 890-1050° C., or about 990° C.

In a second aspect, the invention provides at least one product produced by the method of the first, fourth, fifth, sixth or seventh aspects, the product being selected from:
a. titanium dioxide;
b. silica;
c. calcium sulphate;
d. aluminium sulphate;
e. magnesium sulphate; or
f. Titanium dioxide hydrate.

In particular embodiments, the at least one product is produced by a method comprising recycling excess sulphuric acid and decreasing the level of at least one contaminant in the excess sulphuric acid.

In particular embodiments, the product is produced by a method comprising recycling excess sulphuric acid and decreasing the level of contaminants in the excess sulphuric acid, wherein the product comprises titanium dioxide hydrate.

In particular embodiments, the titanium dioxide hydrate produced by the method comprises one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

In particular embodiments, the titanium dioxide produced by the method comprises a crystal colour specification of at least one of:
a. greater than 97% or 98% brightness; and
b. less than 1.8%, 2.5% or 2.8% blue tonality.

In particular embodiments, the titanium dioxide has a crystal size distribution centred on about 220 nm in diameter. In particular embodiments, the calcined titanium dioxide has a crystal size distribution less than 1.2 standard deviations from the target size of monodisperse particles.

In a third aspect, the invention provides a system for the recovery of products from a particulate material, the system comprising:
a. a sulphation reactor adapted to receive and heat sulphuric acid and particulate material comprising at least titanium dioxide and produce a sulphated mixture;
b. a first filtration unit adapted to receive the sulphated mixture and produce a first permeate comprising at least sulphuric acid, and a filter cake comprising at least titanyl sulphate;
c. a hydrolysis reactor adapted to receive a solution comprising titanyl sulphate and heat said solution to produce a hydrolysis liquor;
d. a separation unit adapted to receive the hydrolysis liquor and separate titanium dioxide hydrate; and
e. a recycling means adapted to recycle excess sulphuric acid from at least one of the first filtration unit and the separation unit.

In particular embodiments, the recycling means further comprises an acid regeneration plant.

In particular embodiments of the third aspect, the separation unit comprises a second filtration unit adapted to receive the hydrolysis liquor and produce a retentate comprising titanium dioxide hydrate. In alternative embodiments the separation unit comprises a centrifugation unit adapted to separate the precipitated titanium dioxide hydrate.

In particular embodiments of the third aspect, the system further comprises at least one precipitation tank to facilitate precipitation of aluminium sulphate or magnesium sulphate.

In particular embodiments, the system further comprises at least one further filtration unit to facilitate separation of precipitated aluminium sulphate or precipitated magnesium sulphate.

In a fourth aspect, the invention provides a method of recovering products from a particulate material comprising the following components:
i. titanium dioxide;
ii. silica;
iii. calcium oxide;
iv. aluminium oxide; and
v. magnesium oxide,

said method comprising:
a. contacting the particulate material with sulphuric acid from a sulphuric acid stream and heating to form a sulphated mixture;
b. filtering the sulphated mixture to produce a filter cake and a first permeate comprising excess sulphuric acid;
c. contacting the filter cake with water to form a sulphated suspension comprising titanyl sulphate;
d. filtering the sulphated suspension to produce a retentate comprising silica and calcium sulphate, and a permeate comprising at least titanyl sulphate;
e. contacting the permeate comprising at least titanyl sulphate with water to produce a hydrolysis liquor;
f. heating the hydrolysis liquor to hydrolyse the titanyl sulphate;
g. separating titanium dioxide hydrate by filtering the hydrolysis liquor to produce a retentate comprising titanium dioxide hydrate and a permeate comprising aluminium sulphate and magnesium sulphate;
h. precipitating aluminium sulphate and separating the precipitate by filtering the liquor to produce a retentate comprising precipitated aluminium sulphate, and a permeate comprising magnesium sulphate;
i. precipitating magnesium sulphate and separating the precipitate by filtering the liquor to produce a retentate comprising precipitated magnesium sulphate,

wherein excess sulphuric acid undergoes recycling from the permeate of at least one of step b., d., h. or i.

Preferably, the step of precipitating aluminium sulphate in the method of the fourth aspect comprises cooling the permeate comprising aluminium sulphate and magnesium sulphate to produce a cooled liquor comprising precipitated aluminium sulphate; and filtering the cooled liquor to produce a retentate comprising precipitated aluminium sulphate, and a permeate comprising magnesium sulphate.

Preferably, the step of precipitating magnesium sulphate in the method of the fourth aspect comprises increasing the acid concentration of the permeate comprising magnesium sulphate to form an acidified liquor; and filtering the acidified liquor to produce a retentate comprising precipitated magnesium sulphate.

In a fifth aspect, the invention provides a method of reducing chromophore concentration in recycled sulphuric acid in a titanium dioxide hydrate recovery process, the method comprising:
a. contacting a particulate material with sulphuric acid from a sulphuric acid stream and heating to form a sulphated mixture;
b. filtering the sulphated mixture to produce a filter cake and a first permeate comprising excess sulphuric acid;
c. recycling the excess sulphuric acid;
d. contacting the filter cake with water to form a sulphated suspension comprising titanyl sulphate;
e. hydrolysing the titanyl sulphate; and
f. separating titanium dioxide hydrate from the hydrolysis liquor;

wherein recycling the excess sulphuric acid further comprises reducing the concentration of one or more chromophores present in the excess sulphuric acid.

In a sixth aspect, the invention provides a method of reducing contaminant or chromophore concentration in titanium dioxide hydrate produced according to a method described in the first, or fourth aspects, the method comprising reducing the contaminant or chromophore concentration in the recycled sulphuric acid to achieve a final concentration of the contaminant or chromophore in the titanium dioxide hydrate of one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

In a seventh aspect, the invention provides a method of producing calcined titanium dioxide from a mixture comprising titanium dioxide hydrate and at least one contaminant, the method comprising: a. treating the mixture to decrease the concentration of the at least one contaminant and produce purified titanium dioxide hydrate;
b. addition of at least one dopant to the purified titanium dioxide hydrate to produce a doped mixture; and
c. heating the doped mixture comprising pre-calcination titanium dioxide hydrate for a period to produce calcined titanium dioxide.

Preferably the method further comprises:
i. heating the doped mixture from b. in water for a period to produce a pre-calcination liquor;
ii. drying the pre-calcination liquor to produce a pre-calcination titanium dioxide hydrate.

In particular embodiments, the calcined titanium dioxide comprises at least one of anatase and rutile titanium dioxide. In particular embodiments, the calcined titanium dioxide comprises greater than 95% or greater than 98% rutile titanium dioxide.

In particular embodiments, treating the mixture comprises at least one of a titanous sulphate leach, a sulphuric acid leach, and a water wash.

In particular embodiments, the titanous sulphate leach comprises the following steps:
i. contacting the mixture comprising titanium dioxide hydrate and at least one contaminant with a titanous sulphate (Ti³⁺ H₂SO₄) solution to produce a titanous sulphate leached liquor;
ii. heating the titanous sulphate leached liquor for a period;
iii. filtering the heated titanous sulphate leached liquor to produce a retentate comprising titanium dioxide hydrate, and a permeate comprising excess titanous sulphate solution and at least one contaminant.

In particular embodiments, the titanous sulphate solution comprises a concentration of between 2 and 10 g/kg titanous sulphate in 8 to 18% w/w sulphuric acid in water. Preferably the titanous sulphate solution comprises a concentration of about 5 g/kg titanous sulphate in about 13% w/w sulphuric acid.

In particular embodiments, the titanous sulphate leached liquor is heated to between 60 and 95° C. Preferably the titanous sulphate leached liquor is heated to about 70° C.

In particular embodiments, the titanous sulphate leached liquor is stirred. In particular embodiments, the period of heating the titanous sulphate leached liquor is between one and five hours. Preferably, the period of heating the titanous sulphate leached liquor is about two hours.

In particular embodiments, the permeate comprising excess titanous sulphate is recycled for re-use in step i. of the titanous sulphate leach.

In particular embodiments, the method of the first aspect comprises a titanous sulphate leach and the concentration of iron in the pre-calcination titanium dioxide hydrate is less than 10 ppm or less than 20 ppm.

In particular embodiments, the method of the first aspect comprises a titanous sulphate leach and the concentration of the following contaminants or chromophores in the pre-calcination titanium dioxide hydrate is one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

In particular embodiments, the titanous sulphate leach method described above is repeated at least once.

In particular embodiments, the sulphuric acid leach comprises the following steps:
i. contacting the mixture comprising titanium dioxide hydrate and at least one contaminant with sulphuric acid to produce a sulphuric acid leached liquor;
ii. heating the sulphuric acid leached liquor for a period;
iii. filtering the heated sulphuric acid leached liquor to produce a retentate comprising titanium dioxide hydrate and a permeate comprising excess sulphuric acid solution and at least one contaminant.

In particular embodiments, the sulphuric acid comprises a concentration of between 8 to 18% w/w sulphuric acid in water. Preferably the sulphuric acid comprises a concentration of about 13% w/w sulphuric acid in water.

In particular embodiments, the sulphuric acid leached liquor is heated to between 104 and 110° C.

In particular embodiments, the sulphuric acid leached liquor is stirred. In particular embodiments, the period of heating the sulphuric acid leached liquor is between one and five hours. Preferably, the period of heating the sulphuric acid leached liquor is about two hours.

In particular embodiments, the permeate comprising excess sulphuric acid is recycled for re-use in step i. of the sulphuric acid leach.

In particular embodiments, the method of the first aspect comprises a sulphuric acid leach and the concentration of the following contaminants or chromophores in the pre-calcination titanium dioxide hydrate is one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

In particular embodiments, the sulphuric acid leach method described above is repeated at least once.

In particular embodiments, the water wash comprises the following steps:
i. contacting the mixture comprising titanium dioxide hydrate and at least one contaminant with water for a period to produce an aqueous titanium dioxide hydrate solution;
ii. filtering the aqueous titanium dioxide hydrate solution to produce a retentate comprising titanium dioxide hydrate and a permeate comprising excess water and at least one contaminant.

In particular embodiments, the aqueous titanium dioxide hydrate solution is stirred.

In particular embodiments, the period for which the aqueous titanium dioxide hydrate solution is stirred is between five and 45 minutes. Preferably, the period for which the aqueous titanium dioxide hydrate solution is stirred is ten minutes.

In particular embodiments, the permeate comprising excess water is recycled for re-use in step i.

In particular embodiments, the water wash method described above is repeated at least once. Preferably the water wash is repeated two, three or four times more times.

In particular embodiments, the method of the first aspect comprises a water wash and the concentration of the following contaminants or chromophores in the pre-calcination titanium dioxide hydrate is one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

In particular embodiments, the method of the first aspect comprises a titanous sulphate leach, a sulphuric acid leach and a water wash, and the concentration of the following contaminants or chromophores in the pre-calcination titanium dioxide hydrate is one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

In particular embodiments, addition of at least one dopant to the purified titanium dioxide hydrate to produce a doped mixture comprises the addition of at least one of potassium oxide (K₂O), phosphorus pentoxide (P₂O₅), and aluminium oxide (Al₂O₃). In a particular embodiment, the potassium oxide is added at a concentration of between 0.1% and 0.4% w/w in aqueous solution. In an alternative embodiment, potassium oxide is added at a concentration of between 0.02% and 0.4% w/w in aqueous solution. In a particular embodiment, the phosphorus pentoxide is added at a concentration of between 0.1% and 0.3% w/w in aqueous solution. In an alternative embodiment, the phosphorus pentoxide is added at a concentration of between 0.001% and 0.4% w/w in aqueous solution. In a particular embodiment, the aluminium oxide is added at a concentration of between 0.1% and 0.8% w/w in aqueous solution. In an alternative embodiment, the aluminium oxide is added at a concentration of between 0.001% and 0.8% w/w in aqueous solution.

In a particular embodiment, the titanium dioxide is substantially monodisperse. Preferably the titanium dioxide comprises a geometric standard deviation of less than 1.5.

In particular embodiments, the doped mixture is heated in water at between 80 to 100° C., or at about 100° C.

In particular embodiments, the period of heating of the doped mixture is between 30 and 90 minutes, or about 60 minutes.

In particular embodiments, purified titanium dioxide hydrate is heated in water wherein the water is present in excess in a ratio to the purified titanium dioxide hydrate of between 2 and 3 times, or about is 2.5 times water to purified titanium dioxide hydrate.

In particular embodiments, the pre-calcination liquor is dried to remove substantially all free water in the pre-calcination liquor and produce pre-calcination titanium dioxide hydrate. Preferably, the drying is carried out in a fluidised bed heater.

In particular embodiments, the dopant mixing and drying may be carried out in the same vessel.

In particular embodiments, the pre-calcination titanium dioxide hydrate is ground.

In particular embodiments, the heating of the pre-calcination titanium dioxide hydrate is carried out in a rotary kiln furnace.

In particular embodiments, the heating of the pre-calcination titanium dioxide hydrate is carried out at between 800 and 1100° C., between 800 and 1050° C., between 890-1050° C., or about 990° C.

In particular embodiments, the pre-calcination titanium dioxide hydrate is heated for between one and eight hours, or about 4 hours.

In particular embodiments, the calcined titanium dioxide comprises a crystal colour specification of at least one of:
c. greater than 97% or 98% brightness; and
d. less than 1.8%, 2.5% or 2.8% blue tonality.

In particular embodiments, the calcined titanium dioxide has a crystal size distribution centred on about 220 nm in diameter. In particular embodiments, the calcined titanium dioxide has a crystal size distribution less than 1.2 standard deviations from the target size of monodisperse particles.

In a further aspect, the method of the seventh aspect is carried out in conjunction with the method of the first, fifth or sixth aspect or any embodiment thereof. It will be understood by those of skill in the art that the particular embodiments of methods described herein for producing calcined titanium dioxide from titanium dioxide hydrate will be applicable to any of the methods of producing titanium dioxide or one or more other products from a particulate material as described above.

In an eighth aspect, the invention provides a system for the recovery of titanium dioxide from a mixture comprising titanium dioxide hydrate and at least one contaminant, the system comprising:
a. a first leach vessel adapted to receive the mixture and carry out at least one of a titanous sulphate leach, a sulphuric acid leach, and a water wash;
b. heating means configured to heat the first leach vessel;
c. separation means adapted to separate purified titanium dioxide hydrate from a leach liquor following at least one of a titanous sulphate leach and a sulphuric acid leach, or to separate purified titanium dioxide hydrate from excess wash water following a water wash;
d. a doping tank adapted to receive purified titanium dioxide hydrate from the separation means and mix it with one or more dopants;
e. a drying means adapted to dry pre-calcination liquor from the doping tank;
f. a calcination reactor adapted to receive pre-calcination titanium dioxide hydrate from the drying means, wherein the reactor is coupled with a heating means adapted to heat the reactor to at least 800° C. to produce calcined titanium dioxide.

In particular embodiments, the system comprises one or more further leach vessels adapted to repeat one or more of the titanous sulphate leach, sulphuric acid leach, and water wash.

In particular embodiments, at least one of the first or further leach vessel, the doping tank and the calcination reactor comprises a mixing means configured to mix any contents.

In particular embodiments, the first or further leach vessel comprises a heating means adapted to heat the contents during one or more of the titanous sulphate leach, sulphuric acid leach, and water wash.

In particular embodiments, the doping tank comprises a heating means adapted to heat the contents.

In particular embodiments, the drying means comprises a heating means. Preferably the drying means comprises a fluidised bed heater.

In particular embodiments, the system comprises a grinder adapted to grind pre-calcination titanium dioxide hydrate received from the drying means.

In particular embodiments, the heating means coupled to the calcination reactor comprises a rotary kiln furnace.

In a further aspect, the invention provides a system for the recovery of titanium dioxide from a mixture comprising titanium dioxide hydrate and at least one contaminant, the system comprising apparatus according to the third aspect coupled to apparatus according to the eighth aspect.

In a ninth aspect, the invention provides a method of reducing the chromophore content of titanium dioxide, the method comprising:
a. treating a mixture comprising titanium dioxide hydrate and at least one chromophore to decrease the concentration of at least one chromophore and produce purified titanium dioxide hydrate;
b. addition of at least one dopant to the purified titanium dioxide hydrate to produce a doped mixture;
c. heating the doped mixture in water for a period to produce a pre-calcination liquor;
d. drying the pre-calcination liquor to produce a pre-calcination titanium dioxide hydrate;
e. heating the pre-calcination titanium dioxide hydrate for a period to produce calcined titanium dioxide.

Embodiments of the method of the first, fifth, sixth or seventh aspect or any embodiment thereof are also applicable to the ninth aspect described above.

The invention also includes the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

Embodiments of the invention will now be described, by way of example only, with reference to the accompanying drawings in which:

FIG. 1A shows a process flow diagram depicting an embodiment of the invention.

FIG. 1B shows a process flow diagram depicting an embodiment of the invention.

FIG. 2 shows the chemical composition of different slag samples as detailed in example 2.

FIG. 3 shows the chemical composition of different slag samples as measured by XRF in example 2 (for New Zealand and South Africa) and obtained from the literature in example 1 (for China and Russia).

FIG. 4a shows the amount of titanium dioxide measured in the permeate comprising titanyl sulphate as measured by the titration method in example 3. FIG. 4b shows the amount of titanium measured in the permeate as measured by the ICP-OES method in example 3.

FIG. 5 shows the ICP-OES measurements of titanium, calcium, aluminium and magnesium in the permeate.

FIG. 6 shows the concentration of metals ion spent acid versus the time of the sulphation reaction.

FIG. 7 shows spent acid composition for an embodiment of the invention in which acid is recycled during a sulphation reaction as described in example 10 (sulphation 1).

FIGS. 8 and 9 show spent acid composition for an embodiment of the invention in which acid is recycled during a sulphation reaction as described in example 10 (sulphation 2).

FIGS. 10A and 10B shows spent acid composition for an embodiment of the invention in which acid is recycled during a sulphation reaction as described in example 10 (sulphation 3).

FIGS. 11, 12 and 13 show yield data from the sulphation reactions described in example 10.

FIG. 14 shows extraction efficiency at different acid concentrations.

FIG. 15 shows x-ray diffraction analysis of the CalSi residue from a 78% sulphation versus a 90% sulphation.

FIG. 16 shows a sulphation reactor with headspace removal.

FIG. 17 shows the effect of removal of headspace by air ingress/egress from the headspace of the sulphation reactor

FIG. 18 shows an SEM image of calcined titanium dioxide produced according to the method outlined in example 16.

FIG. 19 shows an XRD diffractogram showing >98% conversion from anatase to rutile

### DETAILED DESCRIPTION OF PREFERRED EMBODIMENTS

### Definitions

Unless otherwise defined, the following terms as used throughout this specification are defined as follows:

The term “product” or the like is intended to encompass minerals recovered from the raw material or particulate material utilised in the described process. In particular embodiments, the products are titanium dioxide hydrate and at least one of magnesium sulphate, aluminium sulphate, calcium sulphate and silica.

The term “particulate material” is intended to encompass a raw material ground to small particles to permit contact of the sulphuric acid with each species of metal oxide. In particular embodiments, the particulate material has a particle size appropriate to facilitate the sulphation of substantially all of the titanium dioxide present in the particulate material. In particular embodiments, the particulate material has a particle size of less than 180 μm. In preferred embodiments, the particulate material has a particle size from 10 to 180 μm, or from 40 to 110 μm. In particular embodiments, the particulate material has a particle size of approximately 30 μm, 45 μm, 60 μm, 70 μm, 80 μm, 90 μm, or 100 μm.

The term “filter cake”, “cake” and the like refers to solid material present on a filter or membrane following evacuation of liquid (typically acid) from the mixture. In particular embodiments, the filter cake comprises titanyl sulphate and at least one of magnesium sulphate, aluminium sulphate, calcium sulphate and silica.

The term “residue” is intended to encompass a solid material from which water soluble metal sulphates have been recovered following a leaching process. This term and “CalSi Residue” are used interchangeably throughout this specification. In particular embodiments, the residue comprises calcium sulphate (gypsum) and silica. In particular embodiments, the residue further comprises unreacted metal oxides.

The term “free acidity” refers to the portion of the total acidity that exists in the form of acid, both ionized and un-ionized.

The term “reactor” includes any device consisting of one or more vessels and/or towers or piping arrangements in which materials of the invention can be processed, mixed and/or heated. Examples of reactors of the invention include continuous or batch infusion reactors.

The terms “mixture”, “solution” and “permeate” are used throughout the specification, wherein the constituents alter depending on the stage of the process in which the terms are used. Where appropriate, the term “mixture” refers to a liquid with at least one solid substance in suspension. The term “solution” refers to an aqueous substance. The term “permeate” refers to a liquid obtained from a filtration process.

Where mixing of different components and heating the mixture so produced is referred to herein, heating may be carried out on any one or more of the components of the mixture prior to heating, or on the mixture itself. The reference to “heating a mixture” or similar is intended to encompass the heating of any one or more components of said mixture prior to mixing.

Throughout this specification and any claims which follow, unless the context requires otherwise, the words “comprise”, “comprising”, “contain”, “containing” and the like, are to be construed in an inclusive sense as opposed to an exclusive sense, that is to say, in the sense of “including, but not limited to”.

“Perovskite” refers to a titanium-calcium oxide mineral composed of calcium titanate CaTiO₃. Perovskite typically has a cubic crystalline structure although the term as used herein is intended to refer to any form of calcium titanate. The terms perovskite and calcium titanate are used interchangeably.

“Fluid” refers to a material comprising one or more compounds that is able to flow. The fluid may also include one or more liquids, dissolved substances, suspended substances or solid substances.

The term “water” is referred to herein as being for example a solute or reactant to achieve the processes described. It will be appreciated by those of skill in the art that the term water does not imply that pure water is used; the water may be an aqueous solution containing one or more other components.

Where a concentration or percentage of an element is referred to (for example iron), it will be appreciated by those of skill in the art that the element is likely to be bound to other species, for example in ionic salts such as iron sulphate. However, analytical techniques allow the expression of the total amount of the element in the sample. In these cases, it is the total amount of the element in the sample that is being referred to, bound or unbound.

“Stirring” or “agitation” are to be read interchangeably as method steps to mix one component with another. The mixing may be achieved by methods known to those of skill in the art.

“Calcining” refers to a process whereby a substance is heated to a high temperature but below the melting or fusing point, causing loss of moisture, reduction or oxidation, and the decomposition of carbonates and other compounds.

“Gypsum” is CaSO₄.2H₂O. This term and “calcium sulphate” or CaSO₄ are used interchangeably throughout this specification.

The term “titanyl sulphate” is intended to cover other sulphate forms of titanium which may also be present following sulphation. Those of skill in the art will appreciate such further sulphated titanium species.

“Titanium dioxide hydrate” as referred to herein is intended to encompass solutions containing both titanium dioxide and titanium dioxide hydrate. It will be appreciated by those of skill in the art that the product of the hydrolysis of titanyl sulphate will be a mixture of titanium dioxide and titanium dioxide hydrate. Unless the context requires otherwise, where the term titanium dioxide hydrate is referred to herein, it will be understood that titanium dioxide may also be present. Where a proportion, ratio or percentage of titanium dioxide in a feedstock is referred to, it will be appreciated by a person skilled in the art that the actual form of the titanium dioxide may not be in a form appropriate to be purified. For example in perovskite, the form of the titanium dioxide is predominantly as calcium titanate (CaTiO₃).

Where analytical results or wording referring to titanium dioxide are provided, those analytical results or wording are intended to be read as the amount of titanium dioxide that may be bound with other elements, for example in calcium titanate.

“Anatase” means a crystal form of titanium dioxide. The common pyramid of anatase, parallel to the faces of which there are perfect cleavages, has an angle over the polar edge of 82.9°.

“Rutile titanium dioxide” or “rutile” means a crystal form of titanium dioxide. The common pyramid of rutile, parallel to the faces of which there are perfect cleavages, has an angle over the polar edge of 56.5°. The phrase “producing rutile titanium dioxide” or similar is not to be interpreted as meaning that pure, 100% rutile titanium dioxide is formed. It will be appreciated by those of skill in the art that some degree of contamination by contaminants or other forms of titanium dioxide will be present, although the predominant species present will be rutile titanium dioxide.

A “dopant” is an impurity added usually in comparatively small amounts to a substance to alter its properties or crystal growth characteristics.

A “melter” refers to any apparatus appropriate to use high temperatures to convert a solid mineral into a molten state. This term is also intended to incorporate smelters and blast furnaces.

A “system” comprises pipework and other features that would be typically employed to enable the extraction of minerals from a particulate feed. By way of example, the “system” may include pressure valves, heat exchangers, filters, instrumentation (pressure sensors, flow sensors, pH sensors) and mixing tees (static mixers).

“Regenerated”, “regenerating” and like terms when used in relation to recycled sulphuric acid means treating the acid in some way. Typically this is to achieve an increase in the concentration of the sulphuric acid or a decrease in the contaminant content of the sulphuric acid. Other treatment processes may also be incorporated into the regeneration process. Methods for the regeneration of sulphuric acid will be known to those of skill in the art and include the Contact Process as outlined herein.

“Recycled”, “recycling” and like terms means the acid being recycled is collected and re-used rather than being removed as a waste component. The recycled acid may be re-used in a method of recovering titanium dioxide hydrate as described herein, or another unrelated process. The recycled acid may undergo one or more processes to remove contaminants or undesirable compounds from the acid.

A “chromophore” as referred to herein is a contaminant responsible for imparting colour to a product of a process described herein.

“Sulphuric acid” as referred to herein may be of any concentration and is referred to as a weight for weight percentage (% w/w) concentration in aqueous solution. Other nomenclature may include m % or simply %.

These are intended to be used interchangeably and will be understood as being so by those of skill in the art.

“Fresh acid” refers to acid which is input to the sulphation process and which has not previously been recycled within the process described herein. Fresh acid may be obtained from known sources such as commercial suppliers or other processes.

“Excess sulphuric acid” as referred to herein means any sulphuric acid that remains unreacted following a reaction described herein.

“Crystal colour specification” is a metric for assessment of the properties of a crystal. It can be measured by a UV-Vis spectrometer in a 3-D spectrum comprising brightness, blue tonality and red tonality. L* is the lightness on a scale from bright white to black and is measured using the CIELAB colour space.

“Substantially monodisperse” means that the particle size of the titanium dioxide has a geometric standard deviation of less than about 1.5. A skilled person would appreciate how to calculate the GSD of a given particulate material. Although a greater dispersity yields a usable product for some applications, specialised applications it is preferable to have a GSD of less than about 1.5.

The inventors have devised methods for recovering valuable products from titanium-bearing minerals, such as calcium titanate or perovskite, in a way that is commercially viable. In particular, the inventors have demonstrated methods for extraction of titanium dioxide and optionally at least one of magnesium sulphate, aluminium sulphate, calcium sulphate or silica from melter slag, preferably from an iron-manufacturing process. In the case of melter slag, the process is surprisingly advantageous in that a number of high value minerals can by extracted from a material that is otherwise considered a waste product. In addition the invention provides a means for extracting said minerals while recycling the excess sulphuric acid used in the process of extraction. This provides a method that is economically efficient and environmentally sustainable.

In one embodiment, the inventors provide a method for the extraction of the products titanium dioxide hydrate, aluminium sulphate, magnesium sulphate, calcium sulphate and silica from a waste product and recycling extraction acids. Achieving the successful extraction of these products provides commercial advantages by enabling further value to be extracted from what is currently a waste product (perovskite).

Accordingly, in a further aspect, the invention provides a method of minimising waste from a titanium dioxide-containing product from an iron-making process. Minimising waste also has environmental advantages including reduction of pollution and reduction of land use for iron slag.

The methods described herein use large quantities of concentrated sulphuric acid. However, the disposal of used sulphuric acid poses considerable environmental and economic issues. To be disposed of responsibly, the acid must be neutralised and treated to ensure the discharge meets waste water discharge standards. This process requires neutralisation agents which can be costly and their production can lead to further environmental issues. To address these issues, the inventors have developed a novel method including recycling and optionally regenerating the spent acid. Recycling the acid reduces the overall environmental footprint of the method of recovering titanium dioxide by requiring lower acid input and lower waste output. Recycling the acid also reduces the economic and environmental costs associated with the single use and disposal of a highly corrosive substance. In summary, recycling the acid used in the titanium dioxide production process has the advantages of:
a. reducing the potential environmental impact of the excess acid if it is disposed of as a waste product;
b. avoiding the cost, energy and feedstocks required to neutralize the acid prior to being disposed of as a waste product;
c. reducing the economic cost associated with the treatment and disposal of the used acid;
d. reducing the requirement for new acid therefore increasing cost efficiency of the process;
e. increasing the efficiency of the hydrolysis reaction by minimizing acid content of the titanyl sulphate.

During the hydrolysis of titanyl sulphate, a high concentration of acid acts to inhibit the reaction.

Accordingly, the inventors have found that recycling the excess acid also helps to increase the efficiency of the titanyl sulphate hydrolysis step.

The inventors have also developed methods to produce titanium dioxide from titanium dioxide hydrate, wherein the titanium dioxide has preferred crystal sizes, dispersity and concentrations of contaminants (including chromophores), especially chromium, vanadium and iron. The methods developed by the inventors increase the efficiency of production of titanium dioxide by reducing the washing requirements to purify the titanium dioxide (i.e. remove the contaminants).

The inventors found during development of the invention that regeneration of excess sulphuric acid leads to a problem of particular relevance for the production of titanium dioxide. Namely that a number of contaminants are retained in the recycled acid and therefore accumulate following a single or multiple cycles. Some contaminants are co-extracted with titanium dioxide hydrate or other products of the process. Many contaminants are also chromophores which, due to their colour, affect the purity and colour of the products. Quality and commercial value of the products can be affected by the presence of chromophores. The colour of products of the process described herein is particularly important therefore the presence of chromophores can be particularly detrimental. This problem is especially acute for titanium dioxide which, when pure, is a white pigment with a very high refractive index. The pigment is widely employed as a pigment to provide whiteness and opacity to products such as paints, coatings, plastics, papers, inks, foods, medicines (i.e. tablets) and toothpastes. Chromophore species of particular concern are iron, magnesium, lithium, zinc, copper, chromium, nickel, cobalt, vanadium, arsenic, molybdenum, manganese, selenium or a salt form of any one or more thereof. The inventors have found that if these chromophores are allowed to accumulate in the recycled acid, the colour, brightness and degree of rutilisation of the end-product are detrimentally affected. In addition, these three metrics determine the quality of the titanium dioxide end-product and certain standards must be met in order to produce a commercially acceptable product. If these metrics are compromised the value of the product is reduced. Accordingly, in one aspect, the invention provides a method of reducing the chromophore content of recycled acid in a method of producing titanium dioxide and optionally other products. Methods of production of titanium dioxide are described in any one of PCT/NZ2015/050084, PCT/NZ2015/050085 or PCT/NZ2015/050086 and the methods of these applications have been improved in the present invention to reduce chromophore contamination and reliably recycle acid without chromophore accumulation.

Contaminants present in the recycled acid also affect the quality of aluminium sulphate produced by the processes described herein. Since aluminium sulphate is often used for water treatment, the concentrations of certain compounds such as chromium, iron and heavy metals must be carefully controlled in order to provide a commercially acceptable product. Accordingly, the inventors have shown that by using the methods described herein including recycling and decrease of the concentration of contaminants in the recycled acid, improved, commercially acceptable products can be produced from what is normally a waste material.

The issues encountered by the inventors with accumulation of contaminants in the recycled acid and carry-through to the products of the process are typically not encountered when prior art methods of producing titanium dioxide are employed. For example titanium dioxide production using the ilmanite route (sulphate route) does not encounter the same problems. Accordingly, the contaminant/chromophore content of the product is reduced. Similarly, in the chloride route (using a feedstock of rutile or synthetic rutile), the chromophores are not an issue. This is because the precursor to titanium dioxide in the chloride route is titanium tetrachloride which is distilled and therefore the carry-over of contaminants/chromophores is minimised.

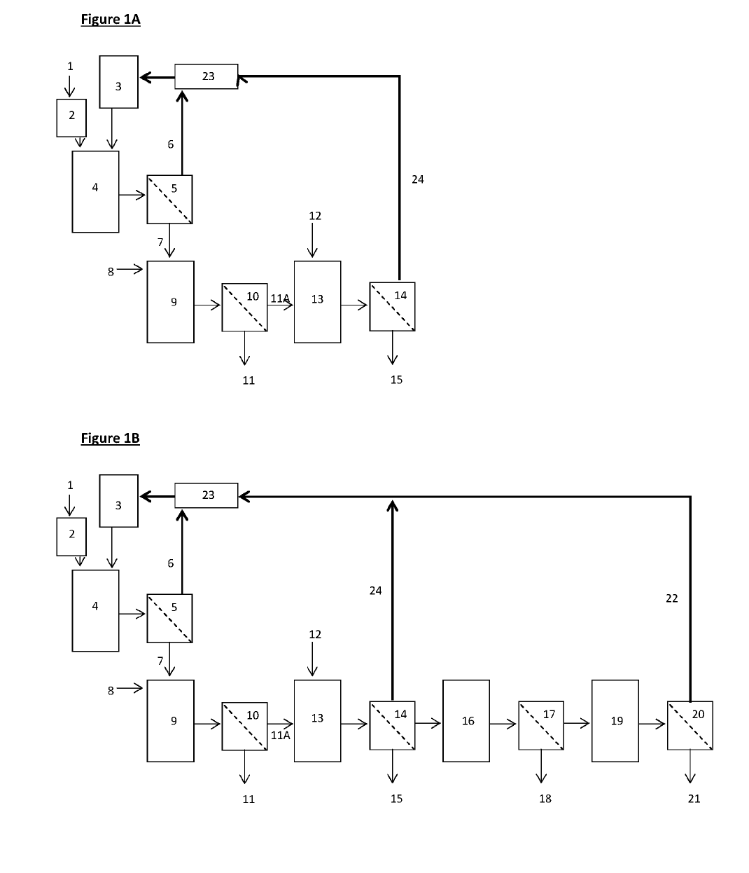

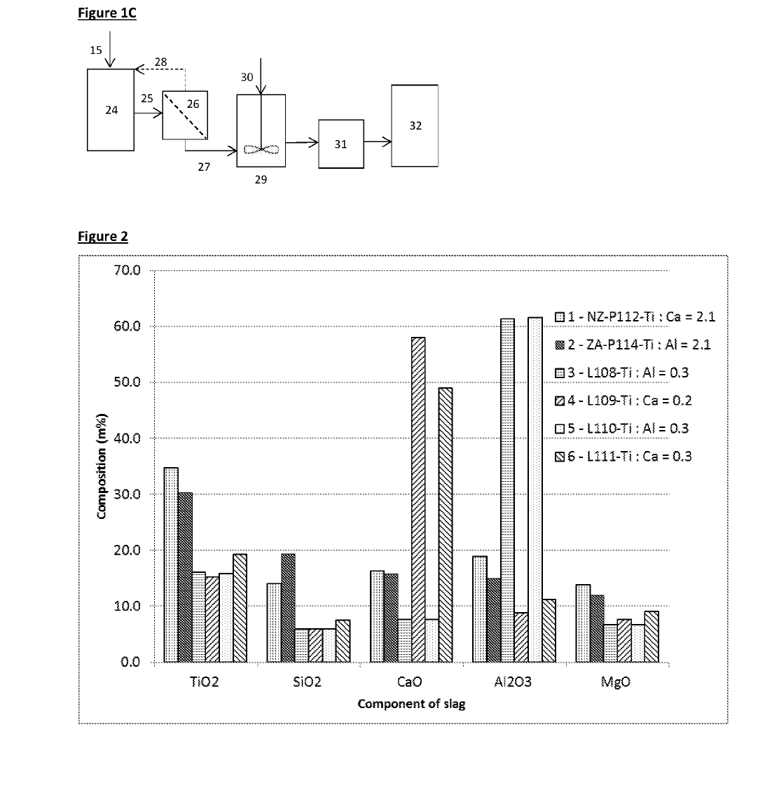

FIG. 1A shows an embodiment of the invention in which minerals 1 are ground in a grinder 2 to produce a particulate material. The particulate material is contacted with a sulphuric acid stream from an acid holding tank 3 in a sulphation reactor 4 before being filtered in a first filtration unit 5 to produce a permeate comprising sulphuric acid 6, and a filter cake 7. The sulphuric acid 6 may be recycled directly to the sulphuric acid stream or via an acid regeneration plant 23. The filter cake is contacted with water 8 to form a sulphated suspension in a reactor 9. The sulphated suspension is filtered in a second filtration unit 10 to yield a retentate comprising insoluble residue 11 and a permeate comprising at least titanyl sulphate 11A. Water 12 is added to the permeate which is then passed to a hydrolysis reactor 13. Following hydrolysis, the fluid is filtered in a third filtration unit 14 and precipitated material (predominantly titanium dioxide hydrate) is removed in a retentate 15. Acid from the permeate may optionally be recycled 24 through an acid regeneration plant 23.

FIG. 1B shows an embodiment of the invention in which minerals 1 are ground in a grinder 2 to produce a particulate material. The particulate material is contacted with a sulphuric acid stream from an acid holding tank 3 in a sulphation reactor 4 before being filtered in a first filtration unit 5 to produce a permeate comprising sulphuric acid 6, and a filter cake 7. The sulphuric acid 6 may be recycled directly to the sulphuric acid stream or via an acid regeneration plant 23. The filter cake is contacted with water 8 to form a sulphated suspension in a reactor 9. The sulphated suspension is filtered in a second filtration unit 10 to yield a retentate comprising insoluble residue 11 and a permeate comprising at least titanyl sulphate 11A. Water 12 is added to the permeate which is then passed to a hydrolysis reactor 13. Following hydrolysis, the fluid is filtered in a third filtration unit 14 and precipitated material (predominantly titanium dioxide hydrate) is removed in a retentate 15. Acid from the permeate may optionally be recycled 24. The permeate is passed to a precipitation tank 16 in which aluminium sulphate is precipitated. The precipitate is then separated by filtration in a fourth filtration unit 17. The retentate comprising aluminium sulphate is removed 18 and the permeate passed to a second precipitation tank 19. Following precipitation of dissolved magnesium sulphate, the fluid is filtered in a fifth filtration unit 20 and a retentate comprising magnesium sulphate 21 collected. The permeate (comprising predominantly acid) is collected and may be recycled 22 through an acid regeneration plant 23.

The inventors have also invented a novel method for treatment of the titanium dioxide hydrate to reduce contaminant concentration. The novel methods may be used in conjunction with methods described herein for production of titanium dioxide hydrate with recycled acid, or they may be used alone. By combining these methods, a single process for producing high quality titanium dioxide with minimal contaminant concentration is achieved. FIG. 1C shows an embodiment of the invention in which titanium dioxide hydrate 15 is fed to a leach vessel 24 in which at least one of a titanous sulphate leach, a sulphuric acid leach, and a water wash is carried out. A leach liquor 25 is fed from the first leach vessel 24 to a separation means 26. Purified titanium dioxide hydrate 27 is separated and the excess leach liquor or wash water is optionally recycled 28 to the leach vessel 24. Purified titanium dioxide hydrate 27 is fed to a doping tank 29 for mixing with one or more dopants 30. The pre-calcination liquor is fed from the doping tank 29 to a drying means 31 which dries the liquor to yield pre-calcination titanium dioxide hydrate. The pre-calcination titanium dioxide hydrate is ground then fed into a calcination reactor 32 for heating to produce calcined titanium dioxide.

Accordingly, in one aspect, the invention provides a method of recovering titanium dioxide hydrate from a particulate material, the method comprising:
a. contacting the particulate material with sulphuric acid from a sulphuric acid stream and heating to form a sulphated mixture;
b. filtering the sulphated mixture to produce a filter cake and a first permeate comprising excess sulphuric acid;
c. contacting the filter cake with water to form a sulphated suspension comprising titanyl sulphate;
d. filtering the sulphated suspension to produce a permeate comprising at least titanyl sulphate, and a retentate comprising insoluble residue;
e. contacting the permeate comprising at least titanyl sulphate with water to produce a hydrolysis liquor;
f. hydrolysing the titanyl sulphate to produce a hydrolysed liquor; and
g. separating titanium dioxide hydrate from the hydrolysed liquor,

wherein excess sulphuric acid from at least one of the first permeate and the hydrolysed liquor undergoes recycling.

In particular embodiments, the method further comprises recovering at least one other product selected from the group consisting of calcium sulphate, silica, aluminium sulphate or magnesium sulphate.

Feedstock

The feedstock used in the process is a titanium-bearing mineral. However, for ease of describing the process, the feedstock exemplified is melter slag from an iron manufacturing process. Melter slag is typically a by-product of the iron or steel manufacturing process, produced at the melter stage of the process. It is commonly used as an aggregate for road building and surfacing.

In particular embodiments, the material is iron slag. In particular embodiments, the material is melter slag from an iron manufacturing process. In particular embodiments, the material is melter slag from a steel manufacturing process. Melter slag is primarily comprised of perovskite by mass (CaTiO₃) in a mixed metal oxide matrix. An example of melter slag constituents is provided below in Table 1, which details the constituents of melter slag produced in New Zealand by NZ Steel's steel manufacturing process.

TABLE 1
NZ Steel Melter Slag

| Constituent | m % |
|---|---|
| TiO₂ | 32.1 |
| Al₂O₃ | 17.8 |
| MgO | 13.3 |
| CaO | 15.9 |
| SiO₂ | 15.2 |
| Fe₂O₃ | 2.34 |
| V₂O₅ | 0.2 |

In order to prepare the feedstock for use in the process, the raw material (e.g. melter slag) is preferably ground into a particulate material by any means known by persons of ordinary skill in the art. The rate and efficiency of mineral extraction from perovskite is dependent on the grind size. In particular embodiments, the material is ground to less than 180 μm. In preferred embodiments, the material is ground to approximately 45 μm.

Accordingly, in particular embodiments, any of the methods of recovery of products described herein may contain the further step of grinding raw material comprising one or more of the constituents in table 1 to form particulate material. In particular embodiments, the particulate material has a particle size of less than 180 μm. Having this particle size provides for efficient sulphation of the oxides. However, using the methods described herein, the inventors have found that a smaller particle size is only beneficial up to a point. If the particle size is reduced too far, for example to less than around 10 μm, the efficiency of the filtration step to remove acid is reduced. It is believed that this reduction in efficiency is caused by the filter becoming blocked. Accordingly, in preferred embodiments, the particulate material has a particle size from 10 to 180 μm, or from 40 to 110 μm. In particular embodiments, the particulate material has a particle size of approximately 30 μm, 45 μm, 60 μm, 70 μm, 80 μm, 90 μm, or 100 μm.

A skilled person will appreciate the methods to achieve particle size reduction. In one embodiment, the grinding is carried out in a ballmill. Particle size may be measured according to methods known to those of skill in the art, for example laser diffraction.

The inventors have found that the relatively high level of titanium dioxide and other materials in melter slag make it a suitable feedstock for use in the recovery methods described herein. Accordingly, in particular embodiments, the invention provides a method of recovering at least one product from a particulate material comprising greater than 8 m %, greater than 10 m %, greater than 15 m % greater than 20 m % or greater than 25 m % titanium dioxide. Generally the higher the titanium dioxide content, the more valuable the particulate material, and the more economically viable the process of recovery is. Accordingly, it is preferably that the particulate material comprises at least than 15 m % titanium dioxide.

One of the key advantageous aspects of the methods of the invention described herein is the ability to recover more than one substantially purified product from the particulate material. By doing this, the waste from the process is reduced, and the products can be used or sold separately. This increases the economic viability of the process and reduces land use for storage of the waste material. Accordingly, the invention provides a method of recovery of titanium dioxide and at least one other product selected from silica, calcium sulphate, aluminium sulphate and magnesium sulphate.

The inventors have found that the order of the steps in the method described herein is an important factor in optimising yields of the most valuable materials. Early trials by the inventors (see example 3, samples 7, 8, 9 and 10) tested the aluminium sulphate precipitation step prior to the titanium dioxide production and recovery step (i.e. hydrolysis). The yield of titanium dioxide when hydrolysis was carried out after aluminium sulphate precipitation was lower than when carried out before, probably due to co-precipitation of the two components. Accordingly, it is preferable to carry out titanium hydrolysis prior to aluminium sulphate precipitation. This is especially true where the ratio of titanium dioxide to aluminium oxide is relatively low (see example 1 table 3). Additionally, the step of magnesium sulphate precipitation is carried out after the precipitation of aluminium sulphate and titanium dioxide. If magnesium sulphate precipitation is carried out prior to recovery of either aluminium sulphate or titanium dioxide, the co-precipitation of these components with magnesium sulphate would reduce the economic viability of the method and reduce the purity with which the products could be obtained.

In particular embodiments, the invention provides a method of recovering titanium dioxide hydrate and at least one other product from a particulate material comprising greater than 8 m %, greater than 10 m %, greater than 15 m % greater than 20 m % or greater than 25 m % titanium dioxide, and greater than 10 m % or greater than 13 m % aluminium oxide. It is particularly preferable to use a feedstock comprising at least 15 m % titanium dioxide and at least 13 m % aluminium oxide. The method preferably comprises carrying out the step of titanium hydrolysis prior to aluminium sulphate precipitation when the ratio of titanium dioxide to aluminium oxide (TiO₂:Al₂O₃) 0.2 to 2.6, more preferably 0.25 to 2.1.

Metal Sulphation

The particulate material is introduced to an appropriate reactor, such as a fusion reactor, where it is combined with the desired amount of sulphuric acid to form a sulphated mixture. Although it would generally be thought of as being inefficient to use a large stoichiometric excess of reagents in a reaction, the inventors have found that a substantial excess of sulphuric acid results in decreased viscosity of the sulphated mixture. In particular, it was found that using a stoichiometric excess of two times or less results in a highly viscous mixture that is difficult to pump. Accordingly, in particular embodiments, the particulate material is contacted with greater than 2 times, or 2-15 times, or preferably 4-10 times its stoichiometric quantity of sulphuric acid. In preferred embodiments, the particulate material is contacted with between 5 and 6 times, or approximately 6 times its stoichiometric quantity of sulphuric acid.

In using a stoichiometric excess of sulphuric acid, there is a substantial quantity of sulphuric acid that is left unreacted—i.e. excess sulphuric acid. The inventors have found that it is economically and environmentally advantageous to recycle and optionally regenerate the excess sulphuric acid for re-use.

The key reactions relating to the processes and which are used by the inventors to determine the stoichiometric quantities of reaction components are:

CaTiO₃+2H₂SO₄→CaSO₄+TiOSO₄+2H₂O

MgO+H₂SO₄→MgSO₄+H₂O

Al₂O₃3H₂SO₄→Al₂(SO₄)₃+3H₂O

To calculate stoichiometric acid consumption per 100 g of slag the following equation is used:

$$Stoichiometric {H}_{2} {SO}_{4} ( per 100 g slag ) = {\sum }_{n = 1}^{∞} ( \frac{{( \% Metal oxide )}_{n}}{{( Molar mass oxide )}_{n}} ) * Molar mass {H}_{2} {SO}_{4} ( 98 )$$

Where “n” is each metal oxide in its highest stable oxidation state that is digestible by H₂SO₄.

“% Metal oxide” is the % of that metal oxide reported by XRF.

The following worked example shows calculation of the stoichiometric quantity of acid based on a sample of particulate material from iron ore slag:

TABLE 1A
XRF analysis of New Zealand Steel slag

| | Component (m %) measured by XRF analysis | | | | | |
|---|---|---|---|---|---|---|
| Slag source | TiO₂ | SiO₂ | CaO | Al₂O₃ | MgO | Sum |
| New Zealand (NZS) | 34.8 | 14.1 | 16.3 | 19.0 | 13.8 | 98.0 |

Stoichiometric Acid Quantity

$$Stoichiometric {H}_{2} {SO}_{4} ( per 100 g slag ) = ( {TiO}_{2} \frac{34.8}{79.86} * 98.08 ) + ( CaO \frac{16.3}{56.08} * 98.08 ) + ( {Al}_{2} {O}_{3} \frac{19.0}{101.96} * 98.08 ) + ( MgO \frac{13.8}{40.30} * 98.09 ) = 123.1098 g {H}_{2} {SO}_{4} per 100 g slag$$

$${H}_{2} {SO}_{4} ( per 100 g slag ) excess = Stocihiometric acid * Excess multiplier$$

$$Where the {}^{″} Excess {multiplier}^{″} is the number of excesses required 10 \times stoichiometric excess examples for NZS$$

$${H}_{2} {SO}_{4} ( per 100 g slag ) excess = 123.1098 * 10 = 1231.098 g {H}_{2} {SO}_{4} per 100 g slag$$

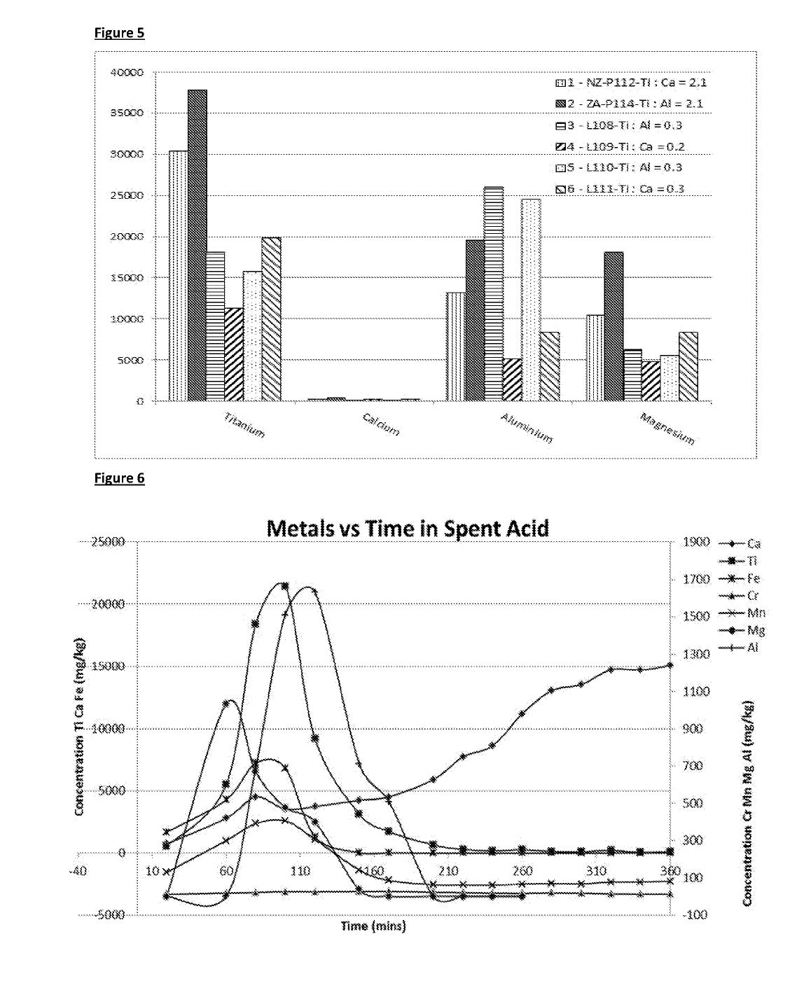

The inventors found that as the sulphation reaction proceeds, contaminant concentration in the spent acid (i.e. acid to be recycled) increased. This is clearly shown in FIG. 6. In order to maintain a high quality product, it is essential that contaminant build up is minimised. This is especially the case where acid recycling is used because accumulation of contaminants will occur. If contaminants are allowed to be recycled or are retained in the filter cake, the final products of the process will be substandard.

Accordingly, it is preferable to reduce or maintain the contaminant or chromophore concentration in the spent acid to a concentration of one or more of the following:
a. iron less than 50 ppm;
b. chromium less than 20 ppm;
c. nickel less than 2 ppm;
d. vanadium less than 15 ppm;
e. manganese less than 100 ppm; or
f. copper less than 15 ppm.

In addition, it is preferable to reduce contaminant or chromophore concentration in the titanium dioxide hydrate product produced according to a method described in the first, fourth, fifth, sixth, seventh eighth or ninth aspects. Preferably the final concentration of the contaminant or chromophore in the titanium dioxide hydrate of one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

In a further embodiment, the final concentration of the contaminant or chromophore in calcined titanium dioxide is less than the values shown in table 24.

The invention preferably provides titanium dioxide hydrate with the contaminant concentration being the higher of the two ppm levels provided above. This level of contaminants is suitable for many commercial uses of titanium dioxide. For some uses however, it is preferable to have the lower concentration of said contaminants or chromophores which provides a superior product specification.

A further problem that the inventors encountered was the viscosity of the sulphated suspension following the sulphation reaction. Without wishing to be bound by theory, it is believed that this viscosity problem is caused by the production of water during the sulphation reaction and resultant lowering of the acid concentration when acid recycling occurs.

During sulphation, the key reactions of the components of this particular feedstock (CaTiO₃, MgO and Al₂O₃) all produce water. As such, the methods of the present invention are particularly applicable to feedstocks where the comprising greater than 8 m % titanium dioxide, greater than 10 m % aluminium oxide and greater than 7 m % magnesium oxide. It is particularly preferable to use a feedstock comprising at least 15 m % titanium dioxide and at least 13 m % aluminium oxide.

The following table details the proposed products which cause the increase in viscosity:

| Proposed Titanium salt produced | |
|---|---|
| during sulphation | Approx. acid concentration |
| Ti(SO₄)₂ | >80% |
| TiO(SO₄)₂•2H₂SO₄ | 60-80% |
| TiO(SO₄)•H₂SO₄•H₂O | 60-80% |
| TiO(SO₄)•2H₂O | <60% |

TiO(SO₄)₂.2H₂SO₄, TiO(SO₄).H₂SO₄.H₂O and TiO(SO₄).2H₂O yield a viscous mixture therefore it is preferable to use acid at a concentration greater than about 80%. If these forms are produced this substantially lowers the efficiency of the leaching step (see below).

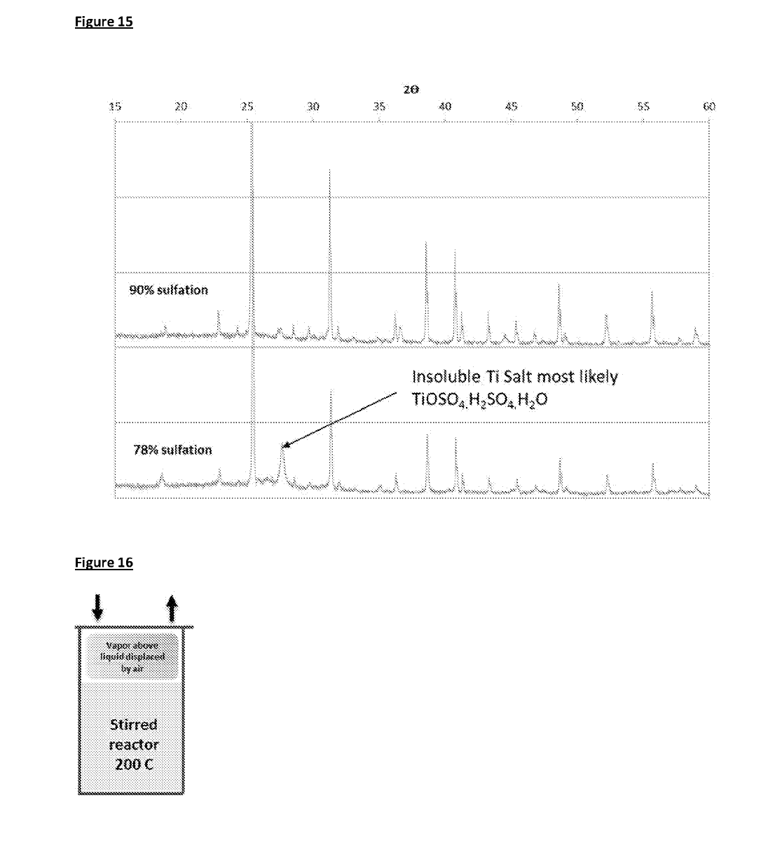

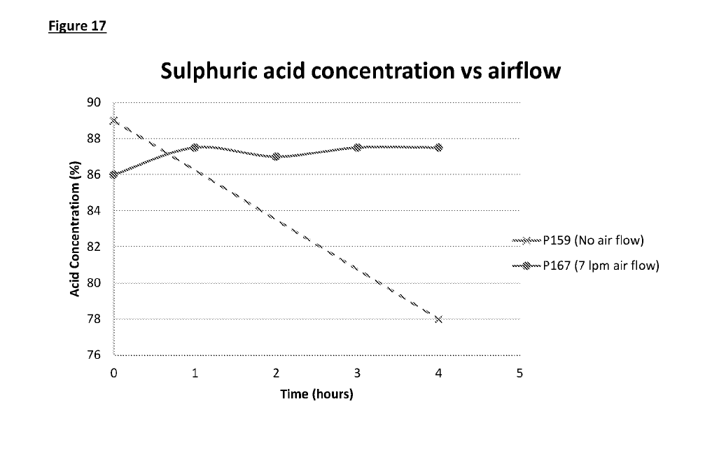

Example 12 and FIG. 14 provide support for the above hypothesis. Example 12 describes experiments carried out to assess the efficiency of the sulphation reaction with respect to the different elements aluminium, magnesium and titanium. FIG. 14 shows that while aluminium and magnesium conversion efficiency is consistently high using weaker acid, titanium sulphation efficiency increases substantially as acid strength increases from 72% to 82%. However, although the yield of titanium dropped with lower acid concentrations, x-ray diffraction analysis (FIG. 15) of the CalSi residue from the sulphation using 78 m % sulphuric acid versus a 90 m % sulphation showed the titanium had been digested as there was no evidence of undigested CaTiO₃ (these peaks would be very intense). Instead, the 78% sulphation included a peak which is believed to be the insoluble titanium salt TiOSO₄.H₂SO₄.H₂O. This new salt has a low solubility in water and hence lowered the titanium extraction efficiency during the leach.

The sulphation reaction proceeds according to the key reactions detailed above. Clearly all of these reactions produce water as a by-product. It is believed that the undesirable accumulation of contaminants/chromophores during and after sulphation and in the recycled acid is caused by the production of water and dissolution of the contaminants/chromophores in the water produced.

In order to achieve the surprisingly low contaminant concentrations in the spent/recycled acid and the titanium dioxide hydrate product, while still recycling acid, the inventors developed particular method steps. FIG. 6 shows the effect of employing these method steps after about 60 minutes where the chromophore/contaminant concentration is reduced. This indicates that the steps take effect and the contaminants/chromophores precipitate from the acid water mixture.

Therefore in particular embodiments, the method comprises a step of minimising water accumulation during sulphation, for example the sulphation step a. of the first, fourth or fifth aspects of the invention. The steps taken by the inventors to help to address the problems outlined above include at least one of the following:
use of a stoichiometric excess of acid (for example 2-15 or 4-10 times the stoichiometric ratio of acid to feedstock reactants)
use of heating to a temperature and for a period sufficient to remove water generated during the reaction and maintain a high concentration acid;
removal of headspace from the sulphation reactor.

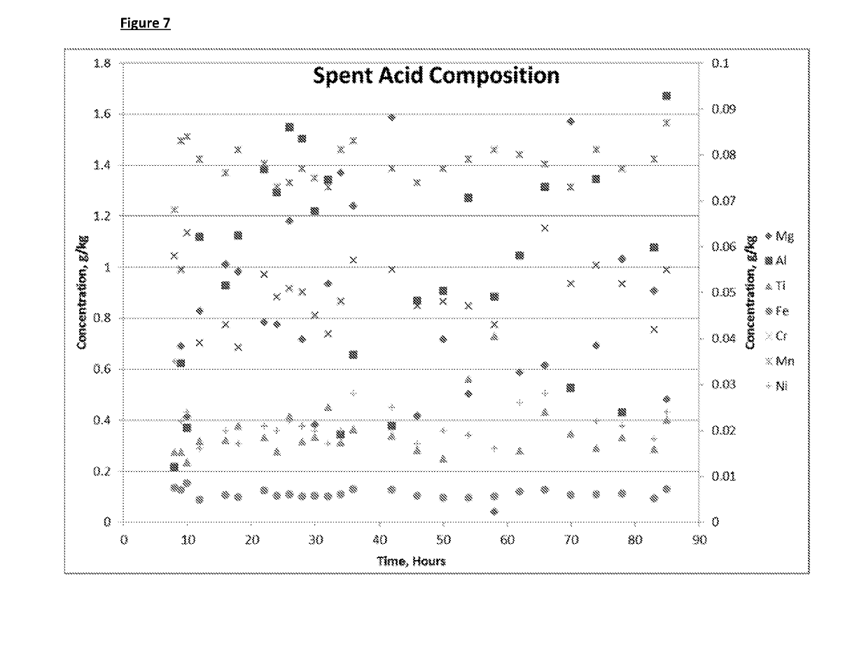

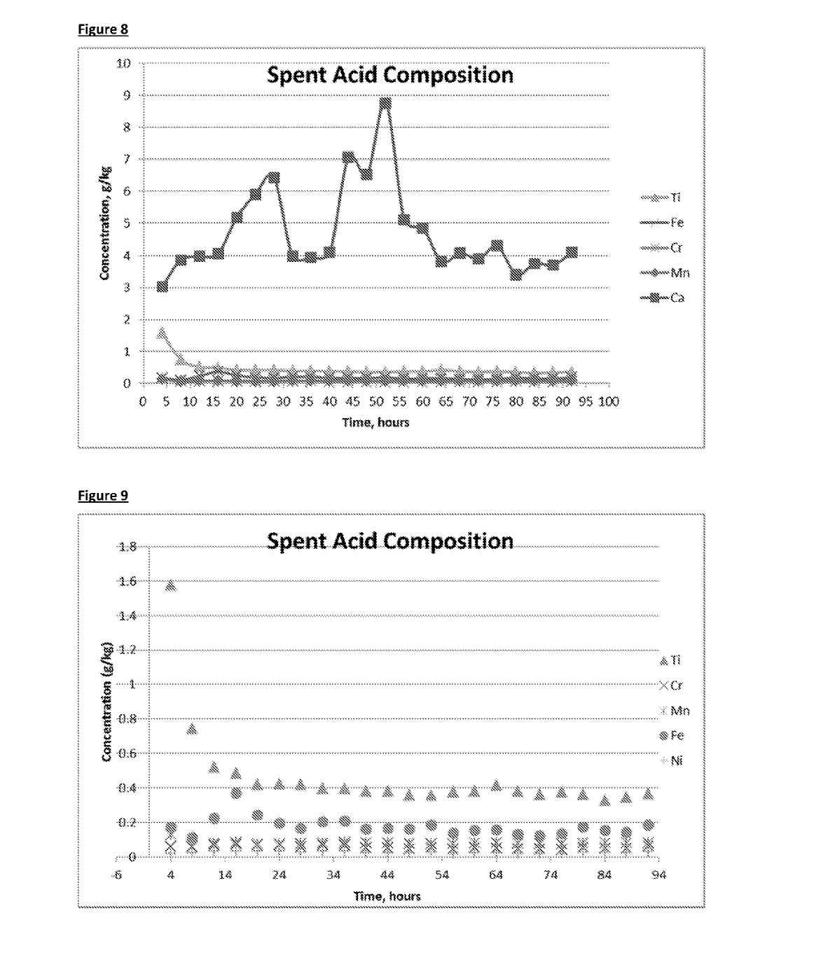

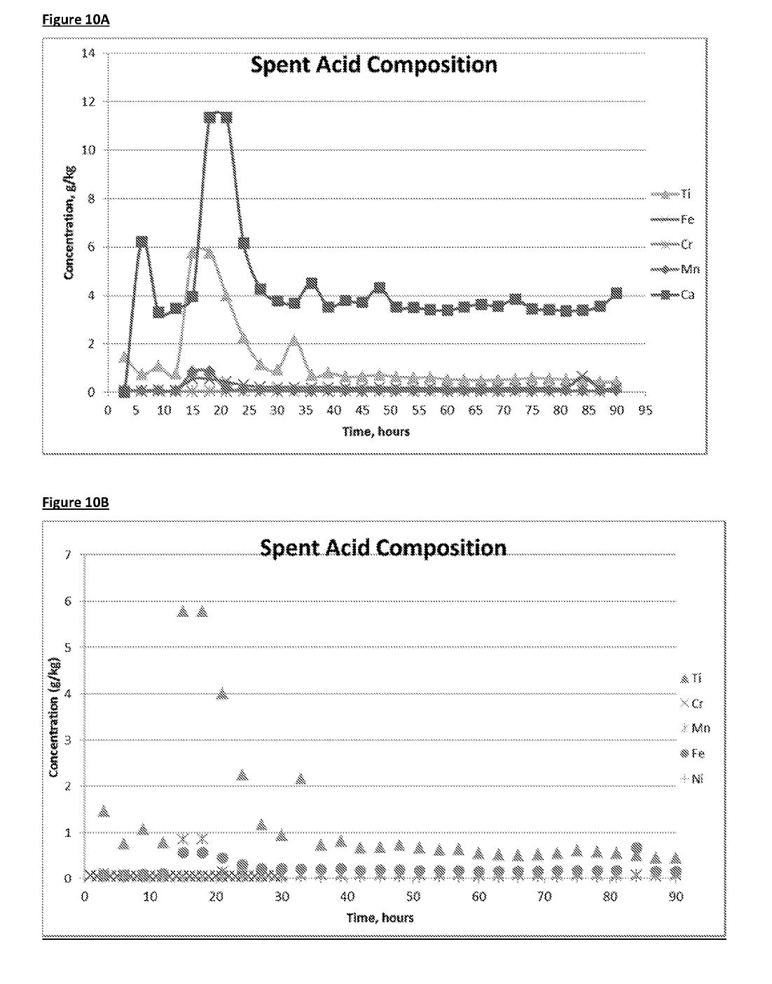

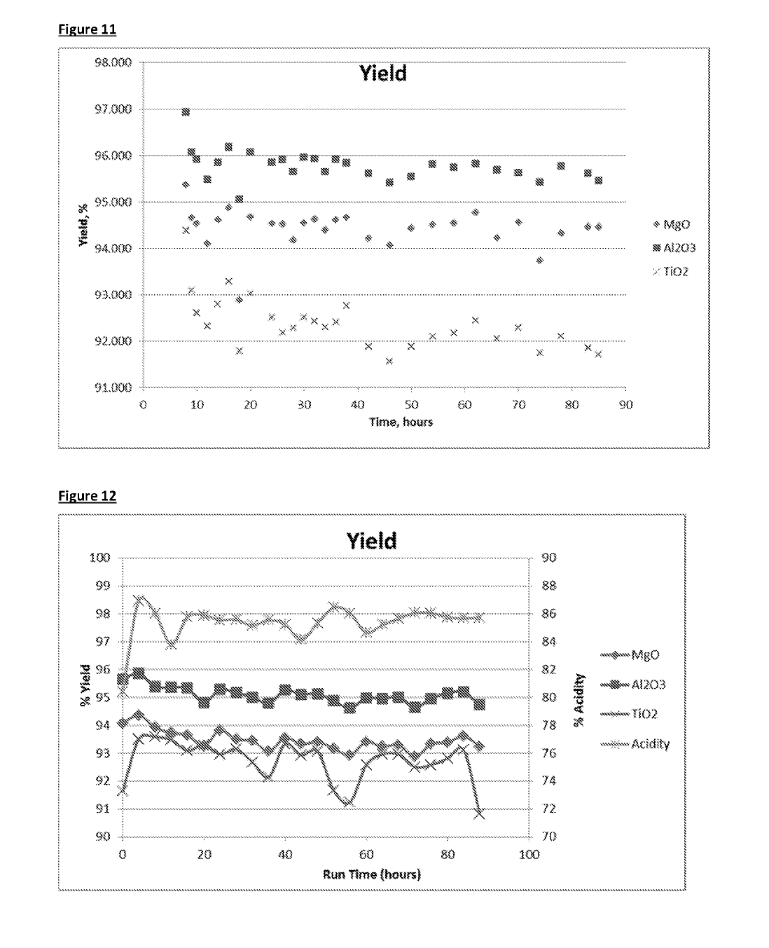

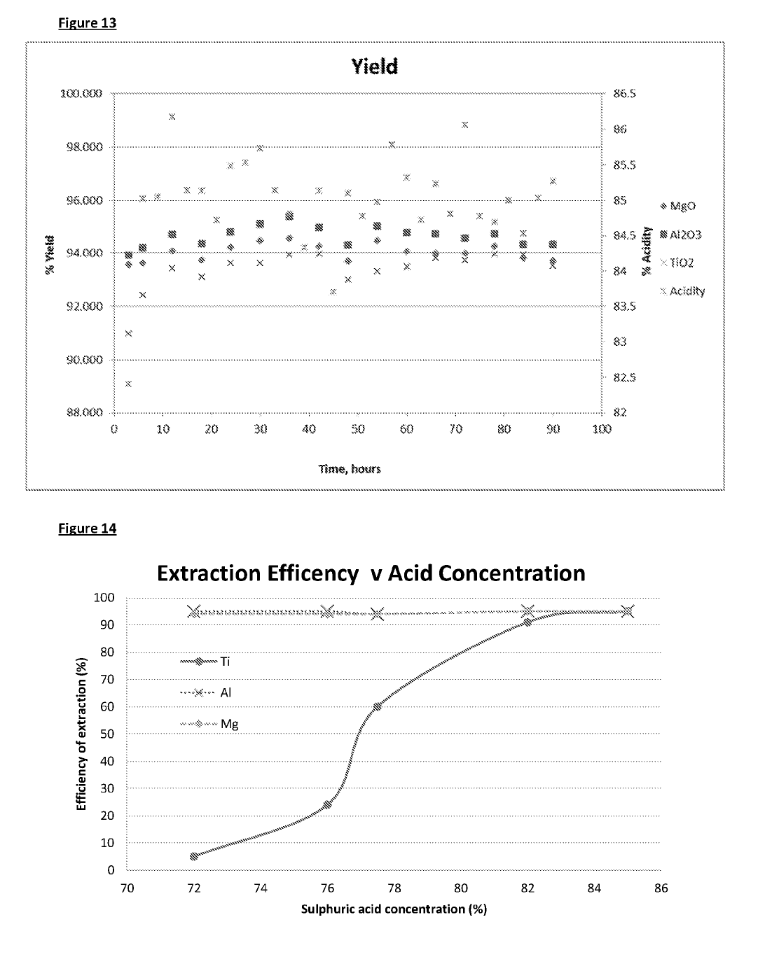

These steps were employed in experiments conducted by the inventors described in example 10. Spent acid composition is shown in FIGS. 7, 8, 9 and 10. It can be seen that although there is some variability in the concentrations of contaminants, the levels did not increase significantly over time. Yield data is shown in FIGS. 11, 12 and 13 and demonstrates that the sulphation reaction using recycled acid provided a good yield of products magnesium oxide, aluminium oxide and titanium dioxide from the feedstocks described herein. These surprising results demonstrate that far from being solely a waste product and environmental hazard, the iron ore slag from manufacturing plants can be used to produce valuable products for us in other industries. This reduces environmental issues, provides value for the processor and increases the viability of extracting iron ore deposits.

The sulphation temperature and heating periods described herein are intended to achieve removal of water generated during the sulphation reaction. In a particular embodiment however, the sulphation step a is heated to a temperature of at least 150° C. for a period of at least 15 minutes, or for a period to achieve a steady state acid concentration of at least 80%. A steady state acid concentration is intended to mean that the acid concentration does not vary by greater than +/−2 m %.

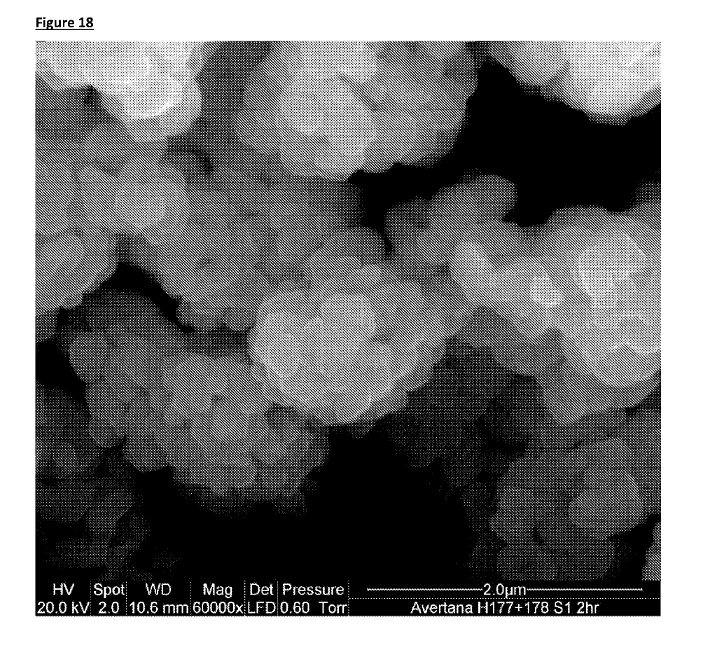

The inventors also found that removing the headspace of the sulphation reactor assisted in maintaining the high acid concentration. This is shown in FIG. 16. FIG. 17 shows the effect of removal of headspace by air ingress/egress from the headspace. In FIG. 17, it can be seen that headspace removal from the reactor maintains the acid concentration at a steady state over the reaction period. Compared to acid concentration with no airflow, the effect can be clearly seen.

Accordingly, in one embodiment, the step of minimising water accumulation comprises removal of headspace from a sulphation reactor adapted to contain the sulphation step a. of any method of the invention. Preferably the removal of headspace is achieved by at least one of:
a. increasing gas ingress to the headspace of the sulphation reactor;
b. increasing gas egress from the headspace of the sulphation reactor.

Preferably, the step of increasing gas egress or ingress is achieved by use of an air pump.

In particular embodiments, the sulphuric acid is introduced via a sulphuric acid stream to a sulphation reactor in the form of a concentrated acid solution, wherein the particulate material is contacted with the acid solution to form an aqueous sulphated mixture. The stream may be continuous or intermittent according to the requirements of the reaction. The inventors have found that if the acid strength is too low (i.e. the amount of H₂SO₄ molecules by mass in the acid solution is too low), the reaction will fail to proceed, or will proceed at a rate that is too low to be economically viable. A low acid concentration also affects the overall titanium dioxide yield as detailed above. Therefore the strength of the acid is preferably greater than 70%. In other embodiments, the acid concentration is at least 60 m %, 70 m %, 80 m %, 90 m % or 98 m %.

In particular embodiments of the invention, the sulphated mixture is heated to achieve substantially complete sulphation of the oxides (particularly titanium dioxide/calcium titanate) present. It will be appreciated that the sulphation temperature can vary according to various factors. In particular embodiments, the sulphated mixture is heated to at least 100° C. following contact with sulphuric acid. In preferred embodiments, the mixture is heated to between about 100° C. to 250° C. In other embodiments, the mixture is heated to between about 150° C. and 250° C., greater than about 150° C., or a maximum of approximately 250° C. In particular embodiments, the sulphated mixture is heated to a temperature between 130° C. and 200° C., approximately 150° C.-160° C. or approximately 190-210° C.

In particular embodiments, preheated air or steam is introduced to the reactor, preferably through the bottom of the reactor. The air/steam is allowed to rise through the mixture in order to heat the mixture to the point where reaction commences. The purpose of this heating step is to decrease the reaction time of the metal oxides converting to sulphates, and to evaporate the water as it is evolved, so as to maintain a high free acidity. High free acidity is desired so that the sulphate salts precipitate, and can be filtered afterwards.

In particular embodiments, the sulphated mixture is heated such that substantially complete sulphation of the calcium titanate/titanium dioxide occurs. During heating, the viscosity of the mixture increases as a function of the liquid content decreasing as the evolved water evaporates. In particular embodiments, the mixture is heated for a heating period. Preferably the heating period is sufficient to achieve substantially complete sulphation of the oxides (particularly titanium dioxide/calcium titanate) present. It will be appreciated by those of skill in the art that the heating period may vary according to other experimental factors. In one embodiment, the heating period is between 15 minutes and one hour. In another embodiment, the heating period is between 15 minutes and 24 hours. In particular embodiments, the heating period is at least 30 minutes or approximately 40 minutes. The inventors have found that a particularly preferred embodiment involves the heating period being from 15 minutes to 90 minutes. This embodiment provides sufficient time for sulphation to occur while not wasting energy.

In particular embodiments, following the heating step, the mixture is further dehydrated using a membrane in order to increase the free acidity of the mixture. In particular embodiments, the free acidity of the mixture exceeds 70% following dehydration.

It will be appreciated by those of skill in the art that heating of a mixture may be achieved in any appropriate way. In one embodiment, one or more of the components of the mixture may be pre-heated and the heat transferred to the mixture during mixing. References to “heating” of a mixture herein are intended to encompass heating of one or more of the components of that mixture prior to mixing.

Leaching

The sulphated mixture is next subjected to a first filtration step (otherwise known as leaching) in order to remove the excess (unreacted) sulphuric acid. Accordingly, the methods of the invention comprise the step of filtering the sulphated mixture in a suitable filtration unit to produce a filter cake and a permeate comprising excess sulphuric acid.

Those of skill in the art will understand that any appropriate filtration unit (filter) may be used for this purpose and exemplary filtration units will be known to them. In particular embodiments, the filtration unit comprises a filter press. In one embodiment, the filtration unit is assisted by a differential pressure gradient across the filter. Preferably, the pressure differential is at least 1 bar. In particular embodiments, the mixture is circulated through a filtration unit which permits acids to pass through, while a solid filter cake is collected on the surface of the filter. In particular embodiments, the pressure differential across the filter is from 2 to 10 bar. Preferably, the pressure differential is approximately 6 bar. Using a filter cake is particularly advantageous to achieve maximum acid extraction from the sulphated mixture. At this stage, the filter cake is comprised of titanyl sulphate and at least one of magnesium sulphate, aluminium sulphate, calcium sulphate or silica.

It is desirable to reduce the acid content of the filter cake as much as possible. Preferably, the moisture content of the filter cake is reduced to less than 30%, more preferably less than 20%, or between 15 and 20%. The remaining liquid in the filter cake is largely acid. In particular embodiments, this first filtration step further comprises contacting the filter cake with compressed air. The compressed air acts as an agitator to evacuate acid from the filter and filter cake, and dries the filter cake further. The temperature of the compressed air is preferably below 85° C. to prevent the premature hydrolysis of titanyl sulphate. In particular embodiments, the temperature of the compressed air is from 10° C. to 85° C. Although the compressed air is expected to assist with drying the filter cake at any temperature, the inventors have found that using a heated compressed air stream assists in maintaining the temperature of the filter cake and the subsequent sulphated suspension. Accordingly, it is preferable that the compressed air is from 30° C. to 85° C., or approximately 50° C., 60° C., 70° C. or 80° C. If the temperature of the compressed air is too low (i.e. lower than 35° C.), the viscosity of the sulphated suspension is increased which can detrimentally affect fluid flow.

Excess sulphuric acid recovered from the mixture is recycled by a recycling means. Recycling comprises collecting the acid in a suitable network of pipes and collection apparatus then re-using it. In particular embodiments, the excess sulphuric acid is passed to an acid regeneration plant. The collected sulphuric acid may then optionally be reused in the metal sulphation step described previously, wherein recycle of the sulphuric acid provides an economic and environmental advantage. In particular embodiments, the sulphuric acid is regenerated prior to being passed to the sulphuric acid stream for use in the metal sulphation step.

The filter cake remaining on the filter now has a minimal acid content. Water is circulated through the filter cake in order to dissolve the soluble salts from the filter cake. Preferably, the filter cake is washed on the filter and water is passed through the filter. Alternatively, the filter cake is washed with water and the solution does not pass through the filter. Optionally, the filter cake is removed and washed in a separate vessel. In situ washing (i.e. on the filter) reduces the need for an extra tank. Preferably, the filter cake is agitated using vibration or mechanical agitation during washing. Preferably, the temperature of the filter cake during washing is less than 80° C. If higher temperatures are used, the inventors have found that partial or complete hydrolysis of the titanyl sulphate occurs thus reducing downstream titanium dioxide yield. The water may be obtained from any appropriate source. This step produces a solution comprising titanyl sulphate and at least one of magnesium sulphate and aluminium sulphate. In particular embodiments, an insoluble residue remains on the filter comprising calcium sulphate and silica.

The solution comprising titanyl sulphate and at least one of magnesium sulphate and aluminium sulphate is optionally passed to a membrane that dehydrates the solution to produce a substantially concentrated solution of the metal sulphates. Concentration using the membrane may be by known membrane concentration methods including reverse osmosis.

The method of extraction further comprises the step of filtering the sulphated suspension to produce a retentate comprising an insoluble residue and a permeate comprising at least titanyl sulphate. In particular embodiments, the insoluble residue of the retentate comprises silica and calcium sulphate. In particular embodiments, the permeate comprises titanyl sulphate, aluminium sulphate and magnesium sulphate.

Silica/Calcium Sulphate Separation

The inventors have found that the perovskite product produced from melter slag often has a high amount of silica and calcium oxide present. These components are relatively low value and are often viewed as problematic waste products that contaminate compositions containing higher value materials such as titanium dioxide. However, through extensive trials, the inventors have found that these components can be extracted in a substantially purified form as silica and calcium sulphate. Both products have use in industry, for example in the production of tyres and in the production of gypsum for building materials respectively. The inventors have found that sulphation of the calcium oxide and removal as an insoluble residue prior to titanium sulphate hydrolysis provides a particularly efficient and cost-effective method of recovery of these components. In addition, where the particulate material also contains quantities of at least one of aluminium oxide and magnesium oxide, removal of the insoluble residue comprising silica and calcium sulphate enables the recovery of substantially pure titanium dioxide, and at least one of aluminium sulphate and magnesium sulphate in later method steps. Overall, these steps and their order contribute to providing an inventive, cost-effective and industrially efficient method of recovering said products with minimal waste.

In particular embodiments, the invention provides a method of recovering titanium dioxide hydrate and at least one other product from a particulate material comprising greater than 8 m %, greater than 10 m %, greater than 15 m % greater than 20 m % or greater than 25 m % titanium dioxide, and greater than 10 m %, greater than 15 m % or greater than 20 m % silica. In other embodiments, the invention provides a method of recovering titanium dioxide hydrate and at least one other product from a particulate material comprising greater than 8 m %, greater than 10 m %, greater than 15 m % greater than 20 m % or greater than 25 m % titanium dioxide, and greater than 15 m %, greater than 20 m % or greater than 25 m % calcium oxide.

In some embodiments, the invention provides a method of recovering titanium dioxide hydrate and at least one other product from a particulate material comprising greater than 8 m %, greater than 10 m %, greater than 15 m % greater than 20 m % or greater than 25 m % titanium dioxide, greater than 10 m %, greater than 15 m % or greater than 20 m % silica, and greater than 15 m %, greater than 20 m % or greater than 25 m % calcium oxide.

Where the method comprises a step of recovering calcium sulphate and/or silica, the insoluble residue may be processed to obtain these products. This residue is typically comprised of calcium sulphate, resulting from the cleavage of calcium titanate and the sulphation of calcium oxide, and silica. Quantities of unreacted metal oxides are typically present also, as a result of being encapsulated by a refractory material.

In one embodiment the insoluble residue of the retentate from the filtration of the sulphated suspension step is passed to a floatation tank and at least one of calcium sulphate and silica is separated according to known methods.

Due to the difference in density between calcium sulphate and silica, and the hydrophilic nature of silica, calcium sulphate can be separated and recovered from silica using a floatation process. In particular embodiments, calcium sulphate is recovered from the residue using a froth floatation process. In particular embodiments, the residue is ground and/or cleaned prior to being subjected to a froth floatation process.

In particular embodiments, the residue is subjected to a pre-floatation step prior to the floatation process in order to recover unreacted metal oxides. In particular embodiments, the residue is subjected to a post-floatation step following the floatation process in order to recover unreacted metal oxides. The pre/post-floatation step preferably comprises a floatation process using xanthates and/or hydroxamates to scavenge unreacted metal oxides. The pre/post-floatation step may also be used to recover sulphates that were not dissolved during leaching.

In alternative embodiments, the calcium sulphate may be recovered from the insoluble residue by precipitation methods known to those of skill in the art.

Concentration of Permeate Comprising Titanyl Sulphate

A low free acidity is desirable for the titanium hydrolysis reaction to proceed efficiently. The free acidity of the liquor following leaching (i.e. the first permeate) or aluminium precipitation/crystallisation is generally too high to permit direct application of the liquor. Since acid is produced in the hydrolysis reaction, the inventors have found that it is desirable to minimise acid flow-through from the earlier sulphation step. Recycling the excess acid also helps to increase the efficiency of the titanyl sulphate hydrolysis step by minimising the acid content of the hydrolysis liquor. Doing this also minimises equipment constraints and costs around using highly concentrated acids.

The inventors found that an effective way to minimise acid flow-through to the hydrolysis reaction is to first increase free acidity by removing water from the liquor, then precipitate the metal sulphates and separate them from the acid. In particular embodiments, the free acidity of the permeate comprising titanyl sulphate and optionally at least one of magnesium sulphate and aluminium sulphate is first raised such that the metal sulphates precipitate and are more easily separated from the acid. In particular embodiments, the free acidity is raised by heating the solution to a temperature at which the water evaporates. Preferably the permeate comprising titanyl sulphate is heated to greater than 100° C., more preferably greater than 130° C. and most preferably to greater than 160° C. or to boiling point. Since the liquor contains a high concentration of acid, the boiling point is approximately 160° C. In alternative embodiments, the free acidity is raised by contacting the solution with a membrane capable of dehydrating the solution, preferably to remove substantially all water.

Once the free acidity of the solution has been raised, the solution is filtered in order to remove substantially all excess acid and produce a filter cake on the surface of the filter. The separated acid is preferably recycled and may be treated to remove contaminants or increase concentration of the recycled acid. Following filtration, water is circulated through the filter in order to dissolve the soluble salts from the filter cake. This step is similar in nature to the leaching step described previously, and produces a reduced-acid permeate comprising titanyl sulphate and optionally at least one of magnesium sulphate and aluminium sulphate. In this embodiment, the permeate is filtered to remove residual acids and the resulting filter cake is contacted with water to obtain a concentrated permeate comprising at least titanyl sulphate. Any residual acid may be recycled for re-use.

Titanyl Sulphate Hydrolysis

The titanyl sulphate is hydrolysed to produce a hydrolysed liquor. Titanium hydrolysis refers to the cleavage of sulphate from titanium. The reaction is as follows:

TiOSO₄+H₂O>TiO₂+H₂SO₄

Experiments carried out by the inventors indicate that the optimal free acidity of hydrolysis liquor ranges from 8-25%. Experiments have indicated that at lower than 8% free acidity, the hydrolysis liquor is unstable which is undesirable. This is due to firstly, the hydrolysis of titanyl sulphate can spontaneously occur at room temperature while standing. Secondly, the rate of hydrolysis is difficult to control. During hydrolysis the rate of hydrolysis is in part controlled by the free acidity. If the rate of hydrolysis exceeds approximately 1% per-minute, new nucleation sites are generated in solution resulting in a wide size distribution of titanium dioxide aggregate, which is undesirable for pigment production. Accordingly, in some embodiments, the free acidity of the hydrolysis liquor comprises at least 8% free acidity. A free acidity of greater than 25% is undesirable as the hydrolysis reaction does not proceed to completion even when heated and seeded. The hydrolysis of titanyl sulphate is under equilibrium control, as titanyl sulphate is hydrolysed free sulphate ions are produced hence increasing free acidity in the hydrolysis liquor. According to the Le Chatelier's principle, the concentration of the product (free acid) directly controls the forward rate of the reaction. Hence, a high starting free acidity in the hydrolysis liquor can slow or completely stop the hydrolysis of titanyl sulphate. Accordingly, in some embodiments, the free acidity of the hydrolysis liquor comprises less than 25% free acidity. In some embodiments, the free acidity of the hydrolysis liquor comprises between 8% and 25%. Within this specified range, the hydrolysis of titanyl sulphate can proceed to completion in a controlled manner resulting in hydrated titanium dioxide of a particularly suitable size distribution for pigment production.

Having achieved a solution which has an appropriate level of free acidity, and preferably in which the excess sulphuric acid is recycled and the titanyl sulphate is concentrated, the step of hydrolysing the titanyl sulphate is initiated. Hydrolysis comprises adding water to the permeate comprising titanyl sulphate (and optionally at least one of magnesium sulphate and aluminium sulphate) to produce a hydrolysis liquor and heating the hydrolysis liquor. Hydrolysis is carried out in a hydrolysis reactor appropriate to contain the reactions described herein. Preferably the hydrolysis liquor is heated to a temperature between 80 and 140° C., between 85 and 140° C. or between 85 and 120° C. The inventors have found that a minimum activation energy for the hydrolysis reaction must be achieved by heating the liquor. In a particular embodiment, the hydrolysis liquor is heated to between 90° C. and 120° C. The inventors have found that a particularly efficient temperature which initiates the reaction quickly while maintaining energy efficiency is from 105° C. to 110° C.

Preferably the hydrolysis liquor is heated for a period such that substantially all of the titanyl sulphate has reacted. A skilled person will be able to determine when all of the titanyl sulphate has reacted. In particular embodiments, the heating period is from one hour to three hours. More preferably from 90 minutes to two hours or approximately 100 minutes. In particular embodiments, the solution is heated for about two hours at a temperature above 85° C. in order for hydrolysis to be completed.

In particular embodiments, the hydrolysis process comprises contacting the solution with water containing titanium dioxide or rutile and heating the solution to a temperature between 85 to 120° C. In preferred embodiments, titanium dioxide particles or nanoparticles, also referred to as seed particles, or nuclei, are added to the hydrolysis liquor. The titanium dioxide particles act as nucleating sites for crystallization, so as to achieve uniform particle formation. The titanium dioxide particles may be added to the hydrolysis liquor or the water added to form said liquor. The titanium dioxide particles may be added and the hydrolysis liquor heated to any of the temperature ranges described herein for hydrolysis. Preferably, the amount of titanium dioxide particles added to the hydrolysis liquor is between 1 m % and 30 m % of the mass of the titanium dioxide calculated to be present in the liquor. More preferably, between 2 m % and 15 m % and preferably between 5 m % and 8 m %. Preferably, the particle size of the titanium particles added to the liquor is from 2 nm to 10 nm, more preferably 3 to 6 nm or approximately 5 nm. Titanium dioxide particles may be anatase, or obtained therefrom.

Excess (unreacted) sulphuric acid produced as a product of the hydrolysis reaction is preferably recycled.

Separation of the hydrated titanium dioxide from the hydrolysed liquor may be achieved by methods known to those of skill in the art. In particular embodiments, separation is carried out in a separation unit adapted to receive the hydrolysis liquor and separate titanium dioxide hydrate.

In particular embodiments, the separation unit comprises a second filtration unit adapted to receive the hydrolysis liquor and produce a retentate comprising titanium dioxide hydrate. In alternative embodiments the separation unit comprises a centrifugation unit adapted to separate the precipitated titanium dioxide hydrate.

In an alternative embodiment to the hydrolysis process described above, the hydrolysis liquor may instead be subjected to a sonication process in order to precipitate titanium dioxide hydrate from the solution. In this embodiment, the bulk fluid requires less heating or does not require heating.

Preferably, the step of separation of the titanium dioxide hydrate may be carried out by filtering the hydrolysis liquor to produce a permeate, and a retentate comprising titanium dioxide hydrate. In alternative embodiments, the titanium dioxide is removed by centrifugation and collection of the precipitate.

Filtration of the hydrolysis liquor is carried out in a suitable filtration unit in order to recover the hydrated titanium dioxide. In preferred embodiments, the hydrolysis liquor remains heated to a maximum of approximately 80° C. in order to keep the titanium dioxide particles large enough to be captured by the filtering medium. The permeate preferably comprises aluminium sulphate and magnesium sulphate.

The titanium dioxide recovered from the hydrolysis or sonication process may be calcined (heated) in an oxidative environment by passing heated air through the product, which removes any residual sulphuric acid and water. In preferred embodiments, the titanium dioxide is heated to 950° C. in a reactor for about an hour. In other embodiments, the heating period is from 30 minutes to two hours. In particular embodiments, calcining is carried out at a temperature of between 800 and 1100° C., between 800 and 1050° C., between 890-1050° C., or about 990° C. The excess sulphuric acid is preferably recycled and reused in the sulphation step described earlier. In order to obtain a finished titanium dioxide product, the calcined titanium dioxide is milled, coated and washed. Such processes will be known to those of skill in the art.

Hydrolysis may be carried out according to Blumenfeld (U.S. Pat. No. 1,795,467). In one embodiment, hydrolysing the titanyl sulphate to produce a hydrolysed liquor comprises the following steps:
a. Water is heated to between about 85° C. and 100° C. in an agitated vessel. The volume of water is preferably about 10-30% of the mass of pre-hydrolysis liquor to be hydrolysed;
b. hydrolysis liquor is pre-heated in an agitated vessel to the same temperature as the water. Preferably the hydrolysis liquor contains between about 1-5 g/kg Ti3+;
c. The pre-heated pre-hydrolysis liquor is pumped into the agitated pre-heated water. The speed at which the pre-hydrolysis liquor is transferred into the water is referred to as the drop-time. Preferably the drop time is between about 5 minutes and 1 hour.
d. Preferably the hydrolysis liquor is held at the water temperature until hydrolysis is greater than 90% complete. Preferably this time period is about 1 and 4 hours. It is preferable to take samples during the hydrolysis to monitor the rate of hydrolysis and how near completion the reaction is.

Following hydrolysis, the titanium dioxide hydrate is separated from the hydrolysed liquor, for example by using a porous glass vacuum filter or a filter press.

In an alternative embodiment, hydrolysing the titanyl sulphate to produce a hydrolysed liquor comprises the following steps:
a. combining the water and hydrolysis liquor and heating to a hydrolysis temperature of between about 65° C. and 95° C.;
b. holding the temperature until the sulphates are substantially dissolved, preferably for between about 30 minutes and 4 hours.

Following hydrolysis, the titanium dioxide hydrate is separated from the hydrolysed liquor, for example by using a porous glass vacuum filter or a filter press.

Alternatively, a Meklenberg hydrolysis procedure may be used according to GB513867. In an alternative method, hydrolysing the titanyl sulphate to produce a hydrolysed liquor comprises the following steps:
a. heat hydrolysis liquor to between about room temperature to 90° C. in an agitated vessel.
b. Add a nuclei suspension produced as per GB513867 to the hydrolysis liquor. The amount of nuclei added is based on the total amount of dissolved TiO2 present in the pre-hydrolysis liquor. Preferably the nucleation ratio is between about 1-4% has be used and is highly dependent on the quality of the nuclei that have been produced.
c. Increase the temperature to between about 90° C. and 110° C. and hold for hydrolysis period. Preferably the hydrolysis period is determined by when the hydrolysis is greater than 90% complete. Preferably the hydrolysis period is at least 1 hour and preferably between about 1 hour and 3 hours. Preferably the rate of hydrolysis is <1.5%/min.

Following hydrolysis, the titanium dioxide hydrate is separated from the hydrolysed liquor, for example by using a porous glass vacuum filter or a small filter press.

The methods described above can be used to control the rate of hydrolysis in order to achieve reduction of at least one of V, Cr, Ni, Mo and Mn.

Following hydrolysis, the product is preferably filtered and washed to remove chromophores and spent acid according to the methods outlined below.

The titanium dioxide hydrate is optionally doped and calcined according to the methods outlined below.

Preferably the titanium dioxide hydrate comprises a concentration of the contaminant or chromophore of one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

Aluminium Sulphate Recovery

Aluminium sulphate is precipitated from the liquor at an appropriate stage. The inventors have found that a higher yield of titanium dioxide can be achieved by carrying out aluminium sulphate precipitation after hydrolysis and titanium dioxide removal (see example 3, samples 7, 8, 9 and 10). It is believed that if aluminium sulphate precipitation is carried out before hydrolysis, some titanyl sulphate is co-precipitated with the aluminium sulphate thus reducing TiO₂ yield.

In one embodiment, aluminium sulphate is precipitated from the permeate comprising titanyl sulphate. In another embodiment, aluminium sulphate is precipitated from the permeate comprising magnesium sulphate and aluminium sulphate. These permeates are typically obtained following sulphation and removal of insoluble residue. Alternatively, if the aluminium sulphate is not required to be separated from the insoluble residue, this step of aluminium sulphate precipitation may be carried out before removal of the insoluble residue.

The process of aluminium sulphate precipitation preferably comprises cooling the permeate to a temperature at which aluminium sulphate precipitates and crystallizes. In particular embodiments, the solution is cooled in the same vessel in which the previous filtration step occurred. In alternative embodiments, the solution is passed to a separate tank for cooling. Any excess sulphuric acid present after hydrolysis (i.e. before aluminium sulphate precipitation) or after aluminium sulphate precipitation is preferably recycled.

The crystallized aluminium sulphate is recovered from the solution by any method known to those skilled in the art. The precipitation and recovery step can be carried out on liquors containing aluminium sulphate, for example those produced by the methods described in example 3. Filtration is particularly preferred. In particular embodiments, >90% of the aluminium sulphate present in the solution is recovered during this stage. In particular embodiments, the solution is cooled to between 10 and 4° C. such that the aluminium sulphate crystallizes. In preferred embodiments, the solution is cooled to approximately 5° C.

In particular embodiments, the invention provides a method of recovering at least one product from a particulate material comprising greater than 8 m %, greater than 10 m %, greater than 15 m % greater than 20 m % or greater than 25 m % titanium dioxide, and greater than 10 m % or greater than 13 m % aluminium oxide. The inventors have found that the method provides an economically viable method of recovery of such components when the feedstock meets these component proportions.

Examples 1 and 2 show the deduction of component ratios in particular feedstocks. In particular embodiments, the invention provides a method of recovering titanium dioxide hydrate and aluminium sulphate product from a particulate material comprising a ratio of titanium dioxide to aluminium oxide (TiO₂:Al₂O₃) in the particulate matter of approximately 0.2 to 2.6, more preferably 0.25 to 2.1. In this embodiment, the inventors have found that the method steps provide particularly economically viable recovery of titanium dioxide and aluminium sulphate. The titanium hydrolysis step being carried out prior to aluminium sulphate precipitation is particularly preferred at this ratio range. Further, where magnesium sulphate precipitation is also carried out, the titanium hydrolysis step being carried out prior to aluminium sulphate precipitation, which in turn is carried out before magnesium sulphate precipitation is particularly preferred at this ratio range.

In particular embodiments, excess acid is recycled from a permeate obtained following separation of aluminium sulphate.

Magnesium Sulphate Recovery

The solution remaining after subjection to the hydrolysis or sonication process, and optionally removal of aluminium sulphate, typically comprises magnesium sulphate that can also be recovered. The inventors have found that it is preferable to recover magnesium sulphate after recovery of other products because the purity of the resultant magnesium sulphate precipitate is increased if the other components have been removed prior. This is because the methods described below to precipitate magnesium sulphate would also precipitate aluminium sulphate, titanyl sulphate and other components. If the magnesium sulphate precipitation was not carried out after recovery of the other components, the precipitated mixture would be difficult and uneconomically viable to separate to yield substantially pure components. The resultant lack of value in the mixture increases the probability that it will be disposed of in an uncontrolled and unregulated manner, thus causing environmental degradation.

The precipitation and recovery step can be carried out on liquors containing magnesium sulphate, for example those produced by the methods described in example 3.

In particular embodiments, the method of recovering products comprises the step of increasing the acid concentration of the permeate comprising magnesium sulphate to form an acidified liquor comprising precipitated magnesium sulphate. The increased acidity causes the magnesium sulphate to precipitate.

The method preferably further comprises filtering the acidified liquor in to produce a retentate comprising precipitated magnesium sulphate and a permeate comprising excess sulphuric acid.

In particular embodiments, the acid concentration of the permeate comprising magnesium sulphate is increased by the addition of sulphuric acid. Preferably the pH of the permeate comprising magnesium sulphate is reduced to less than approximately pH1 by the addition of sulphuric acid.

In particular embodiments, the acid concentration of the permeate comprising magnesium sulphate is increased by heating the permeate to remove water. Preferably heating is carried out at boiling point or at a temperature of greater than 130° C.

The inventors have also found that it is preferable to carry out magnesium sulphate precipitation after aluminium sulphate precipitation. The lower precipitation temperature of magnesium sulphate results in aluminium sulphate precipitating first during cooling of a solution comprising both dissolved aluminium sulphate and magnesium sulphate. Accordingly, it is preferable to carry out magnesium sulphate precipitation after aluminium sulphate precipitation. In particular embodiments, the invention provides a method of recovering at least one product from a particulate material comprising greater than 8 m %, greater than 10 m %, greater than 15 m % greater than 20 m % or greater than 25 m % titanium dioxide, and greater than 7 m % or greater than 10 m % magnesium oxide. It is particularly preferable to use a feedstock comprising at least 15 m % titanium dioxide and at least 10 m % magnesium oxide.

In some embodiments, the invention provides a method of recovering titanium dioxide hydrate and at least one other product from a particulate material comprising greater than 8 m %, greater than 10 m %, greater than 15 m % greater than 20 m % or greater than 25 m % titanium dioxide, and greater than 7 m % or greater than 10 m % magnesium oxide. It is particularly preferable to use a feedstock comprising at least 15 m % titanium dioxide and at least 10 m % magnesium oxide.

The method preferably comprises carrying out the step of titanium hydrolysis prior to magnesium sulphate precipitation. This enables the yield of titanium dioxide to be maximised and reduces co-precipitation losses of titanium dioxide (or titanium sulphate) that could occur if magnesium sulphate precipitation was carried out prior to titanium dioxide recovery. Examples 1 and 2 show the deduction of component ratios in particular feedstocks. The method preferably comprises carrying out the step of titanium hydrolysis prior to magnesium sulphate precipitation when the ratio of titanium dioxide to magnesium oxide (TiO₂:MgO) in the particulate matter is from 0.5 to 3.0, more preferably 0.8 to 2.8.

In some embodiments, the invention provides a method of recovering titanium dioxide hydrate and at least one other product from a particulate material comprising greater than 8 m %, greater than 10 m %, greater than 15 m % greater than 20 m % or greater than 25 m % titanium dioxide, and greater than 7 m % or greater than 10 m % magnesium oxide, and greater 10 m % or greater than 13 m % aluminium oxide. It is particularly preferable to use a feedstock comprising at least 15 m % titanium dioxide, at least 13 m % aluminium dioxide and at least 10 m % magnesium oxide.

In some embodiments, the invention provides a method of recovering titanium dioxide hydrate and at least one other product from a particulate material comprising greater than 8 m %, greater than 10 m %, greater than 15 m % greater than 20 m % or greater than 25 m % titanium dioxide, greater than 10 m %, greater than 15 m % or greater than 20 m % silica, greater than 15 m %, greater than 20 m % or greater than 25 m % calcium oxide and greater than 7 m % or greater than 10 m % magnesium oxide.

In some embodiments, the invention provides a method of recovering titanium dioxide hydrate and at least one other product from a particulate material comprising greater than 8 m %, greater than 10 m %, greater than 15 m % greater than 20 m % or greater than 25 m % titanium dioxide, greater than 10 m %, greater than 15 m % or greater than 20 m % silica, greater than 15 m %, greater than 20 m % or greater than 25 m % calcium oxide, greater than 10 m % or greater than 13 m % aluminium oxide and greater than 7 m % or greater than 10 m % magnesium oxide.

In a particular embodiment, the invention provides a method of recovering titanium dioxide hydrate and at least one other product from a particulate material comprising greater than 8 m % titanium dioxide, greater than 10 m % silica, greater than 15 m % calcium oxide, greater than 10 m % aluminium oxide and greater than 7 m % magnesium oxide. In this embodiment the method provides a commercially viable and useful method for the extraction of these compounds from what was previously viewed as a waste material.

In an alternative embodiment, the invention provides a method of recovering titanium dioxide hydrate and at least one other product from a particulate material comprising greater than 15 m % titanium dioxide, greater than 10 m % silica, greater than 15 m % calcium oxide, greater than 10 m % aluminium oxide and greater than 7 m % magnesium oxide.

In particular embodiments, the invention provides a method of recovering titanium dioxide hydrate and magnesium sulphate product from a particulate material comprising a ratio of titanium dioxide to magnesium oxide (TiO₂:MgO) in the particulate matter of approximately 0.5 to 3.0, more preferably 0.8 to 2.8. In this embodiment, the inventors have found that the method steps provide particularly economically viable recovery of titanium dioxide and magnesium sulphate. The titanium hydrolysis step being carried out prior to magnesium sulphate precipitation is particularly preferred at this ratio. Further, where aluminium sulphate precipitation is also carried out, the titanium hydrolysis step being carried out prior to aluminium sulphate precipitation, which in turn is carried out before magnesium sulphate precipitation is particularly preferred at this ratio range.

In particular embodiments, the acidified liquor comprising magnesium sulphate or a permeate comprising magnesium sulphate is cooled to a temperature at which magnesium sulphate crystallizes. In particular embodiments, the solution is cooled in the same reactor in which the previous precipitation, hydrolysis process or sonication process occurred. In alternative embodiments, the solution is passed to a separate tank for cooling.

In particular embodiments, the permeate comprising magnesium sulphate or the acidified liquor comprising magnesium sulphate is cooled to induce precipitation/crystallisation of magnesium sulphate. In preferred embodiments, the permeate comprising magnesium sulphate or the acidified liquor is cooled to less than 4° C. or between 0° C. and 4° C., more preferably approximately 3° C. In particular embodiments, greater than 90% of the magnesium sulphate present in the acidified liquor or the permeate comprising magnesium sulphate is recovered during filtration. The crystallized magnesium sulphate is recovered from the solution by any method known to those skilled in the art.

In particular embodiments, excess sulphuric acid is recycled from at least one of a permeate obtained following separation of magnesium sulphate, the acidified liquor or the permeate comprising excess sulphuric acid.

Recycling and Regeneration of Excess Sulphuric Acid

As noted above, the invention comprises one or more steps of recycling excess sulphuric acid for re-use. The inventors have found that using a stoichiometric excess of acid helps to reduce viscosity of the process which has substantial benefits for processing. The increased acid concentration during hydrolysis also assists with driving the reaction thus improving titanium dioxide yield. However, this development has led to the economic and environmental problem of having substantial quantities of excess acid.

Excess acid may be recycled from any step of the reaction method described herein and the recycled acid may be regenerated. The recycled acid may be re-used in the same process or in a different process. In some embodiments, the acid is added to fresh acid to achieve a particular concentration for re-use. In particular embodiments, the acid for re-use has a concentration of approximately 80%, 90%, 95%, 96%, greater than 70%, greater than 80%, greater than 90%, greater than 95%, greater than 96%, between 70-98%, between 70-80%, or between 80-98%.

The recycling of acid has also led to problems including the accumulation of contaminants in the recycled acid. Chromophores are a particular issue as outlined herein. In addition, the concentration of recycled sulphuric acid may be too low to be effectively re-used within the process.

In one aspect, the invention provides a method of recovering titanium dioxide hydrate from a particulate material, the method comprising:
a. contacting the particulate material with sulphuric acid from a sulphuric acid stream and heating to form a sulphated mixture;
b. filtering the sulphated mixture to produce a filter cake and a first permeate comprising sulphuric acid;
c. contacting the filter cake with water to form a sulphated suspension comprising titanyl sulphate;
d. filtering the sulphated suspension to produce a permeate comprising at least titanyl sulphate, and a retentate comprising insoluble residue;
e. contacting the permeate comprising at least titanyl sulphate with water to produce a hydrolysis liquor;
f. hydrolysing the titanyl sulphate to produce a hydrolysed liquor; and
g. separating titanium dioxide hydrate from the hydrolysed liquor,

wherein excess sulphuric acid from the permeate of step b. or g. undergoes recycling.

In a further aspect, the invention provides a method of reduction of chromophores in recycled sulphuric acid in a titanium dioxide recovery process, the method comprising:
a. contacting a particulate material with sulphuric acid from a sulphuric acid stream and heating to form a sulphated mixture;
b. filtering the sulphated mixture to produce a filter cake and a first permeate comprising excess sulphuric acid;
c. recycling the excess sulphuric acid;
d. contacting the filter cake with water to form a sulphated suspension comprising titanyl sulphate;
e. hydrolysing the titanyl sulphate; and
f. separating titanium dioxide hydrate from the hydrolysis liquor;
wherein recycling the excess sulphuric acid further comprises reducing the concentration of one or more chromophores present in the excess sulphuric acid.

In particular embodiments, recycling further comprises regenerating the excess sulphuric acid. In particular embodiments, regenerating the excess sulphuric acid comprises at least one of:
a. increasing the concentration of the sulphuric acid; and
b. decreasing the concentration of one or more contaminants in the sulphuric acid.

Increasing the concentration of the sulphuric acid may be achieved in any way known to those of skill in the art. In a particular embodiment, increasing the concentration of the acid is achieved by removing water from the acid. In particular embodiments, removal of water comprises passing the acid through a selective membrane to separate at least a portion of the water.

In particular embodiments, removing the water from the acid is achieved by at least one of stripping and distillation.

In particular embodiments, regenerating the acid comprises:
a. thermally cracking the excess sulphuric acid to produce a sulphur dioxide stream;
b. producing regenerated sulphuric acid from the sulphur dioxide stream;
c. adding the regenerated sulphuric acid to a fresh acid stream.

To regenerate the acid, an acid regeneration plant may be used. Such plants will be known to those of skill in the art. In particular embodiments, this plant treats the sulphuric acid in order to achieve at least one of:
a. increasing the concentration of the sulphuric acid; and
b. decreasing the concentration of one or more contaminants in the sulphuric acid.

In particular embodiments, the excess sulphuric acid is regenerated using the Contact Process. This well-known process involves the following steps:
a. converting at least a portion of the excess sulphuric acid to sulphur dioxide;
b. converting the sulphur dioxide to sulphur trioxide; and
c. converting the sulphur trioxide to concentrated sulphuric acid.

Preferably the concentrated sulphuric acid produced following regeneration of the excess sulphuric acid comprises a concentration of approximately 80%, 90%, 95%, 96%, greater than 70%, greater than 80%, greater than 90%, greater than 95%, greater than 96%, between 70-98%, between 70-80%, or between 80-98%.

In particular embodiments, the Contact Process comprises the steps of
a. converting at least a portion of the sulphuric acid to sulphur dioxide by addition of oxygen to the sulphuric acid;
b. purifying the sulphur dioxide;
c. converting the sulphur dioxide into sulphur trioxide by addition of oxygen to the sulphur dioxide in the presence of an appropriate catalyst, heat and pressure;
d. converting the sulphur trioxide into concentrated sulphuric acid by combining the sulphur trioxide with sulphuric acid to form oleum, and combining the oleum with water to form concentrated sulphuric acid.

Preferably the catalyst to convert sulphur dioxide to sulphur trioxide comprises vanadium pentoxide.

Preferably the temperature required to convert sulphur dioxide to sulphur trioxide is between about 350° C. and 500° C., or about 400° C. to about 450° C. Preferably the pressure required to convert sulphur dioxide to sulphur trioxide is between about 1-2 atm.

Purification of sulphur dioxide is necessary to avoid catalyst poisoning (i.e. attenuation of catalytic activities) by impurities in the gas. Appropriate purification methods for the impurities present will be appreciated by those of skill in the art.

In particular embodiments, the excess sulphuric acid has a concentration of between 40-80%, between 50-80%, less than 80%, less than 70%, less than 60%, or less than 50%.

In order to avoid the accumulation of contaminants, the excess acid may be regenerated and “cleaned” during the recycling process. In particular embodiments, the concentration of the one or more contaminants or chromophores is reduced or maintained at a steady state below desirable thresholds (as described below). The reduction of the contaminant content may be achieved by methods known in art, for example by a membrane separation technique. In particular embodiments, the contaminants or chromophores comprise at least one of iron, magnesium, lithium, zinc, copper, chromium, nickel, cobalt, vanadium, arsenic, molybdenum, manganese, selenium or a salt form of any one or more thereof. In particular embodiments, the contaminants or chromophores comprise at least one of iron, chromium, nickel, vanadium or a salt form of any one or more thereof.

In particular embodiments, the invention provides a method wherein concentration of any one of the contaminants or chromophores in the regenerated sulphuric acid is less than 100 ppm.

In order to achieve commercial specifications of products, it is desirable to minimise the contaminant concentration in the titanium dioxide hydrate produced by the methods described herein. In embodiments where accumulation of contaminants occurs during recycling of acid, analysis of the titanium dioxide hydrate produced can determine whether removal of contaminants such as chromophores is required. Those of skill in art will appreciate the methods that may be used to determine the level of contaminants such as those described below. However, by way of example the concentration may be determined by inductively coupled plasma atomic emission spectroscopy (ICP-OES).

If the contaminant concentration in the titanium dioxide exceeds the following levels, it is desirable to regenerate the recycled sulphuric acid to remove the contaminants and therefore minimise contaminant accumulation:
a. iron greater than 10 ppm;
b. chromium greater than 2 ppm;
c. nickel greater than 1 ppm;
d. vanadium greater than 5 ppm;
e. manganese greater than 1 ppm; or
f. copper greater than 5 ppm.

In a further aspect, the invention provides a method of reducing contaminant or chromophore concentration in titanium dioxide hydrate produced according to a method described in the first, fourth, fifth or sixth aspects, the method comprising reducing the contaminant or chromophore concentration in the recycled sulphuric acid to achieve a final concentration of the contaminant or chromophore in the titanium dioxide of one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

The invention preferably provides titanium dioxide hydrate with the contaminant concentration being the higher of the two ppm levels provided above. This level of contaminants is suitable for many commercial uses of titanium dioxide. For some uses however, it is preferable to have an even lower concentration of said contaminants or chromophores which provides a superior product specification.

In particular embodiments, decreasing the concentration of the one or more contaminants in the sulphuric acid comprises removal of the one or more contaminants by a separation process. Preferably the separation process comprises precipitation of the one or more contaminants followed by filtration to yield a retentate comprising the one or more contaminants. Preferably the separation process comprises a membrane separation technique.

In particular embodiments, the concentration of the one or more contaminants is decreased by increasing the concentration of the sulphuric acid to induce precipitation of the one or more contaminants followed by filtration to yield a retentate comprising the one or more contaminants. For example the Contact Process may be used to achieve this.

In a further aspect, the invention provides a system for the recovery of products from a particulate material, the system comprising:
a. a sulphation reactor adapted to receive and heat sulphuric acid and particulate material comprising at least titanium dioxide and produce a sulphated mixture;
b. a first filtration unit adapted to receive the sulphated mixture and produce a first permeate comprising at least sulphuric acid, and a filter cake comprising at least titanyl sulphate;
c. a hydrolysis reactor adapted to receive a solution comprising titanyl sulphate and heat said solution to produce a hydrolysis liquor;
d. a separation unit adapted to receive the hydrolysis liquor and separate titanium dioxide hydrate; and
e. a recycling means adapted to recycle excess sulphuric acid from at least one of the first filtration unit and the separation unit.

These features of the overall system are described herein. The inventors have taken steps to combine the features of the system in an inventive manner in order to achieve the inventive methods of titanium dioxide production, recycling of acid and optionally regeneration of the excess acid.

In particular embodiments, the separation unit comprises a second filtration unit adapted to receive the hydrolysis liquor and produce a retentate comprising titanium dioxide. In alternative embodiments the separation unit comprises a centrifugation unit adapted to separate the precipitated titanium dioxide hydrate. In particular embodiments, the system further comprises at least one precipitation tank to facilitate precipitation of aluminium sulphate or magnesium sulphate. In particular embodiments, the particulate material further comprises at least one of aluminium oxide, magnesium oxide, calcium oxide or silica. In particular embodiments, the system further comprises at least one further filtration unit to facilitate separation of precipitated aluminium sulphate or precipitated magnesium sulphate.

The invention also provides at least one product prepared according to the methods described herein. The at least one product being selected from:
a. titanium dioxide;
b. silica;
c. calcium sulphate;
d. aluminium sulphate;
e. magnesium sulphate; or
f. titanium dioxide hydrate.

In particular embodiments, the at least one product is produced by a method comprising recycling excess sulphuric acid and decreasing the level of at least one contaminant in the excess sulphuric acid.

In particular embodiments, the product is produced by a method comprising recycling excess sulphuric acid and decreasing the level of contaminants in the excess sulphuric acid, wherein the product comprises titanium dioxide. In particular embodiments, the titanium dioxide hydrate produced by the method comprises one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

Calcination

In a further aspect, the invention provides a method of producing calcined titanium dioxide from a mixture comprising titanium dioxide hydrate and at least one contaminant, the method comprising:
a. treating the mixture to decrease the concentration of the at least one contaminant and produce purified titanium dioxide hydrate;
b. addition of at least one dopant to the purified titanium dioxide hydrate to produce a doped mixture;
c. heating the doped mixture comprising pre-calcination titanium dioxide hydrate for a period to produce calcined titanium dioxide.

This method may be carried out in combination with the methods of recovering titanium dioxide hydrate described herein.

Optionally, the embodiment in the preceding paragraph further comprises:
i. heating the doped mixture from b. in water for a period to produce a pre-calcination liquor;
ii. drying the pre-calcination liquor to produce a pre-calcination titanium dioxide hydrate.

The methods of the invention described herein provide advantages over the prior art including:
optimisation of the crystal size;
exclusion of contaminants such as the chromophores chromium, vanadium and iron;
reducing the washing requirements to clean and remove the contaminants.

Without wishing to be bound by theory, it is believed that these advantages are at least partly brought about by the conversion of anatase to rutile titanium dioxide at an optimum method stage and reaction period. In addition, the crystal size may be controlled effectively by the periods of reaction and the addition of dopants to control crystal growth and conversion from anatase titanium dioxide hydrate (which is produced by the sulphuric acid extraction method described herein) to titanium dioxide. In general, anatase has a higher activity therefore its crystals grow faster but it is of limited commercial value in its crystal form. Accordingly, the inventors have found that it is advantageous to add specific dopants to the anatase. At specific temperatures, these dopants retard anatase crystal growth and promote the conversion to rutile.

In particular embodiments, the calcined titanium dioxide produced by the methods described herein comprises at least one of anatase and rutile titanium dioxide. Although rutile titanium dioxide generally has higher value, anatase is preferable for some niche applications such as inks and pharmaceuticals. The methods described herein are particularly effective at producing a high degree of rutilised or rutile titanium dioxide. This is shown in example 16 and FIG. 19. Accordingly, in particular embodiments, the calcined titanium dioxide comprises greater than 95% or greater than 98% rutile titanium dioxide.

The invention also provides advantages in reducing the chromophore concentration in the rutile titanium dioxide crystals grown. The treatment steps taken pre-calcination (i.e. titanous sulphate leach, sulphuric acid leach, water wash and doping) mean that the crystals have a higher purity and therefore more desirable crystal colour specification when compared to calcined titanium dioxide produced without pre-treatment or doping.

In particular embodiments, the pre-calcination titanium dioxide hydrate is ground. A skilled person will appreciate the methods to achieve particle size reduction. In one embodiment, the grinding is carried out in a ballmill. Particle size may be measured according to methods known to those of skill in the art, for example laser diffraction.

In particular embodiments, the heating of the pre-calcination titanium dioxide hydrate is carried out in a suitable calcination reactor. In particular embodiments, the calcination reactor comprises a rotary kiln furnace.

In particular embodiments, the heating of the pre-calcination titanium dioxide hydrate is carried out at between 800 and 1100° C., between 800 and 1050° C., between 890-1050° C., or about 990° C.

In particular embodiments, the pre-calcination titanium dioxide hydrate is heated for between one and eight hours, or about 4 hours.

In particular embodiments, the calcined titanium dioxide comprises a crystal colour specification of at least one of:
a. greater than 97% or 98% brightness (L*); and
b. less than 1.8%, 2.5% or 2.8% blue tonality.

In particular embodiments, the calcined titanium dioxide has a crystal size distribution centred on about 220 nm in diameter. In particular embodiments, the calcined titanium dioxide has a crystal size distribution less than 1.2 standard deviations from the target size of monodisperse particles.

Example 15 describes an experiment for preparation and calcination of titanium dioxide with preferred colour specification. As such, the invention preferably provides pre-calcination titanium dioxide or calcined titanium dioxide with at least one of the brightness being greater than 97% and blue tonality being less than 2.5% or 2.8%. This level of brightness and blue tonality provides a product suitable for many commercial uses of titanium dioxide. For some uses however, it is preferable to have an even higher specification product and for such uses the invention also provides a product having at least one of a brightness greater than 98% and a blue tonality lower than 1.8%.

A titanous sulphate leach may be performed to reduce the content of contaminants in the titanium dioxide hydrate, and thus the final titanium dioxide product. This process is particularly useful for reducing the concentration of iron, aluminium and magnesium, or salt forms thereof. Titanous sulphate is prepared according to methods known to those of skill in the art.

In particular embodiments, the titanous sulphate leach comprises the following steps:
i. contacting the mixture comprising titanium dioxide hydrate and at least one contaminant with a titanous sulphate (Ti³⁺ H₂SO₄) solution to produce a titanous sulphate leached liquor;
ii. heating the titanous sulphate leached liquor for a period;
iii. filtering the heated titanous sulphate leached liquor to produce a retentate comprising titanium dioxide hydrate, and a permeate comprising excess titanous sulphate solution and at least one contaminant.

Step ii. is performed to allow time for the reaction to proceed and ensure complete mixing.

In particular embodiments, the titanous sulphate solution comprises a concentration of between 2 and 10 g/kg titanous sulphate (i.e. grams of titanous sulphate in kg of water) in 8 to 18% w/w sulphuric acid in water. Preferably the titanous sulphate solution comprises a concentration of about 5 g/kg titanous sulphate in about 13% w/w sulphuric acid.

In particular embodiments, the titanous sulphate leached liquor is heated to between 60 and 95° C. Preferably the titanous sulphate leached liquor is heated to about 70° C.

In particular embodiments, the titanous sulphate leached liquor is stirred. Stirring, or mixing may be achieved by any method known to those of skill in the art. In particular embodiments, the period of heating the titanous sulphate leached liquor is between one and five hours. Preferably, the period of heating the titanous sulphate leached liquor is about two hours.

In particular embodiments, the permeate comprising excess titanous sulphate is recycled for re-use in step i. of the titanous sulphate leach.

As noted previously, the invention provides a method of reducing the contaminant concentration of pre-calcination titanium dioxide hydrate and hence titanium dioxide produced from that hydrate form.

Accordingly, in particular embodiments, the method of the first aspect comprises a titanous sulphate leach and the concentration of iron or a salt form thereof in the pre-calcination titanium dioxide hydrate is less than 10 ppm.

In particular embodiments, the method of the first aspect comprises a titanous sulphate leach and the concentration of the following contaminants or chromophores in the pre-calcination titanium dioxide hydrate is one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

The invention preferably provides pre-calcination titanium dioxide or calcined titanium dioxide with the contaminant concentration being the higher of the two ppm levels provided above. This level of contaminants is suitable for many commercial uses of titanium dioxide. For some uses however, it is preferable to have an even lower concentration of said contaminants which provides a superior product specification.

In particular embodiments, the titanous sulphate leach method described above is repeated at least once.

A sulphuric acid leach is preferably used to further purify the titanium dioxide hydrate. In particular embodiments, the sulphuric acid leach comprises the following steps:
i. contacting the mixture comprising titanium dioxide hydrate and at least one contaminant with sulphuric acid to produce a sulphuric acid leached liquor;
ii. heating the sulphuric acid leached liquor for a period;
iii. filtering the heated sulphuric acid leached liquor to produce a retentate comprising titanium dioxide hydrate and a permeate comprising excess sulphuric acid solution and at least one contaminant.

In particular embodiments, the sulphuric acid comprises a concentration of between 8 to 18% w/w sulphuric acid in water. Preferably the sulphuric acid comprises a concentration of about 13% w/w sulphuric acid in water.

In particular embodiments, the sulphuric acid leached liquor is heated to between 104 and 110° C.

In particular embodiments, the sulphuric acid leached liquor is stirred. In particular embodiments, the period of heating the sulphuric acid leached liquor is between one and five hours. Preferably, the period of heating the sulphuric acid leached liquor is about two hours.

In particular embodiments, the permeate comprising excess sulphuric acid is recycled for re-use in step i. of the sulphuric acid leach.

In particular embodiments, the method of the first aspect comprises a sulphuric acid leach and the concentration of the following contaminants or chromophores in the pre-calcination titanium dioxide hydrate is one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

In particular embodiments, the sulphuric acid leach method described above is repeated at least once.

The water wash is performed primarily to remove the residual acidity left in the titanium dioxide hydrate filter cake after the preceding leaches. In particular embodiments, the water wash comprises the following steps:
i. contacting the titanium dioxide hydrate with water for a period to produce an aqueous titanium dioxide hydrate solution. This period allows completion of mixing;
ii. filtering the aqueous titanium dioxide hydrate solution to produce a retentate comprising titanium dioxide hydrate and a permeate comprising excess water and at least one contaminant.

In particular embodiments, the aqueous titanium dioxide hydrate solution is stirred.

In particular embodiments, the period for which the aqueous titanium dioxide hydrate solution is stirred is between five and 45 minutes. Preferably, the period for which the aqueous titanium dioxide hydrate solution is stirred is ten minutes.

In particular embodiments, the permeate comprising excess water is recycled for re-use in step i.

In particular embodiments, the water wash method described is repeated at least once. Preferably the water wash is repeated two, three or four more times.

In particular embodiments, the method of the first aspect comprises a water wash and the concentration of the following contaminants or chromophores in the pre-calcination titanium dioxide hydrate is one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

In particular embodiments, the method of the first aspect comprises a titanous sulphate leach, a sulphuric acid leach and a water wash, and the concentration of the following contaminants or chromophores in the pre-calcination titanium dioxide hydrate is one or more of the following:
a. iron less than 10 ppm or less than 20 ppm;
b. chromium less than 2 ppm or less than 4 ppm;
c. nickel less than 1 ppm or less than 2 ppm;
d. vanadium less than 5 ppm or less than 15 ppm;
e. manganese less than 1 ppm or less than 2 ppm; or
f. copper less than 5 ppm or less than 15 ppm.

Dopants are added to the pre-calcination titanium dioxide hydrate to impart desirable properties to the titanium dioxide crystal grown during calcination, as well as to minimise the effect and accumulation of contaminants such as chromophores. Heat is applied to the doped mixture to maintain dispersion and chemical activity.

In particular embodiments, addition of at least one dopant to the purified titanium dioxide hydrate to produce a doped mixture comprises the addition of at least one of potassium oxide (K₂O), phosphorus pentoxide (P₂O₅), and aluminium oxide (Al₂O₃). In a particular embodiment, the potassium oxide is added at a concentration of between 0.1% and 0.4% w/w in aqueous solution. In an alternative embodiment, potassium oxide is added at a concentration of between 0.02% and 0.4% w/w in aqueous solution. In a particular embodiment, the phosphorus pentoxide is added at a concentration of between 0.1% and 0.3% w/w in aqueous solution. In an alternative embodiment, the phosphorus pentoxide is added at a concentration of between 0.001% and 0.4% w/w in aqueous solution. In a particular embodiment, the aluminium oxide is added at a concentration of between 0.1% and 0.8% w/w in aqueous solution. In an alternative embodiment, the aluminium oxide is added at a concentration of between 0.001% and 0.8% w/w in aqueous solution.

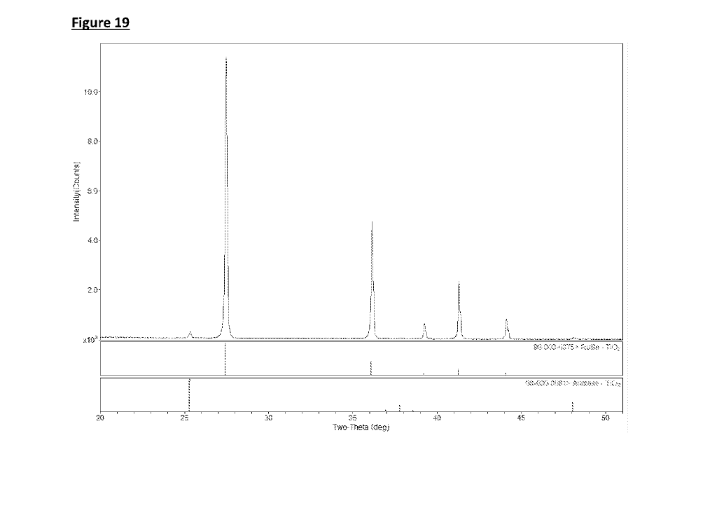

Dispersity of final particle size is an important consideration for titanium dioxide for commercial uses. The inventors have found that using the levels of dopants detailed above, a substantially monodisperse titanium dioxide product can be produced. FIG. 18 shows an example SEM image of calcined titanium dioxide produced according to the method outlined in example 16. The particle sizes are homogenous and exhibit low levels of chromophores (see table 24).

In particular embodiments, the doped mixture is heated in water at between 80 to 100° C., or at about 100° C.

In particular embodiments, the period of heating of the doped mixture is between 30 and 90 minutes, or about 60 minutes.

In particular embodiments, purified titanium dioxide hydrate is heated in water wherein the water is present in excess in a ratio to the purified titanium dioxide hydrate of between 2 and 3 times, or about is 2.5 times water to purified titanium dioxide hydrate.

In particular embodiments, the pre-calcination liquor is dried to remove substantially all free water in the pre-calcination liquor and produce pre-calcination titanium dioxide hydrate. Drying may be carried out according to known methods. Preferably, the drying is carried out in a fluidised bed heater.

It will be appreciated by those of skill in the art that the treatment steps to produce purified titanium dioxide may not reduce the concentration of contaminants to zero. The aim of the treatment steps is to reduce the level of contamination to a degree that renders the product usable for the application required.

In some embodiments, the at least one contaminant is selected from iron, magnesium, lithium, zinc, copper, chromium, nickel, cobalt, vanadium, arsenic, molybdenum, manganese, selenium or a salt form of any one or more thereof.

In particular embodiments, any of the methods described herein further comprise at least one step to reduce the concentration of at least one chromophore present in titanium dioxide by the addition of dopants and associated method steps.

Fe co-hydrolysis with TiO₂ can result in insoluble Fe₂O₃ particles trapped within the floc structure. These cannot be removed and discolour the TiO₂ upon calcination by doping the TiO₂ crystal lattice. This thus reduces the quality and value of the product. However, Fe only undergoes hydrolysis in the 3+ state. When in the 2+ state, Fe remains in the solution as a water/acid soluble salt. The inventors have therefore used a reductant, (commonly Al or Fe metal) to reduce the Fe3+ to Fe2+ and some of the Ti4+ to Ti3+. The Ti3+ acts as a buffer reducing any Fe2+ that is oxidised to Fe3+ during hydrolysis. If this is done successfully then very little Fe from solution will end up in the final product. This is a particular problem for the inventors process due to the feedstock typically used—i.e. iron ore slag. Accordingly, this method step is of particular use where the feedstock comprises Fe content of greater than 10 ppm.

Accordingly, the methods described herein may optionally include at least one step to reduce the concentration of at least one chromophore present in titanium dioxide wherein the step is to reduce iron contamination and comprises addition of a reductant prior to or during hydrolysis. Preferably the reductant has a greater oxidation potential than the reduction potential of Fe3+, for example at least one of Al, Zn or Fe powder. Addition of aluminium as a dopant is particularly preferred for treatment of this feedstock because it can be recovered during standard processing to remove aluminium (see methods described above. This minimises chromophore contamination even more and enables the recovery of the reductant in a cost-efficient way.

A further chromophore—copper—can also detrimentally affect the quality of the final titanium dioxide product. Cu contamination is mostly caused by Cu as a colloidal metal particle becoming trapped within the filter cake as the TiO₂ is separated from the spent hydrolysis liquor. The colloidal Cu metal is believed to be a by-product of the reduction reaction preformed to reduce the Fe3+. Due to Cu's low reduction potential, during the reduction reaction dissolved Cu is reduced back to its metallic state. The inventors have found that this Cu contamination can be decreased by reducing the pre-hydrolysis liquor before hydrolysis and filtering it through a polishing filter. The colloidal Cu is removed in the filter. Accordingly, in a further embodiment, any method of the invention comprises a step of addition of a reductant to the hydrolysis or the pre-hydrolysis liquor followed by filtration, preferably with a polishing filter. Preferably the polishing filter comprises a porous glass filter. Preferably the polishing filter mesh size is less than 7 μm, more preferably less than 1 μm. Polishing filters will be known to those of skill in the art and will preferably be acid resistant and hydrophilic. Alternatively, another type of filter such as a screened filter may be used, or a settling method.

Example 13 shows experimental evidence of the efficacy of these methods to reduce chromophore contamination and yield a leach liquor with reduced chromophore concentration.

Preferably the at least one step to reduce the concentration of at least one chromophore present in titanium dioxide comprises a step to reduce at least one of V, Cr, Ni, Mo and Mn. It is believed that these contaminants become trapped in the micro-pores between the crystals that make up micelle as soluble salts. During calcination, like Fe, they dope the TiO₂ lattice severely discolouring the TiO₂. Any contamination from these metals should ideally be removed before calcination. The inventors have found that slowing the rate of hydrolysis prevents these contaminants contaminating the TiO₂. By lowering the rate of hydrolysis it is believed that the crystals making up the micelles align and grow with less imperfection or spaces between crystals resulting in fewer nano sized pores. Secondly the pores between micelles are larger as the micelle have a higher aspect ratio. Overall the resulting flocs have fewer nano-pores and larger macro-pores, this results in a hydrated TiO₂ which is easier to wash.

Accordingly, in one embodiment of any of the methods described herein, the method comprises a step to reduce at least one of V, Cr, Ni, Mo and Mn by controlling the rate of hydrolysis. Controlling the rate of hydrolysis is preferably carried out by the methods described above.

A further method by which the titanium dioxide can become contaminated with undesirable contaminants is through un-reacted slag (or ilmenite) and precipitated insolubles e.g. CaSO₄ containing Fe, V, Cr, Mn, Ni, Cu and Mo becoming trapped in the TiO₂ filter cake as it is removed from the spent hydrolysis liquor following hydrolysis. The inventors have found that two methods in particular can be used to prevent this. Firstly, the hydrolysis liquor (i.e. pre-hydrolysis) is preferably filtered through a polishing filter. Preferably the polishing filter comprises a porous glass filter. Preferably the polishing filter mesh size is less than 7 μm, more preferably less than 1 μm, or less than 0.2 μm. Alternatively, or in addition, the hydrolysis liquor may be settled for a settling period and the settled material is not used in the hydrolysis reaction.

The systems or processes of the invention may optionally include means for regulating and/or controlling other parameters to improve overall efficiency of the process. One or more processors may be incorporated into the system to regulate and/or control particular parameters of the process. For example particular embodiments may include determining means to monitor the composition of mixtures or solutions. In addition, particular embodiments may include a means for controlling the delivery of a mixture or solution to particular stages or elements within a particular system if the determining means determines the mixture or solution has a composition suitable for a particular stage.

In addition, it may be necessary to heat or cool particular system components or mixtures, solutions or additives prior to or during one or more stages in the process. In such instances, known heating or cooling means may be used.

Furthermore, the system may include one or more pre/post treatment steps to improve the operation or efficiency of a particular stage. For example, a pre-treatment step may include means for removing unwanted particulate matter from the ground feedstock prior to the metal sulphation process. Other pre- or post-operations that may be conducted include separation of desired product(s) from particular stages. The invention has been described herein with reference to certain preferred embodiments, in order to enable the reader to practice the invention without undue experimentation. Those skilled in the art will appreciate that the invention can be practiced in a large number of variations and modifications other than those specifically described. It is to be understood that the invention includes all such variations and modifications. Furthermore, titles, headings, or the like are provided to aid the reader's comprehension of this document, and should not be read as limiting the scope of the present invention. The entire disclosures of all applications, patents and publications cited herein are herein incorporated by reference.

More particularly, as will be appreciated by one of skill in the art, implementations of embodiments of the invention may include one or more additional elements. Only those elements necessary to understand the invention in its various aspects may have been shown in a particular example or in the description. However, the scope of the invention is not limited to the embodiments described and includes methods including one or more additional steps and/or one or more substituted steps, and/or methods omitting one or more steps.

The reference to any prior art in this specification is not, and should not be taken as, an acknowledgement or any form of suggestion that that prior art forms part of the common general knowledge in the field of endeavour in any country.

### EXAMPLES

### Example 1—Determination of Composition of Slag from Different Sources

The composition of slag from steel manufacturing facilities was obtained.

Results

TABLE 2
composition of raw material feedstock

| | Component (m %) | | | | | |
|---|---|---|---|---|---|---|
| Slag source | TiO₂ | SiO₂ | CaO | Al₂O₃ | MgO | Sum |
| New Zealand | 34.8 | 14.1 | 16.3 | 19.0 | 13.8 | 98.0 |
| South Africa | 28.2 | 16.5 | 16.6 | 13.6 | 14 | 99.2 |
| China 1 | 21.5 | 15.55 | 24.6 | 14.11 | 7.65 | 83.84 |
| China 2 | 16.03 | 24.94 | 32.12 | 14.89 | 7.47 | 96.02 |
| Russia | 9 | 29 | 31 | 14.5 | 12 | 96.54 |

TABLE 3
ratio of feedstock components to titanium dioxide

| | Component ratio | | | |
|---|---|---|---|---|
| Slag source | TiO₂:Al₂O₃ | TiO₂:MgO | TiO₂:SiO₂ | TiO₂:CaO |
| New Zealand | 1.8 | 2.5 | 2.5 | 2.1 |
| South Africa | 2.1 | 2.0 | 1.7 | 1.7 |
| China 1 | 1.5 | 2.8 | 1.4 | 0.9 |
| China 2 | 1.1 | 2.1 | 0.6 | 0.5 |
| Russia | 0.6 | 0.8 | 0.3 | 0.3 |

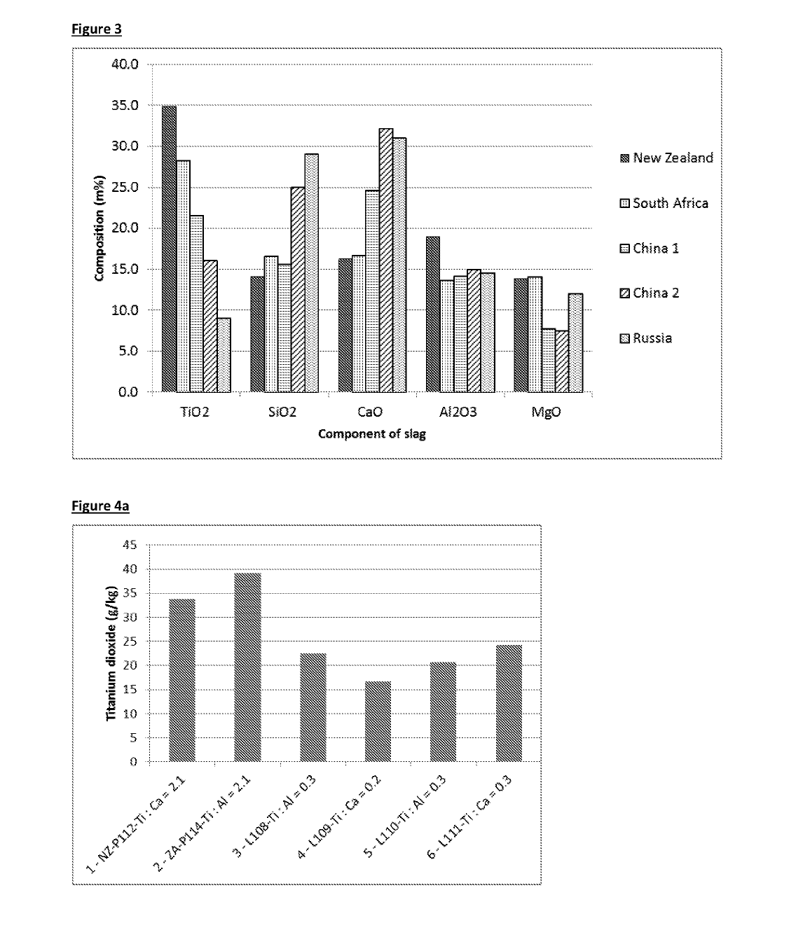

FIG. 3 shows the composition of the above slag samples measured by the inventors (for New Zealand) and obtained from the following literature for South Africa, China and Russia:

South Africa—Control of open slag bath furnaces at Highveld Steel and Vanadium Ltd: development of operator guidance tables. Steinberg and Pistorius, Ironmaking and Steelmaking, 2009, vol 36 no. 7.

China 1 and China 2-3rd International Symposium on High Temperature Metallurgical Processing. Tao Jiang Jiann-Yang Hwang Patrick Masset Onuralp Yucel Rafael Padilla Guifeng Zhou—9 May 2012. John Wiley & Sons

Russia—Titania-containing slag processing method—RU 2295582

Conclusion

All five sources of slag for which data were obtained had varying degrees of metal oxides capable of extraction using the methods described herein.

### Example 2

Materials and Methods

Six samples containing mixtures of titanium dioxide, aluminium oxide, magnesium oxide, silica and calcium oxide were analysed using x-ray fluorescence spectrometry. The mass percentage composition of these samples was determined and ratios of titanium dioxide to a second component calculated.

Results

TABLE 4
compositions and component ratios of samples measured using x-ray fluorescence spectrometry

| | Component (m %) | | | | | Ratio | | | |
|---|---|---|---|---|---|---|---|---|---|
| Slag source | TiO₂ | SiO₂ | CaO | Al₂O₃ | MgO | TiO₂:Al₂O₃ | TiO₂:MgO | TiO₂:SiO₂ | TiO₂:CaO |
| 1 - NZ-P112-Ti:Ca = 2.1 | 34.8 | 14.1 | 16.3 | 19.0 | 13.8 | 1.84 | 2.52 | 2.47 | 2.14 |
| 2 - ZA-P114-Ti:Al = 2.1 | 30.3 | 19.3 | 15.8 | 15.0 | 12.0 | 2.02 | 2.53 | 1.57 | 1.92 |
| 3 - L108-Ti:Al = 0.3 | 16.1 | 6.0 | 7.7 | 61.5 | 6.7 | 0.26 | 2.40 | 2.68 | 2.09 |
| 4 - L109-Ti:Ca = 0.2 | 15.3 | 6.0 | 58.1 | 8.9 | 7.7 | 1.72 | 1.98 | 2.55 | 0.26 |
| 5 - L110-Ti:Al = 0.3 | 15.9 | 6.0 | 7.7 | 61.7 | 6.7 | 0.26 | 2.38 | 2.65 | 2.06 |
| 6 - L111-Ti:Ca = 0.3 | 19.3 | 7.6 | 49.1 | 11.2 | 9.2 | 1.72 | 2.11 | 2.54 | 0.39 |

FIG. 2 shows the composition of samples 1-6.

Conclusion

Samples were obtained with a range of compositions. These compositions are representative of a range of industrial slag compositions and core component ratios.

### Example 3—Sulphation of Slag Comprising Titanium Dioxide

Materials and Methods

Sulphation and hydrolysis (samples 1 and 3 to 6)
1. 100 g samples of particulate material corresponding to samples 1 to 6 from example 2 were transferred to a 1 L round bottom flask;
2. 1 kg of 98% sulphuric acid was added;
3. the mixture was heated, stirred and held at a temperature of 200° C. for around 4 hours;
4. the resultant sulphated mixture was cooled and filtered through a 46K filter cloth under vacuum;
5. the filter cake was transferred to a 1 L conical flask and washed with 1:1 stoichiometry (mass) of RO water for 2 hours at 70° C.;
6. the mixture was stirred and for approximately 15 hours then filtered through a 46K filter cloth under vacuum to produce a permeate comprising at least titanyl sulphate;
7. the permeate (comprising at least titanyl sulphate) was sampled and the samples subjected to inductively coupled plasma atomic emission spectroscopy (ICP-OES) analysis for titanium, calcium, aluminium and magnesium. The titanium dioxide content of the samples was also analysed using lab titration;
8. the permeate comprising at least titanyl sulphate was transferred to a 1 L round bottom flask and diluted 1:2 stoichiometry (mass) with RO water (3× dilution) to produce a hydrolysis liquor;
9. the hydrolysis liquor was heated to boiling point (approximately 104° C.) for 5 hours with stirring to hydrolyse the titanyl sulphate;
10. the precipitated titanium dioxide was separated from the hydrolysis liquor by centrifugation at 8000 rpm for 20 minutes to pellet the precipitated hydrated titanium dioxide;
11. The remaining hydrolysis liquor was analysed using ICP-OES to determine the amount of remaining titanium, aluminium and magnesium in mg/L. A yield of titanium dioxide was calculated from this value. The amount of aluminium and magnesium remaining (as sulphate salts) for downstream extraction was also measured.

The free acidity of the reaction liquor was measured at the following stages:
a. the filtered acid removed following the initial filtration;
b. the permeate comprising titanyl sulphate from the second filtration; and
c. the hydrolysis liquor remaining after the hydrated titanium dioxide had been precipitated and centrifuged.

Sulphation and Hydrolysis Method (Sample 2)
1. A 1.5 kg sample of sample 2-(P114) (see example 2) was ground to form a particulate material of a particulate size of approximately x μm using a ball mill;
2. 8 L of 98% sulphuric acid was added;
3. the mixture was heated and held at a temperature of 200° C. for around 4.5 hours while under 2 bar pressure and stirred at 300 rpm;
4. the resultant sulphated mixture was cooled and filtered through a 46K filter cloth at 50° C.;
5. the filtration was carried out at 5 bar pressure and blown with compressed air for 30-40 mins;
6. the permeate (comprising at least titanyl sulphate) was sampled and the samples subjected to inductively coupled plasma atomic emission spectroscopy (ICP-OES) analysis for titanium, calcium, aluminium and magnesium. The titanium dioxide content and free acidity of the samples was also analysed using lab titration according to the methods described in example 3.
7. the filter cake was leached with 1:1 stoichiometry (mass) of RO water for 2.5 hours at 70° C. i.e. 3028 g of filter cake was leached with 3000 g of RO water, to produce a hydrolysis liquor;
8. the hydrolysis liquor was then filtered through a 46K filter cloth for 15 mins at 1-3 bar and air blown for 20 mins;
9. The hydrolysis liquor was then transferred to a 3 L round bottom flask and diluted 1:2 stoichiometry (mass) with RO water (3× dilution);
10. this diluted liquor was then heated to boiling to hydrolyse the titanyl sulphate for 5 hours with stirring;
11. the hydrated titanium dioxide was centrifuged out at 8000 rpm for 20 minutes to pellet the precipitated hydrated titanium dioxide;
12. The remaining hydrolysis liquor was analysed using ICP-OES to determine the amount of remaining titanium, aluminium and magnesium. A yield of titanium dioxide was calculated from this value. The amount of aluminium and magnesium remaining (as sulphate salts) for downstream extraction was also measured.

Precipitation of Aluminium Sulphate
13. Following hydrolysis the acidity of the liquor comprising aluminium sulphate was increased to around 40% (w/w) with 98% sulphuric acid.
14. This high acidity liquor was then centrifuged at 8000 rpm and 20° C. for 3 hours to precipitate out the aluminium sulphate and pelletise it for separation.

Titration Method to Determine Concentration of Titanium Dioxide
1. Pipetted out approximately 1 mL of the sample into the 500 mL Erlenmeyer flask and determined the exact mass of the sample.
2. Added 60 mL of 10% HCl, 20 mL of 98% H¬2SO4 and about 1.3 g of aluminium foil.
3. Once the reaction was complete allowed for some cooling to occur. This was when some NaHCO3 was sucked back into the flask and formed a buffering CO2 layer.
4. Added 6 drops of methylene blue indicator while the solution was still warm.
5. Titrated against an acidified 0.1M Cerium sulphate standard.
6. The endpoint of the titration is when the colour changes from pale yellow to pale green.

Determination of Free Acidity
1. Pipetted out approximately 1 mL of the sample into a 500 mL Erlenmeyer flask and determined the exact mass of the sample.
2. Added 100 mL of RO water to the flask
3. Added 4 drops of the phenolphthalein indicator
4. Titrated against a standardised 1M NaOH solution.
5. The endpoint of the titration is when the colour changes from colourless to a slight pink.

Results

Samples subjected to the sulphation method described above were analysed and the compositions of the permeate in table 5 were measured:

TABLE 5
analysis results of permeate produced following filtration

| | Lab titration results | | | | | |
|---|---|---|---|---|---|---|
| | Titanium | Free | | | | |
| | Dioxide | Acidity | ICP-OES results (mg/L) | | | |
| Sample number | (g/kg) | (%) | Titanium | Calcium | Aluminium | Magnesium |
| 1 - NZ-P112-Ti:Ca = 2.1 | 33.76 | 31.54 | 30379 | 159 | 13103 | 10429 |
| 2 - ZA-P114-Ti:Al = 2.1 | 39.15 | 29.47 | 37835 | 478 | 19492 | 18099 |
| 3 - L108-Ti:Al = 0.3 | 22.53 | 32.44 | 18063 | 110 | 26012 | 6287 |
| 4 - L109-Ti:Ca = 0.2 | 16.64 | 31.06 | 11297 | 144 | 5068 | 4799 |
| 5 - L110-Ti:Al = 0.3 | 20.66 | 32.97 | 15723 | 107 | 24542 | 5539 |
| 6 - L111-Ti:Ca = 0.3 | 24.29 | 29.07 | 19852 | 233 | 8341 | 8332 |

The free acidity of the permeate was in a range of 29% to 33%.

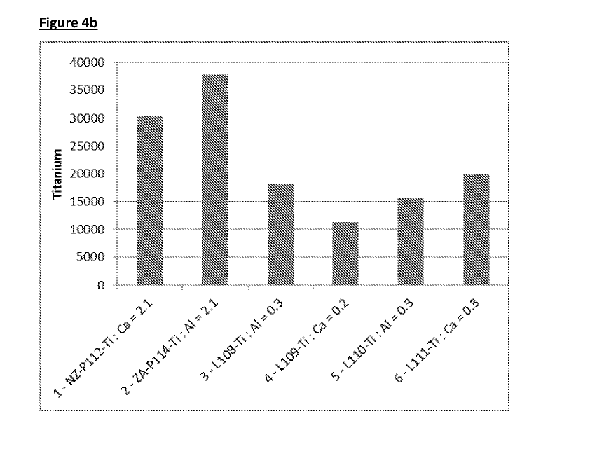

FIG. 4a shows the amount of titanium dioxide measured in the permeate comprising titanyl sulphate as measured by the titration method. FIG. 4b shows the amount of titanium measured in the permeate as measured by the ICP-OES method. It can be seen that the measurements obtained using the lab titration method closely correlate to the measurements obtained using the ICP-OES method. FIG. 5 shows the ICP-OES measurements of titanium, calcium, aluminium and magnesium in the permeate.

TABLE 6
ICP-OES results showing titanium present in the permeate comprising
titanyl sulphate (prior to hydrolysis) and titanium remaining in
the spent hydrolysis liquor (after precipitation of titanium dioxide
and centrifugation/filtration to remove the precipitate).

| | | Titanium in | |
|---|---|---|---|
| | Titanium in | spent | |
| | permeate | hydrolysis | |
| Sample number | (mg/L) | liquor (mg/L) | Yield (%) |
| 1 - NZ-P112-Ti: Ca = 2.1 | 30379 | 1546 | 95 |
| 2 - ZA-P114-Ti: Al = 2.1 | 37835 | 4199 | 89 |
| 3 - L108-Ti: Al = 0.3 | 18063 | 1612 | 91 |
| 4 - L109-Ti: Ca = 0.2 | 11297 | 292 | 97 |
| 5 - L110-Ti: Al = 0.3 | 15723 | 1022 | 93 |
| 6 - L111-Ti: Ca = 0.3 | 19852 | 1415 | 93 |

TABLE 7
ICP-OES results showing aluminium and magnesium present in the
hydrolysis liquor following removal of titanium dioxide.

ICP-OES results
(spent hydrolysis liquor)
(mg/L)

| Sample number | Aluminium | Magnesium |
|---|---|---|
| 1 - NZ-P112-Ti: Ca = 2.1 | 5069 | 3126 |
| 2 - ZA-P114-Ti: Al = 2.1 | 3167 | 2821 |
| 3 - L108-Ti: Al = 0.3 | 6280 | 1552 |
| 4 - L109-Ti: Ca = 0.2 | 1250 | 1253 |
| 5 - L110-Ti: Al = 0.3 | 5362 | 1307 |
| 6 - L111-Ti: Ca = 0.3 | 2377 | 2124 |

TABLE 8
Free acidity of reaction liquor at specific reaction stages.

| | Free acidity (%) | | |
|---|---|---|---|
| | | Permeate | |
| | Filtered | comprising titanyl | Hydrolysis |
| Sample number | acid | sulphate | liquor |
| 1 - NZ-P112-Ti: Ca = 2.1 | 85.53 | 31.54 | 10.7 |
| 2 - ZA-P114-Ti: Al = 2.1 | 90.85 | 29.47 | 9.52 |
| 3 - L108-Ti: Al = 0.3 | 85.23 | 32.44 | 10.85 |
| 4 - L109-Ti: Ca = 0.2 | 86.73 | 31.06 | 10.03 |
| 5 - L110-Ti: Al = 0.3 | 84.27 | 32.97 | 9.52 |
| 6 - L111-Ti: Ca = 0.3 | 83.98 | 29.07 | 9.34 |

In the instance where aluminium sulphate is precipitated first and filtered out, there is a loss of titanyl sulphate to this material stream. Table 9 describes the losses to the precipitated aluminium sulphate due to hold-up of the titanyl sulphate in the aluminium sulphate as it precipitates (occlusion)

TABLE 9
Equivalent titanium dioxide losses when extracting aluminium sulphate prior to hydrolysis

| | Lab | | | | | |
|---|---|---|---|---|---|---|
| | titration results | | Mass Calculations | | | |
| | Titanium | Free | Mass of | Mass of | | |
| | Dioxide | Acidity | Liquor | TiO₂ | Loss of TiO₂ | |
| Sample number | (g/kg) | (%) | (g) | (g) | (g) | % Loss |
| 7 - L112-Ti:Al = 0.3 Leach | 16.11 | 27.81 | 678 | 10.92 | | |
| Liquor | | | | | | |
| 8 - L112-Ti:Al = 0.3 Post Al | 14.01 | 38.43 | 533 | 7.47 | 3.45 | 31.6 |
| Sulphate Precipitation Liquor | | | | | | |
| 9 - ZA-P114-Ti:Al = 2.1 Leach | 39.15 | 29.47 | 630 | 24.66 | | |
| Liquor | | | | | | |
| 10 - ZA-P114-Ti:Al = 2.1 Post | 29.05 | 35.22 | 588 | 17.08 | 7.58 | 30.7 |
| Al Sulphate Precipitation | | | | | | |
| Liquor | | | | | | |

Conclusions

The ICP-OES results in table 5 show that substantial quantities of titanium, aluminium and magnesium are dissolved and pass through the filter substantially devoid of insoluble residues and other undesirable impurities. The titanium, aluminium and magnesium in the permeate are in the form of sulphate salts and can be separately precipitated according to the methods described herein.

The free acidity measurements indicate that the permeate comprising titanyl sulphate is in a range of 29% to 33%.

The amount of calcium in the ICP-OES analyses is very low indicating that the calcium oxide present in the original samples (see FIG. 2/3 and table 4) is precipitated and removed as calcium sulphate during the filtration step.

The yield measurements shown in table 6 indicate a high efficiency extraction of titanium salts (89-97% efficiency. The yield measurements also indicate that the methods described herein are effective and highly efficient for a range of particulate matter compositions and component ratios (see table 4 and FIG. 2).

Table 7 shows that there is a substantial quantity of aluminium and magnesium present in the liquor following hydrolysis and removal of titanium dioxide. These other components (present in the form of sulphate salts) are available for extraction in later method step precipitations.

Table 8 shows that the free acidity of the samples filtered acid is very high. The permeate comprising titanyl sulphate contains a reduced amount of free acid and the hydrolysis liquor contains approximately 10% free acidity. Additional experiments carried out by the inventors indicated that if the free acidity of the hydrolysis liquor is greater than 25%, the hydrolysis reaction is energetically unfavourable and does not proceed, or does not proceed to completion. Additionally, the inventors have found that it is preferable that the hydrolysis liquor contains a free acidity of greater than approximately 8% to enable complete hydrolysis of the titanium sulphate to occur.

Table 9 shows that there are significant losses of equivalent titanium dioxide that would otherwise be available for hydrolysis, in the instance where aluminium sulphate is precipitated prior to hydrolysis. The losses are due in large part to titanyl sulphate being occluded in the coarse aluminium sulphate crystals that form during precipitation. In developing the technique of hydrolysing titanyl sulphate to titanium dioxide prior to aluminium sulphate precipitation, the inventors have improved the economic viability of the process.

A comparison of the two sulphation/hydrolysis methods used shows that they produce comparable results. In a commercial context, the second method (used for sample 2) is generally preferable due to the higher throughput available. Additionally, the inventors contemplate that in a commercial context, the centrifugation step would be replaced by an alternative, higher throughput separation technique such as filtration. Those of skill in the art will appreciate that such separation techniques may be used to obtain the products referred to herein from the liquor/permeate comprising said products.

### Example 4—Recovery of Magnesium Sulphate

Materials and Methods

Extraction of Magnesium Sulphate
1. 1000 mL of the liquor is received from the hydrolysis reaction (optionally following recovery of aluminium sulphate). The liquor comprising magnesium sulphate and sulphuric acid is heated to a temperature above 180° C. by placing in a heated, stirred vessel.
2. As the liquor reaches boiling point at 180° C., the concentration of the acid in solution will reach approximately 75%.
3. The liquor is held at 180° C. for 60 minutes
4. The magnesium sulphate in solution will precipitate as the acid concentration rises
5. The liquor is allowed to cool to ambient temperature
6. The liquor and precipitate is filtered in a vacuum filter with 46K cloth
7. The retentate is removed, dried and analysed with XRF to determine composition
8. The permeate will be high concentration sulphuric acid. A sample of this will be analysed for composition with ICP-OES or ICP-MS technique.
9. A sample of the permeate will also be titrated for free acidity

### Example 5

This example describes a proposed method to achieve higher acid concentration in a permeate comprising magnesium sulphate. This method dehydrates the liquor thus decreasing pH. The higher sulphuric acid concentration results in magnesium sulphate precipitating from the permeate.

A permeate comprising magnesium sulphate is obtained from a method of recovering products from a particulate material as described in example 3. The permeate is passed to a reverse osmosis unit comprising at least one reverse osmosis membrane. The permeate is fed to the unit under a pressure greater than the pressure on the other side of the membrane, for example 1.5 bar.

The retentate is collected and allowed to settle. Magnesium sulphate precipitation occurs spontaneously or may be assisted by cooling or addition of further acid. Precipitated magnesium sulphate is collected via filtration.

### Example 6

This example describes experiments undertaken by the inventors to compare the extraction of minerals from the New Zealand Steel slag by sulphation with 98% (experiment A) and 80% (experiment B) sulphuric acid.

Materials and Methods
1. An acid stream containing 7.32 kg of 98% (experiment A) or 80% (experiment B) sulphuric acid was added to a glass reactor vessel with overhead agitation.
2. 750 g of ground iron making slag was slowly added 3. The mixture was heated to 200° C. for 4 hours;
4. The mixture was allowed to cool to below 80° C. then filtered through a filter press containing a 46K filter cloth;
5. The filter cake was then removed from the filter press and weighed along with the excess acid;
6. The filter cake was then fed into another glass reactor vessel with overhead stirring, and leached at 70° C. for 2 hours to produce a sulphated suspension;
7. The sulphated suspension was filtered through a 46K filter cloth;
8. The permeate (comprising titanyl sulphate and other sulphated compounds) and the insoluble residue retentate were weighed;

The excess acid, sulphated suspension and insoluble residue were analysed. The acid from the sulphuric acid stream and the excess acid were analysed according to the method outlined in example 3.

Results

Acid titration results (table 10):

| | TiO2 | Free Acidity |
|---|---|---|
| Sample | (g/kg) | (%) |
| Feed acid experiment A 98% | 0 | 97.33 |
| Excess acid experiment A | 1.59 | 85.23 |
| Feed acid experiment B 80% | 0 | 81.45 |
| Excess acid experiment B | 1.81 | 78.27 |

ICP-OES results for the liquid samples (table 11):

| Sample | Fe | Cr | Mg | Al | Ti | V |
|---|---|---|---|---|---|---|
| Excess acid experiment A | 131 | 4.1 | 700 | 610 | 1153 | 15 |
| Excess acid experiment B | 132 | 19 | 720 | 766 | 1222 | 34 |
| (sample P130) | | | | | | |

XRF results for the slag and the insoluble residue samples (table 12):

| Sample | FeT | CaO | SiO2 | TiO2 | Al2O3 | MgO | Na2O | K2O | S | V2O3 | MnO | Cr2O3 |
|---|---|---|---|---|---|---|---|---|---|---|---|---|
| Insoluble | 0.61 | 21.2 | 19.4 | 13.5 | 8 | 6.32 | 0.143 | 0.015 | 13.6 | 0.092 | 0.605 | 0.017 |
| residue A | | | | | | | | | | | | |
| Insoluble | 0.116 | 27.4 | 30.7 | 3 | 1.27 | 1.22 | 0.4 | 0.068 | 15.9 | 0.005 | 0.219 | 0.009 |
| residue B | | | | | | | | | | | | |
| Feedstock | 2.94 | 16.03 | 12.75 | 32.98 | 18.75 | 13.68 | 0.41 | 0.14 | 0.14 | 0.27 | 1.13 | 0.22 |
| Slag | | | | | | | | | | | | |

Results are in wt. %. FeT = Total Iron - i.e. from all the valence states

The percentage yield for the sulphation which was calculated using the slag and insoluble residue ratios of silica to metal are:

TABLE 13

| Sample | Ti (%) | Al (%) | MgG (%) |
|---|---|---|---|
| A | 73.10 | 71.96 | 69.63 |
| B | 96.21 | 97.18 | 96.29 |

Note:
Sample A sulphation is with the 98% sulphuric acid and sample B sulphation is with 80% sulphuric acid.

Conclusions

The chromophore content in the excess acid was slightly higher in the 80% acid sulphation (experiment B-) but still very similar. The chromophores measured here are Cr, Fe and V. This indicates that the recycling of acid and re-use at 80% provides a viable alternative to using fresh acid for the process of extraction of titanium dioxide and one or more other products. The carry-over of chromophores to the excess acid is manageable and where necessary the chromophores accumulated may be removed by methods known in the art or described herein.

The yield for experiment B (80% acid) is around the expected theoretical yield of 95%. This indicates that the recycling of acid for re-use at a lower concentration of 80% provides an effective process for the production of titanium dioxide and one or more other products.

### Example 7—Increasing Acid Concentration in the Recycled Sulphuric Acid

The method described in example 6 may be used to produce acid for recycling and regeneration to increase acid concentration. Excess acid is passed through a membrane system. This system comprises a membrane suitable for service in a high acid concentration and sulphate salt concentration environment. The permeate from the membrane is a greater than 95% Water stream with low acid and salt concentration. The concentrated acid retentate is passed to a receiving container for storage. An aliquot of the regenerated acid is taken to confirm the concentration. The stored acid is titrated into the sulphuric acid stream for re-use within the method described in example 6.

### Example 8—Regenerating Sulphuric Acid by Thermal Cracking

The method described in example 6 may be used to produce acid for recycling and regeneration to increase acid concentration.

The excess acid for regeneration is mixed with compressed air and sprayed into a furnace operating at 1000° C. to 1200° C., which cracks the H₂SO₄ molecule into sulphur dioxide and steam. The residence in the furnace is less than 5 seconds.

The gas stream is cleaned by cooling it in a heat exchanger, followed by passing it through electrostatic precipitators.

Following cleaning, the gases are dried by contact with 98% sulphuric acid and then fed into the contact process sulphuric acid production plant.

### Example 9—Testing of Methods to Reduce Chromophore Accumulation in Spent Acid

Aim:

To monitor the change in metal levels at various stages of sulphation in response to steps to reduce chromophore accumulation in spent acid.

Method:
2000 g of 87% sulfuric acid was weighed in a 2 L beaker and set up on a magnetic heater stirrer.
200.244 g of NZ Steel slag #8 was added to this acid while agitating.
The mixture was heated slowly to a sulphation temperature of 200° C.
First sample was taken 20 minutes after the addition of the slag. Subsequent samples were taken every 20 minutes.
Heating was stopped after six hours.

The samples were processed as follows:

Leaching:
30 g sulphation sample was cooled in a water bath, and then transferred into a centrifuge tube.
The spent acid was decanted, titrated for free acidity and analysed using XRF.
The resulting sulphation filter cake in the centrifuge tube was weighed.
Leaching of the filter cake was performed with RO water.
A magnetic stirrer bar was added into the tube and the lid closed.
The mixture was heated on a magnetic heater-stirrer to 70° C. while stirring, for 1 hour.
The CalSi residue was centrifuged out from the leach liquor.

CalSi Residue Washing:
The resulting CalSi residue sample was washed with 10×RO water for at least 30 minutes.
Washed CalSi residue was centrifuged out and dried in the oven at 120′C for at least 2 hours.
The dried sample was then ground to powder form.
The ground CalSi residue sample was then analysed by the XRF.

Discussion

The steps taken to minimise chromophore accumulation in the spent acid result in the chromophore concentration decreasing over time.

The calcium concentration in the acid increases over time. This is believed to be due to it being soluble in sulfuric acid unlike the other salts which are believed to be soluble in water. The precipitation of metals from the spent acid may also be influenced by the calcium level which has a ‘salting out’ effect.

### Example 10

Aim:

To carry out continuous sulphation runs with recycled acid to check effectiveness of chromophore minimisation strategies.

Methods

Sulphation:
A sulphation apparatus was assembled.
The sulphation vessel was filled with 6.2 kg of 90% fresh sulfuric acid.
635 g of slag was added slowly to the vessel and heated to 200° C. and agitated at 400 rpm. The solution was held for 4 hours once it reached 200′C.
A premix slag was prepared by mixing 1.29 kg of recycled acid and 129 g of slag.
The percentage of spent acid in the recycled acid was slowly increased over the run and over different sulphation runs.
Recycled acid was initially prepared with a 50:50 mix of fresh and spent acid. This was done by weighing the spent acid collected and adding a specific percentage of fresh acid to end up at 88% acidity. Full spent acid recycle was later carried out.
1.3 kg of sample was extracted from the sulphation every hour or every 45 minutes, and then approximately 1.3 kg of slag was also added.
Headspace removal was set to maintain steady state acid concentration and adjusted using the valve on scrubber inlet.
Samples were also taken from the condenser KO pot. These samples were weighed and titrated for acidity.
The scrubber was monitored by checking the pH of the sample and adding more 10% NaOH as required. The pH was maintained above 12.
The acidity of the sulphation acid was checked regularly by titration.

Leaching:
Samples were either filtered using the vacuum filtration setup, or using the filter press.
60 g of the sulphation filter cake was weighed into a 250 mL ground glass joint conical flask.
90 g of RO water was added to 60 g of sulphation filter cake.
A magnetic stirrer bar was added and the flask stoppered with a glass stopper.
The mixture was heated on a magnetic heater-stirrer to 7° C. while stirring, for 1 hour.
Temperature readings were taken intermittently using a thermometer.
Samples were then filtered in 80-mm Buchner funnel with 42 kk cloth.

CalSi Residue Washing:
The resulting CalSi residue samples were weighed in a beaker then washed with 10×RO water.
The CalSi residue samples were washed by stirring at room temperature on a magnetic stirrer for at least 30 minutes.
Washed CalSi residue was also filtered using a 80-mm Buchner funnel.
Washed CalSi residue was dried in the oven at 120° C. for at least 2 hours.
The dried sample was then ground to powder form using mortar and pestle.

The ground CalSi residue sample was then analysed by the XRF.

Results

Spent acid composition is shown in FIGS. 7, 8, 9 and 10. It can be seen that although there is some variability in the concentrations of contaminants, the levels did not increase significantly over time. Yield data is shown in FIGS. 11, 12 and 13.

Discussion

By using the methods of the present invention, chromophore accumulation in the spent acid was avoided.

The sulphation reaction using recycled acid provided a good yield of products magnesium oxide, aluminium oxide and titanium dioxide.

### Example 11—Regeneration of Recycled Acid

Aim:

To carry out a lab scale sulphation with regenerated acid and compare it to a fresh acid sulphation.

Method:

Acid Regeneration:

Acid was regenerated using the following steps:
Spent acid produced from a previous sulphation experiment (P172-10) was added to the spent hydrolysis liquor (H171-50) to increase acidity to 25%. Then this liquor was boiled down to increase acidity to 30%.
Upon aluminium sulphate precipitation and filtration, the resulting acidity of the Post Aluminium Liquor (A129-70) was 32%.
The liquor A129-70 was mixed with spent acid to increase acidity to 40%; this liquor was boiled down to achieve 45% acidity in order to remove more aluminium sulphate.
Upon aluminium sulphate removal, the resulting Post Aluminium Liquor (A130-70) acidity was 44.62%.
The liquor A130-70 was then boiled down further to 70%.
The regenerated acid (330 g) concentration was then increased to 75% by adding P172-10 spent acid (208 g) and then adding 414 g of 98% fresh sulfuric acid to reach 88% concentration.

Sulphation:
The sulphation setup included a 600-mL beaker and a stirrer bar placed on a heater-stirrer.
The beaker was filled with 900 g of 88% regenerated sulfuric acid.
90 g of New Zealand Steel slag was added slowly to the beaker and heated to 200° C. and agitated at 400 rpm. The solution was held for 4 hours once it reached 200° C.

Leaching:
After four hours, the sulphation solution was cooled and filtered using the vacuum filtration setup.
60 g of the sulphation filter cake was weighed into a 250 mL ground glass joint conical flask.
90 g of RO water was added to 60 g of sulphation filter cake.
A magnetic stirrer bar was added and the flask stoppered with a glass stopper.
The mixture was heated to 70′C while stirring, for 1 hour.
Temperature readings were taken intermittently using a thermometer.
Samples were then filtered in a Buchner funnel with 42 kk cloth.

CalSi Residue Washing:
The resulting CalSi residue samples were weighed in a beaker then washed with 10×RO water.
The CalSi residue samples were washed by stirring at room temperature on a magnetic stirrer for at least 30 minutes.
Washed CalSi residue was also filtered using a Buchner funnel.
Washed CalSi residue was dried in an oven at 120 deg C. for at least 2 hours.
The dried sample was then ground to powder form using mortar and pestle.
The ground CalSi residue sample was then analysed by the XRF.

Results:

TABLE 14
Regenerated acid Analysis

| Compound | Concentration (g/kg) |
|---|---|
| Mg | 3.036 |
| Al | 3.510 |
| Ti | 0.200 |
| Cr | 0.080 |
| Mn | 0.380 |
| Fe | 1.184 |
| Ni | 0.020 |

TABLE 15
% Acidity of Samples

| Sample | Acidity (%) |
|---|---|
| Spent acid, L113-10 | 89.3 |
| Leach Liquor, L113-30 | 14.8 |

TABLE 16
Comparison of Chromophore Levels in Leach Liquor Samples

| | Leach liquor Analysis, L113-30 | Leach Liquor Analysis, P172-30-1 |
|---|---|---|
| Compound | Concentration (g/kg) | Concentration (g/kg) |
| Mg | 4.056 | |
| Al | 19.010 | |
| Ti | 16.836 | |
| Cr | 0.048 | 0.064 |
| Mn | 0.604 | 0.748 |
| Fe | 2.688 | 3.248 |
| Ni | 0.012 | 0.032 |

TABLE 17
CalSi residue Analysis

| L113-43 | |
|---|---|
| Compound | Concentration |
| MgO | 1.415 |
| Al2O3 | 2.053 |
| SiO2 | 28.147 |
| CaO | 28.346 |
| TiO2 | 5.458 |
| Cr2O3 | 0.005 |
| MnO | 0.427 |
| Fe | 0.337 |

TABLE 18
Comparison of % Yield

| Compound | L113-43, % Yield | P172-43-1, % Yield |
|---|---|---|
| MgO | 94.762 | 93.563 |
| Al2O3 | 94.815 | 93.924 |
| CaO | 25.166 | 23.354 |
| TiO2 | 93.076 | 90.965 |

Discussion
Acid regeneration was carried out in several steps to effectively remove salts. Otherwise, the liquor would solidify upon precipitation and could not be filtered.
Removing all of the aluminium salts in one step was also not possible because the liquor would solidify upon precipitation.
Spent acid was added to the liquor to dilute out the salts. This improved the filtration of the liquor.
Sulphation with a high % yield was possible with the regenerated acid. Sulphation with regenerated acid also produced leach liquor with comparable chromophore concentrations.

### Example 12—Sulphation Efficiency Versus Acid Concentration

Aim

To test the acid concentration required to achieve efficient sulphation of aluminium, magnesium and titanium oxides in sulphation reactions.

Method

Sulphation was carried at 200° C. for approximately 4 hours with an agitation rate of 400 rpm as described in example 11.

Leaching was performed with RO water at 70° C. for 1.5 hours. The CalSi residue was washed at a ratio of 10:1 RO water:CalSi residue.

Sulphation efficiency was calculated by varying acid concentration.

Results and Discussion

Results of the efficiency of sulphation conversion are shown in FIG. 14. While aluminium and magnesium conversion efficiency is consistently high using weaker acid, titanium sulphation efficiency increases substantially as acid strength increases from 72% to 82%.

The results indicate that for efficient titanium sulphation, acid of greater than about 80% is preferable.

### Example 13

Aim:

To test different reducing agents and whether reducing at leach reduces the Cu contamination in the TiO₂

Method:

In 3 conical flasks 200 g sulphate cake was added to 300 g RO water. Al and Zn were added to each conical flask as per table 20. These were then heated to 70° C. for 2 hours while being agitated. The solutions were then filtered and the CalSi residue and leach liquor analysed by XRF.

To each filtrate solution 5 ml of nuclei suspension was added. These were then heated to the boil for 1 hour. After boiling for 1 hour the TiO₂ was filtered out, washed, calcined and analysed by XRF. Note 0.384 g Al metal powder was added to the control experiment and the Zn experiment as the liquor was not sufficiently reduced to supress Fe precipitation.

TABLE 19

| Test | Reductant |
|---|---|
| Control | |
| Al | Al powder = 0.384 g |
| Zn | Zn granules = 0.384 |

Results:

XRF was used to analyse the Cu present in the TiO₂, CalSi residue, leach liquor and post hydrolysis liquor. Table 20 shows the results. From table 20 it can be seen that the Cu reports to the CalSi residue if the solution is reduced properly (as indicated by the purple colour, due to the presents of Ti³⁺). This is shown by the increased counts per-second of the Cu signal in the CalSi residue and the reduced counts per-second in the leach liquor for the “Al” sample when compared to the “control” experiment. In the case of “Zn” there was insufficient reduction to produce Ti³⁺, this was due to the lack of surface area of the Zn granules.

The Cu in the TiO₂ calciner discharge (CD) was reduced by trapping the Cu in the CalSi residue. This can be seen in table 20 where the detected Cu in the CD of the “Al” experiment was 50% or less than the control. Since Al was added to the “Zn” experiment during hydrolysis, Cu was reduced and reported to the TiO₂ again much like the control.

TABLE 20

| | | Purple | | | | | Cu Spent |
|---|---|---|---|---|---|---|---|
| | Reducing | at | Purple at | Cu | Cu CalSi | Cu calciner | hydrolysis |
| Experiment | agent | Leach | hydrolysis | leach | residue | discharge | (Fe adjusted) |
| Control | Al | No | Yes | 10.1 cps | 5.6 cps | 23.3 cps | 9.7 cps |
| | Added | | | 100% | 100% | 100% | 100% |
| | during | | | | | | |
| | hydrolysis | | | | | | |
| Al | Al | Yes | Yes | 7.7 cps | 13.3 cps | 13.3 cps | 8.4 cps |
| | Added | | | 76% | 274% | 57% | 86% |
| | during | | | | | | |
| | leach | | | | | | |
| Zn | Zn | No | Yes | 11.0 cps | 4.7 cps | 29.3 cps | 8.1 cps |
| | Added | | | 102% | 97% | 126% | 82% |
| | during | | | | | | |
| | leach | | | | | | |
| | Al | | | | | | |
| | Added | | | | | | |
| | during | | | | | | |
| | hydrolysis | | | | | | |

Discussion and Conclusion:

The results show that reducing in the leach stage rather than in the hydrolysis stage reduces Cu contamination of the TiO₂. This is because the colloidal Cu generated by the reduction of CuSO₄ reports to the CalSi residue rather than the TiO₂.

### Example 14

Aim:

To show that Cu contamination of TiO₂ can be reduced by reducing the leach rather than the pre hydrolysis liquor.

Method:

A leach was carried out as per example 6, however 3.84 g of Al powder was added to the leach during the exothermic hydration of the sulphate cake (P170 #7+8 (reduced liquor Al).

A standard Blumenfeld hydrolysis as per U.S. Pat. No. 1,795,467 was carried out on the reduced leach liquor (H154). The hydrated TiO₂ was washed and calcined as per example 15. The colour and contamination was of the calciner discharge was measured using the colour spectrometer and XRF.

Results:

The calciner discharge produced using the leach liquor that had been reduced at the leach has far superior colour and lower Cu contamination. Below in table 21 it can be seen that H154 when compared to H150 (a Blumenfeld calciner discharge produce by reduction during the hydrolysis stage) had around 50% (ca. 26.783 cps vs 13.698 cps Cu) less Cu contamination. The decreased Cu contamination significantly increased the L* (lightness) of H154 vs H150.

TABLE 21

| | | | | | | Colour | | |
|---|---|---|---|---|---|---|---|---|
| | | | | | | (CIELAB | | |
| | | | | | | colour | | |
| | | XRF | | | | space | | |
| Experiment No. | Reduced at leach? | Ti (CPS) | Fe (CPS) | Cr (CPS) | Cu (CPS) | L* (%) | A* (%) | B* (%) |
| H150 | No | 135501.8 | 10.397 | −0.013 | 26.783 | 97.04 | 0.22 | 1.12 |
| H154 | Yes | 133543.6 | 7.459 | 0.309 | 13.698 | 98.82 | 0.08 | 0.85 |
| RCL595 | | 133808.0 | 17.132 | 0.665 | 13.54 | 98.8 | | 1.3 |

Discussion and Conclusion:

The colour and purity of the calciner discharge can be improved by reducing at the leach stage rather than the hydrolysis stage. This is because the precipitated Cu reports to the CalSi residue as rather than the TiO₂.

### Example 15—Preparation and Calcination of Titanium Dioxide

This experiment demonstrated the preparation and calcination of titanium dioxide.

Materials and Methods

200 g of titanium dioxide hydrate are prepared as follows;

Preparation—Titanous Sulphate Leach
1. The TiO2 hydrate is leached with titanous sulphate (Ti³⁺ H2SO4) solution in a 1 L conical flask. This solution is in a concentration of 5 g/kg titanous sulphate in 13% w/w sulphuric acid. The conical flask is operating at 70° C.
2. The TiO2 hydrate is stirred 2 hours.
3. The leached TiO2 hydrate is filtered to separate the hydrate from the wash liquor.
4. Steps 1-3 are repeated in full.

Preparation—Sulphuric Acid Leach
1. The TiO2 hydrate requires an additional leach in sulphuric acid solution at a concentration of 13% w/w sulphuric acid in water.
2. The TiO2 hydrate is leached with 13% sulphuric acid solution in a 1 L conical flask.
3. The flask is stirred continuously and brought to the boil for 2 hours
4. The leached TiO2 hydrate is filtered to separate the hydrate from the wash liquor.
5. Steps 2 to 4 are repeated in full.

Preparation—Water Wash
1. The final stage of preparation for calcination is a series of water washes.
2. The TiO2 hydrate is added to a conical flask containing wash water at high agitation.
3. The TiO2 hydrate is stirred continuously for 10 minutes.
4. The washed TiO2 hydrate is filtered to separate the hydrate from the wash water. The wash water is recycled to the wash vessel.
5. Steps 2 to 4 are repeated an additional three times.

Calcination
1. In order to successfully calcine the TiO₂ hydrate to dry TiO₂ crystal suitable for coating to pigment grade material it is preferably doped with specific additives.
2. The TiO₂ hydrate is added to a conical flask along with 500 mL of water.
3. Dopants are added to the solution as follows:
   a. 0.5 g of K₂O
   b. 0.5 g of P₂O₅
   c. 0.5 g of Al₂O₃
4. The flask is stirred and heated to boiling and held at temperature until the free water is driven off.
5. The dry pre-calcination TiO2 is ground in a mortar and pestle.
6. Then placed in a furnace at 990° C.

Results

Table 22 below, shows the change in chromophore content of TiO2 hydrate before and after washing steps.

| | Sample A | |
|---|---|---|
| | Unwashed TiO2 hydrate | Sample B |
| Element | (ppm) | Washed & Calcined TiO2 |
| Cr | 43.9 | Not detectable |
| Mn | 5.1 | Not detectable |
| Fe | 3472.9 | Not detectable |
| Ni | 96.8 | 6.29 |

Colour performance of Sample B is outlined in Table 23 below,

| | Brightness | Blue tonality |
|---|---|---|
| Sample | L* (%) | b* (%) |
| B | 97.8 | 2.8 |

Conclusions

The method outlined is successful in producing TiO2 crystal that is substantially free from chromophore contamination and has colour performance very close to top quality pigment grade TiO₂. This can be seen in the values in Tables 22 and 23.

### Example 16—Demonstration of Production of Calcined Titanium Dioxide from Iron Ore Slag

Materials and Methods

Sulphation:

The sulphation setup included a 600-mL beaker and a stirrer bar placed on a heater-stirrer.

The beaker was filled with 900 g of 88% sulfuric acid.

90 g of New Zealand Steel slag was added slowly to the beaker and heated to 200° C. at 2° C./min and agitated at 400 rpm. The solution was held for 4 hours once it reached 200° C.

Leaching:

After four hours, the sulphation solution was cooled and filtered using the vacuum filtration setup.

60 g of the sulphation filter cake was weighed into a 250 mL ground glass joint conical flask.

90 g of RO water was added to 90 g of sulphation filter cake.

0.1 g of fine Al powder was added to the leaching solution.

A magnetic stirrer bar was added and the flask stoppered with a glass stopper.

The mixture was heated on a magnetic heater-stirrer to 70° C. while stirring, for 2 hour.

Temperature readings were taken intermittently using a thermometer.

Samples were then filtered in 80-mm Buchner funnel with 42 kk cloth.

The filtrate was filter a second time through a porous glass (<7 μm) filter.

The TiO₂ content of the filtrate was analysed using XRF.

Hydrolysis:

The filtrate from the leach was placed in a 250 ml ground glass joint conical flask.

A magnetic stirrer bar was added and a reflux condenser was fitted to the flask.

The mixture was heated on a magnetic heater-stirrer to 85° C. while stirring.

Once at 85° C., TiO₂ nuclei were added, these were produced using an oxychloride solution as described in GB513867. The quantity of nuclei added had been pre-determined to give a final product (calcined rutile) with a mean particle size of 250 nm based on the performance of that batch of nuclei.

Once the addition of nuclei was complete hydrolysis was carried out using the methods described by Mecklenburg (U.S. Pat. No. 1,758,528).

Once hydrolysis was complete, the hydrated titanium dioxide was filtered out using a porous glass (<7 μm) filter.

The hydrated titanium dioxide was washed and leached as described in example 15.

Doping and Calcining of Hydrated Titanium Dioxide:

The hydrated titanium dioxide was doped with K2O, P2O5 and Al2O3 as described in example 15.

Hydrated titanium dioxide was pre-dried as described earlier in the patent

The pre-dried titanium dioxide was calcined in a static furnace at 900° C. for 2 hours SEM was used to evaluate the final products mean size, particle shape and dispersity.

Results

XRD was used to determine rutile content and is shown in FIG. 19. An SEM image of calcined titanium dioxide is shown in FIG. 18.

The chromophore content of the final calciner discharge is provided in table 24 below:

TABLE 24
ICP analysis of calciner discharge
showing low levels of contaminants

| | Concentration |
|---|---|
| Element | (ppm) |
| Iron | 6.2 |
| Chromium | 2.2 |
| Vanadium | 4.8 |
| Arsenic | <0.1 |
| Nickel | 0.1 |
| Manganese | 0.3 |
| Antimony | 0.2 |
| Lead | 0.2 |
| Cobalt | <0.1 |
| Zinc | 2.0 |
| Molybdenum | 1.9 |
| Copper | <15 |

Conclusion:

SEM images of the final TiO2 product produced showed good crystal shape, a mean size of approximately 250 nm and a narrow distribution of sizes. The XRD diffractogram (FIG. 19) showed >98% conversion from anatase to rutile. This product should have good hiding power and high durability due to it optimal particle size and rutile content. Overall this pigment should be suitable for use in a large range of industrial applications.

1. A method of recovering titanium dioxide hydrate from a particulate material, the method comprising:
a. contacting the particulate material with 2-15 times its stoichiometric quantity of sulphuric acid from a sulphuric acid stream and heating to form a sulphated mixture;
b. filtering the sulphated mixture to produce a filter cake and a first permeate comprising excess sulphuric acid;
c. contacting the filter cake with water to form a sulphated suspension comprising titanyl sulphate;
d. filtering the sulphated suspension to produce a permeate comprising at least titanyl sulphate, and a retentate comprising insoluble residue;
e. contacting the permeate comprising at least titanyl sulphate with water to produce a hydrolysis liquor;
f. hydrolysing the titanyl sulphate to produce a hydrolysed liquor; and
g. separating titanium dioxide hydrate from the hydrolysed liquor,
wherein excess sulphuric acid from at least one of the first permeate and the hydrolysed liquor undergoes recycling.

2. The method of claim 1 wherein separating titanium dioxide hydrate from the hydrolysis liquor produces a permeate comprising aluminium sulphate, and a retentate comprising titanium dioxide hydrate, and the method further comprises
h. precipitating aluminium sulphate from the permeate;
wherein step h. may be carried out after step d or after step g, and
wherein excess sulphuric acid undergoes recycling from the permeate of at least one of step b., g. or h.

3. The method of claim 1 wherein separating titanium dioxide hydrate from the hydrolysis liquor produces a permeate comprising magnesium sulphate, and a retentate comprising titanium dioxide hydrate, and the method further comprises
h. precipitating magnesium sulphate from the permeate;
wherein excess sulphuric acid undergoes recycling from the permeate produced following at least one of step b., g. or h.

4. The method of any one of the preceding claims wherein recycling comprises collecting excess sulphuric acid from one or more steps of the method and passing recycled sulphuric acid to the sulphuric acid stream.

5. The method of any one of the preceding claims wherein the sulphuric acid stream acid has a concentration of greater than 70 m %.

6. The method of any one of the preceding claims wherein the sulphuric acid stream has a concentration of about 80 m % to about 98 m %.

7. The method of any one of the preceding claims wherein the method comprises a step of minimising water accumulation during the sulphation step a.

8. The method of claim 7 wherein the step of minimising water accumulation comprises heating the sulphated mixture to a sulphation temperature and for a heating period sufficient to remove substantially all of the water produced during sulphation.

9. The method of claim 7 or 8 wherein the step of minimising water accumulation comprises removal of headspace from a sulphation reactor adapted to contain the sulphation step a.

10. The method of claim 9 wherein the removal of headspace is achieved by at least one of:
a. a gas pump adapted to increase gas ingress to the headspace of the sulphation reactor; and
b. a gas pump adapted to increase gas egress from the headspace of the sulphation reactor.

11. A method as claimed in any one of the preceding claims wherein the sulphated mixture is heated to a temperature and for a period to achieve substantially complete sulphation of the titanium oxides present.

12. A method as claimed in any one of the preceding claims wherein the sulphated mixture is heated to between about 100° C. to 250° C.

13. A method as claimed in any one of the preceding claims wherein the mixture is heated for between 15 minutes and 24 hours.

14. A method as claimed in claim 1 wherein the particulate material of step a. is contacted with approximately 4-10 times its stoichiometric quantity of sulphuric acid; and wherein the method comprises a step of minimising water accumulation during the sulphation step a. comprising:
a. heating the sulphated mixture in a sulphation reactor to a sulphation temperature of between approximately 150° C. and 250° C.; and
b. heating the sulphated mixture for a heating period of between about 30 minutes and 6 hours; and
c. removal of headspace from the sulphation reactor.

15. A method as claimed in any one of the preceding claims wherein the particulate material comprises greater than 8 m % titanium dioxide.

16. A method as claimed in claim 15 wherein the particulate material further comprises greater than 10 m % aluminium oxide and greater than 7 m % magnesium oxide.

17. A method as claimed in any one of the preceding claims wherein the method comprises decreasing the concentration of one or more contaminants in the sulphuric acid or recycled sulphuric acid by removal of the one or more contaminants by at least one of:
a. a separation process followed by filtration to yield a retentate comprising the one or more contaminants;
b. a membrane separation technique; and
c. increasing the concentration of the sulphuric acid to induce precipitation of the one or more contaminants followed by filtration to yield a retentate comprising the one or more contaminants.

18. The method of any one of the preceding claims wherein the concentration of contaminants in the titanium dioxide hydrate is one or more of the following:
a. iron less than 20 ppm;
b. chromium less than 4 ppm;
c. nickel less than 2 ppm;
d. vanadium less than 15 ppm;
e. manganese less than 2 ppm; or
f. copper less than 15 ppm.

19. A method as claimed in any one of the preceding claims wherein the method further comprises producing calcined titanium dioxide from a mixture comprising titanium dioxide hydrate and at least one contaminant, the method comprising:
a. treating the mixture to decrease the concentration of the at least one contaminant and produce purified titanium dioxide hydrate;
b. addition of at least one dopant to the purified titanium dioxide hydrate to produce a doped mixture; and
c. heating the doped mixture comprising pre-calcination titanium dioxide hydrate for a period to produce calcined titanium dioxide.

20. A method as claimed in claim 19, further comprising heating the doped mixture from b. in water for a period to produce a pre-calcination liquor and drying the pre-calcination liquor to produce a pre-calcination titanium dioxide hydrate.

21. A method as claimed in claim 19 or 20 wherein the calcined titanium dioxide comprises greater than 95% rutile titanium dioxide.

22. A method as claimed in any one of claims 19 to 21 wherein treating the mixture comprises at least one of a titanous sulphate leach, a sulphuric acid leach, and a water wash.

23. A method as claimed in any one of the preceding claims wherein at least one dopant is added to the titanium dioxide hydrate to produce a doped mixture wherein the at least one dopant is selected form the group consisting of potassium oxide (K₂O), phosphorus pentoxide (P₂O₅), and aluminium oxide (Al₂O₃).

24. A method as claimed in any one of the preceding claims wherein the titanium dioxide produced comprises a geometric standard deviation of less than 1.5.

25. A method as claimed in any one of the preceding claims further comprising addition of a reductant to the hydrolysis liquor.

26. A method as claimed in any one of the preceding claims wherein the method further comprises a step to reduce the concentration of iron present in titanium dioxide comprising addition of a reductant prior to or during hydrolysis.

27. A method as claimed in claim 26 wherein the reductant is selected from:
a. a reductant with a greater oxidation potential than the reduction potential of Fe3+;
b. aluminium
c. zinc; and
d. iron.

28. A method as claimed in any one of the preceding claims wherein hydrolysing the titanyl sulphate comprises heating to between about 85° C. and 140° C.

29. A method as claimed in claim 28 wherein the heating is carried out for at least one hour.

30. A product produced by the method of any one of the preceding claims, the product being selected from:
a. titanium dioxide;
b. silica;
c. calcium sulphate;
d. aluminium sulphate;
e. magnesium sulphate; or
f. titanium dioxide hydrate.

31. A titanium dioxide product as claimed in claim 30 comprising at least 95% rutile titanium dioxide.

32. A titanium dioxide product as claimed in claim 30 or 31 wherein the concentration of contaminants in the titanium dioxide is one or more of the following:
a. iron less than 20 ppm;
b. chromium less than 4 ppm;
c. nickel less than 2 ppm;
d. vanadium less than 15 ppm;
e. manganese less than 2 ppm; or
f. copper less than 15 ppm.

33. A titanium dioxide product as claimed in any one of claims 30 to 32 wherein the product comprises at least one of:
a. a crystal colour specification of greater than 97% or 98% brightness;
b. a crystal colour specification of less than 1.8%, 2.5% or 2.8% blue tonality;
c. a crystal size distribution centred on about 220 nm in diameter
d. a crystal size distribution less than 1.2 standard deviations from the target size of monodisperse particles;
e. a geometric standard deviation of less than 1.5.

34. A system for the recovery of products from a particulate material, the system comprising:
a. a sulphation reactor adapted to receive and heat sulphuric acid and particulate material comprising at least titanium dioxide and produce a sulphated mixture;
b. a first filtration unit adapted to receive the sulphated mixture and produce a first permeate comprising at least sulphuric acid, and a filter cake comprising at least titanyl sulphate;
c. a hydrolysis reactor adapted to receive a solution comprising titanyl sulphate and heat said solution to produce a hydrolysis liquor;
d. a separation unit adapted to receive the hydrolysis liquor and separate titanium dioxide hydrate; and
e. a recycling means adapted to recycle excess sulphuric acid from at least one of the first filtration unit and the separation unit.

35. A system as claimed in claim 34, further comprising:
a. a first leach vessel adapted to receive a mixture comprising titanium dioxide hydrate and at least one contaminant and carry out at least one of a titanous sulphate leach, a sulphuric acid leach, and a water wash;
b. heating means configured to heat the first leach vessel;
c. separation means adapted to separate purified titanium dioxide hydrate from a leach liquor;
d. a doping tank adapted to receive purified titanium dioxide hydrate from the separation means and mix it with one or more dopants;
e. a calcination reactor adapted to receive pre-calcination titanium dioxide hydrate from the drying means, wherein the reactor is coupled with a heating means adapted to heat the reactor to at least 800° C. to produce calcined titanium dioxide.
